(19) United States
(12) Patent Application Publication
(10) Pub. No.: US 2025/0196583 A1
(43) Pub. Date: Jun. 19, 2025

(54) REFRIGERATION CYCLE DEVICE

(71) Applicant: DENSO CORPORATION, Kariya-city (JP)

(72) Inventors: Kengo SUGIMURA, Kariya-city (JP); Yuichi KAMI, Kariya-city (JP); Kota TAKEICHI, Kariya-city (JP)

(21) Appl. No.: 19/069,156

(22) Filed: Mar. 3, 2025

Related U.S. Application Data
(63) Continuation of application No. PCT/JP2023/030910, filed on Aug. 28, 2023.

(30) Foreign Application Priority Data
Sep. 7, 2022 (JP) 2022-142135

(51) Int. Cl. B60H 1/22; F24F 3/14; F24F 110/10; F25B 41/42

(52) U.S. Cl. CPC B60H 1/22; F24F 3/14; F25B 41/42; B60H 2001/2268; F24F 2110/10; F25B 2700/21

(57) ABSTRACT

In a series dehumidification heating mode, a refrigerant discharged from a compressor circulates in order of a heating portion, a first depressurization unit, an outdoor heat exchange portion, a second depressurization unit, an indoor evaporation portion, and a suction port of the compressor. In a hot gas dehumidification heating mode, (i) the refrigerant discharged from the compressor circulates in order of a branch portion, the heating portion, the second depressurization unit, the indoor evaporation portion, a merging portion, and the suction port of the compressor; (ii) the refrigerant discharged from the compressor circulates in order of the branch portion, the heating portion, a third depressurization unit, the merging portion, and the suction port of the compressor; and (iii) the refrigerant discharged from the compressor circulates in order of the branch portion, a bypass passage, the merging portion, and the suction port of the compressor.

### CROSS REFERENCE TO RELATED APPLICATION

The present application is a continuation application of International Patent Application No. PCT/JP2023/030910 filed on Aug. 28, 2023, which designated the U.S. and claims the benefit of priority from Japanese Patent Application No. 2022-142135 filed on Sep. 7, 2022. The entire disclosures of all of the above applications are incorporated herein by reference.

### FIELD OF THE INVENTION

The present disclosure relates to a refrigeration cycle device applied to an air conditioner.

### BACKGROUND

Conventionally, a refrigeration cycle device can be applied to a vehicle air conditioner and configured to be switchable between operation modes.

For example, a refrigeration cycle device includes a heat pump cycle that adjusts a temperature of ventilation air blowing a vehicle interior that is a space to be air conditioned. The heat pump cycle is configured to switch a refrigerant circuit according to an operation mode in order to continuously adjust the temperature of ventilation air.

### SUMMARY

An object of the present disclosure is to provide a refrigeration cycle device that can continuously adjust a temperature of ventilation air in a wide range while suppressing a decrease in operation efficiency.

A refrigeration cycle device according to a first aspect of the present disclosure includes a compressor, a branch portion, a heating portion, a depressurization device, an outdoor heat exchange portion, an indoor evaporation portion, a bypass passage, a bypass flow rate adjustment portion, a merging portion, and a refrigerant circuit switching portion.

In the refrigeration cycle device, the compressor is configured to compress and discharge a refrigerant. The branch portion is configured to branch a flow of the refrigerant discharged from the compressor. The heating portion is configured to heat ventilation air blowing a space to be air conditioned, using, as a heat source, the refrigerant flowing out of a one outflow port of the branch portion. The depressurization device is configured to depressurize the refrigerant flowing out of the heating portion. The outdoor heat exchange portion is configured to exchange heat between the refrigerant flowing out of the depressurization device and outside air. The indoor evaporation portion is configured to evaporate the refrigerant depressurized at the heating-portion side depressurization portion to cool the ventilation air before being heated by the heating portion. The bypass passage guides the refrigerant flowing out of an another outflow port of the branch portion, toward a suction port side of the compressor. The bypass flow rate adjustment portion is configured to adjust a flow rate of the refrigerant flowing through the bypass passage. The merging portion is configured to merge a flow of the refrigerant flowing out of the heating-portion side depressurization portion and a flow of the refrigerant flowing out of the bypass flow rate adjustment portion, and to cause the merged refrigerant to flow toward the suction port side of the compressor. The refrigerant circuit switching portion is configured to switch a refrigerant circuit.

In addition, the depressurization device includes a first depressurization unit that depressurizes the refrigerant flowing into the outdoor heat exchange portion, a second depressurization unit that depressurizes the refrigerant flowing into the indoor evaporation portion, and a third depressurization unit that depressurizes the refrigerant bypassing the outdoor heat exchange portion and the indoor evaporation portion.

Operation modes, in which the heating portion heats the ventilation air cooled at the indoor evaporation portion, include a series dehumidification heating mode and a hot gas dehumidification heating mode.

The refrigerant circuit switching portion is configured to switch a refrigerant circuit in which the refrigerant discharged from the compressor circulates in order of the heating portion, the first depressurization unit, the outdoor heat exchange portion, the second depressurization unit, the indoor evaporation portion, and the suction port of the compressor, in the series dehumidification heating mode.

In addition, the refrigerant circuit switching portion is configured to switch a refrigerant circuit in which (i) the refrigerant discharged from the compressor circulates in order of the branch portion, the heating portion, the second depressurization unit, the indoor evaporation portion, the merging portion, and the suction port of the compressor; (ii) the refrigerant discharged from the compressor circulates in order of the branch portion, the heating portion, the third depressurization unit, the merging portion, and the suction port of the compressor, and (iii) the refrigerant discharged from the compressor circulates in order of the branch portion, the bypass passage, the merging portion, and the suction port of the compressor, in the hot gas dehumidification heating mode.

A refrigeration cycle device of a second aspect of the present disclosure includes a compressor, a branch portion, a heating portion, a depressurization device, an outdoor heat exchange portion, a bypass passage, a bypass flow rate adjustment portion, a merging portion, and a refrigerant circuit switching portion.

In the refrigeration cycle device, the compressor is configured to compress and discharge a refrigerant. The branch portion is configured to branch a flow of the refrigerant discharged from the compressor. The heating portion is configured to heat ventilation air blowing a space to be air conditioned, using, as a heat source, the refrigerant flowing out of a one outflow port of the branch portion. The depressurization device is configured to depressurize the refrigerant flowing out of the heating portion. The outdoor heat exchange portion is configured to exchange heat between the refrigerant flowing out of the depressurization portion and outside air. The bypass passage guides an other stream of the refrigerant branched at the branch portion toward a suction port side of the compressor. The bypass flow rate adjustment portion is configured to adjust a flow rate of the refrigerant flowing through the bypass passage. The merging portion is configured to merge a flow of the refrigerant flowing out of the depressurization device and a flow of the refrigerant flowing out of the bypass flow rate adjustment portion, and to cause the merged refrigerant to flow toward a suction port side of the compressor. The refrigerant circuit switching portion is configured to switch a refrigerant circuit.

The depressurization device includes an outdoor side depressurization unit that depressurizes the refrigerant flowing into the outdoor heat exchange portion, and a bypass side depressurization unit that depressurizes the refrigerant bypassing the outdoor heat exchange portion.

The operation modes, in which the heating portion heats the ventilation air, includes an outside air endothermic heating mode and a hot gas heating mode.

The refrigerant circuit switching portion is configured, in the outside air endothermic heating mode, to switch a refrigerant circuit in which the refrigerant discharged from the compressor circulates in order of the heating portion, the outdoor side depressurization unit, the outdoor heat exchange portion, and the suction port of the compressor.

The refrigerant circuit switching portion is configured, in the hot gas heating mode, to switch a refrigerant circuit in which (i) the refrigerant discharged from the compressor circulates in order of the branch portion, the heating portion, the bypass side depressurization unit, the merging portion, and the suction port of the compressor; and (ii) the refrigerant discharged from the compressor circulates in order of the branch portion, the bypass passage, the merging portion, and the suction port of the compressor.

### BRIEF DESCRIPTION OF DRAWINGS

The above object and other objects, features, and advantages regarding the present disclosure will become more apparent from the following detailed description with reference to the accompanying drawings. In the drawings:

FIG. 1 is a schematic overall configuration diagram of a vehicle air conditioner of a first embodiment;

FIG. 2 is a block diagram illustrating an electric control unit of the vehicle air conditioner of the first embodiment;

FIG. 3 is a flowchart showing a part of a control process of a control program of the first embodiment;

FIG. 4 is a flowchart showing another part of the control process of the control program of the first embodiment;

FIG. 5 is a flowchart showing another part of the control process of the control program of the first embodiment;

FIG. 6 is a flowchart showing another part of the control process of the control program of the first embodiment;

FIG. 7 is a flowchart showing another part of the control process of the control program of the first embodiment;

FIG. 8 is a control characteristic diagram for switching an operation mode in the control program of the first embodiment;

FIG. 9 is another control characteristic diagram for switching the operation mode in the control program of the first embodiment;

FIG. 10 is another control characteristic diagram for switching the operation mode in the control program of the first embodiment;

FIG. 11 is another control characteristic diagram for switching the operation mode in the control program of the first embodiment;

FIG. 12 is another control characteristic diagram for switching the operation mode in the control program of the first embodiment;

FIG. 13 is a flowchart showing a control process in an hot-gas (HG) dehumidification heating mode of the control program of the first embodiment;

FIG. 14 is a schematic overall configuration diagram illustrating a flow of a refrigerant and the like in the HG dehumidification heating mode and a cooling HG dehumidification heating mode of the vehicle air conditioner of the first embodiment;

FIG. 15 is a Mollier chart showing a change in the state of the refrigerant in the HG dehumidification heating mode of the heat pump cycle of the first embodiment;

FIG. 16 is a flowchart showing a control process in an outside air endothermic HG dehumidification heating mode of the control program of the first embodiment;

FIG. 17 is a schematic overall configuration diagram illustrating a flow of a refrigerant and the like in the outside air endothermic HG dehumidification heating mode and a cooling outside air endothermic HG dehumidification heating mode of the vehicle air conditioner of the first embodiment;

FIG. 18 is a Mollier chart showing a change in the state of the refrigerant in the outside air endothermic HG dehumidification heating mode of the heat pump cycle of the first embodiment;

FIG. 19 is a flowchart showing a control process in an HG heating mode of the control program of the first embodiment;

FIG. 20 is a schematic overall configuration diagram illustrating a flow of a refrigerant and the like in the HG heating mode and a cooling HG heating mode of the vehicle air conditioner of the first embodiment;

FIG. 21 is a Mollier chart showing a change in the state of the refrigerant in the HG heating mode of the heat pump cycle of the first embodiment;

FIG. 22 is a flowchart showing a control process in a cooling HG dehumidification heating mode of the control program of the first embodiment;

FIG. 23 is a Mollier chart showing a change in the state of the refrigerant in the cooling HG dehumidification heating mode of the heat pump cycle of the first embodiment;

FIG. 24 is a flowchart showing a control process in a cooling outside air endothermic HG dehumidification heating mode of the control program of the first embodiment;

FIG. 25 is a Mollier chart showing a change in the state of the refrigerant in the cooling outside air endothermic HG dehumidification heating mode of the heat pump cycle of the first embodiment;

FIG. 26 is a flowchart showing a control process in the cooling HG heating mode of the control program of the first embodiment;

FIG. 27 is a Mollier chart showing a change in the state of the refrigerant in the cooling HG heating mode of the heat pump cycle of the first embodiment;

FIG. 28 is a flowchart showing a control process in a cooling outside air endothermic HG heating mode of the control program of the first embodiment;

FIG. 29 is a schematic overall configuration diagram illustrating a flow of a refrigerant and the like in the cooling outside air endothermic HG heating mode of the vehicle air conditioner of the first embodiment;

FIG. 30 is a Mollier chart showing a change in the state of the refrigerant in the cooling HG heating mode of the heat pump cycle of the first embodiment;

FIG. 31 is a control characteristic diagram for switching an operation mode in the control program of a second embodiment;

FIG. 32 is another control characteristic diagram for switching the operation mode in the control program of the second embodiment;

FIG. 33 is a schematic overall configuration diagram of a vehicle air conditioner of a third embodiment;

FIG. 34 is a schematic overall configuration diagram illustrating a flow of a refrigerant and the like in the HG dehumidification heating mode and the cooling HG dehumidification heating mode of the vehicle air conditioner of the third embodiment;

FIG. 35 is a schematic overall configuration diagram illustrating a flow of a refrigerant and the like in the outside air endothermic HG dehumidification heating mode and the cooling outside air endothermic HG dehumidification heating mode of the vehicle air conditioner of the third embodiment;

FIG. 36 is a schematic overall configuration diagram illustrating a flow of a refrigerant and the like in the HG heating mode and the cooling HG heating mode of the vehicle air conditioner of the third embodiment; and

FIG. 37 is a schematic overall configuration diagram illustrating a flow of a refrigerant and the like in the cooling outside air endothermic HG heating mode of the vehicle air conditioner of the third embodiment.

### DESCRIPTION OF EMBODIMENTS

A refrigeration cycle device of a comparison example includes a heat pump cycle that adjusts a temperature of ventilation air blowing a vehicle interior that is a space to be air conditioned. The heat pump cycle is configured to be able to switch a refrigerant circuit according to the operation mode in order to continuously adjust the temperature of ventilation air in a wide range. For example, when performing dehumidification heating of the vehicle interior, the heat pump cycle switches between a refrigerant circuit in a series dehumidification heating mode and a refrigerant circuit in a parallel dehumidification heating mode.

More specifically, in the series dehumidification heating mode, the heat pump cycle switches to a refrigerant circuit in which an outdoor heat exchanger is connected in series to a refrigerant flow upstream side of an indoor evaporator. The outdoor heat exchanger exchanges heat between the refrigerant and outside air. The indoor evaporator exchanges heat between the refrigerant and the ventilation air. Then, in the series dehumidification heating mode, the heating capability of the ventilation air in a heating portion is adjusted by adjusting a heat exchange amount between the refrigerant and the outside air in the outdoor heat exchanger while suppressing frost formation at the indoor evaporator.

In the parallel dehumidification heating mode, the heat pump cycle switches to a refrigerant circuit in which the outdoor heat exchanger and the indoor evaporator connected in parallel in the refrigerant flow. In this case, the refrigerant evaporation temperature at the outdoor heat exchanger is lowered than a refrigerant evaporation temperature at the indoor evaporator while suppressing frost formation at the indoor evaporator. This increases the heat absorption amount absorbed from the outside air by the refrigerant, and improves the heating capability of the ventilation air at the heating portion as compared with the series dehumidification heating mode.

That is, a vehicle air conditioner with the refrigeration cycle device of comparison example can continuously adjust the temperature of ventilation air in a wide range by switching between the refrigerant circuit in the series dehumidification heating mode and the refrigerant circuit in the parallel dehumidification heating mode when dehumidifying and heating the vehicle interior.

However, in the heat pump cycle, an evaporation pressure adjustment valve is disposed on a refrigerant flow downstream side of the indoor evaporator in order to lower the refrigerant evaporation temperature at the outdoor heat exchanger than the refrigerant evaporation temperature at the indoor evaporator during the parallel dehumidification heating mode. The evaporation pressure adjustment valve increases pressure loss of the refrigerant circulating in the heat pump cycle, causing a decrease in operation efficiency of the heat pump cycle.

In view of the above point, an object of the present disclosure is to provide a refrigeration cycle device that can continuously adjust a temperature of ventilation air in a wide range while suppressing a decrease in operation efficiency.

A refrigeration cycle device according to a first aspect of the present disclosure includes a compressor, a branch portion, a heating portion, a depressurization device, an outdoor heat exchange portion, an indoor evaporation portion, a bypass passage, a bypass flow rate adjustment portion, a merging portion, and a refrigerant circuit switching portion.

In the refrigeration cycle device, the compressor is configured to compress and discharge a refrigerant. The branch portion is configured to branch a flow of the refrigerant discharged from the compressor. The heating portion is configured to heat ventilation air blowing a space to be air conditioned, using, as a heat source, the refrigerant flowing out of a one outflow port of the branch portion. The depressurization device is configured to depressurize the refrigerant flowing out of the heating portion. The outdoor heat exchange portion is configured to exchange heat between the refrigerant flowing out of the depressurization device and outside air. The indoor evaporation portion is configured to evaporate the refrigerant depressurized at the heating-portion side depressurization portion to cool the ventilation air before being heated by the heating portion. The bypass passage guides the refrigerant flowing out of an another outflow port of the branch portion, toward a suction port side of the compressor. The bypass flow rate adjustment portion is configured to adjust a flow rate of the refrigerant flowing through the bypass passage. The merging portion is configured to merge a flow of the refrigerant flowing out of the heating-portion side depressurization portion and a flow of the refrigerant flowing out of the bypass flow rate adjustment portion, and to cause the merged refrigerant to flow toward the suction port side of the compressor. The refrigerant circuit switching portion is configured to switch a refrigerant circuit.

In addition, the depressurization device includes a first depressurization unit that depressurizes the refrigerant flowing into the outdoor heat exchange portion, a second depressurization unit that depressurizes the refrigerant flowing into the indoor evaporation portion, and a third depressurization unit that depressurizes the refrigerant bypassing the outdoor heat exchange portion and the indoor evaporation portion.

Operation modes, in which the heating portion heats the ventilation air cooled at the indoor evaporation portion, include a series dehumidification heating mode and a hot gas dehumidification heating mode.

The refrigerant circuit switching portion is configured to switch a refrigerant circuit in which the refrigerant discharged from the compressor circulates in order of the heating portion, the first depressurization unit, the outdoor heat exchange portion, the second depressurization unit, the indoor evaporation portion, and the suction port of the compressor, in the series dehumidification heating mode.

In addition, the refrigerant circuit switching portion is configured to switch a refrigerant circuit in which (i) the refrigerant discharged from the compressor circulates in order of the branch portion, the heating portion, the second depressurization unit, the indoor evaporation portion, the merging portion, and the suction port of the compressor; (ii) the refrigerant discharged from the compressor circulates in order of the branch portion, the heating portion, the third depressurization unit, the merging portion, and the suction port of the compressor, and (iii) the refrigerant discharged from the compressor circulates in order of the branch portion, the bypass passage, the merging portion, and the suction port of the compressor, in the hot gas dehumidification heating mode.

Thus, in the series dehumidification heating mode, by adjusting the throttle opening degree of at least one of the first depressurization unit and the second depressurization unit, it is possible to adjust the heat exchange amount between the refrigerant and the outside air at the outdoor heat exchange portion while suppressing frost formation at the indoor evaporation portion. Therefore, it is possible to continuously adjust the heating capability of ventilation air at the heating portion.

In the hot gas dehumidification heating mode, the refrigerant having relatively high enthalpy is merged with the refrigerant having relatively low enthalpy flowing out of the third depressurization unit, via the bypass passage. This can increase the heat dissipation amount released from the refrigerant in the heating portion without decreasing the refrigerant evaporation pressure at the indoor evaporation portion when increasing the refrigerant discharge capability of the compressor.

That is, in the hot gas dehumidification heating mode, by increasing the refrigerant discharge capability of the compressor, it is possible to improve the heating capability of the ventilation air at the heating portion more than the series dehumidification heating mode while suppressing frost formation of the indoor evaporation portion.

Furthermore, in the hot gas dehumidification heating mode, an increase amount in the compression work amount when the refrigerant discharge capability of the compressor is increased can be effectively used as a heating source of the ventilation air. Therefore, when the heating capability of the ventilation air at the heating portion is improved, a decrease in operation efficiency can be suppressed.

As a result, according to the refrigeration cycle device of the first aspect of the present disclosure, by switching between the series dehumidification heating mode and the hot gas dehumidification heating mode, it is possible to continuously adjust a temperature of ventilation air in a wide range while suppressing a decrease in operation efficiency.

A refrigeration cycle device according to a second aspect of the present disclosure includes a compressor, a branch portion, a heating portion, a depressurization device, an outdoor heat exchange portion, a bypass passage, a bypass flow rate adjustment portion, a merging portion, and a refrigerant circuit switching portion.

In the refrigeration cycle device, the compressor is configured to compress and discharge a refrigerant. The branch portion is configured to branch a flow of the refrigerant discharged from the compressor. The heating portion is configured to heat ventilation air blowing a space to be air conditioned, using, as a heat source, the refrigerant flowing out of a one outflow port of the branch portion. The depressurization device is configured to depressurize the refrigerant flowing out of the heating portion. The outdoor heat exchange portion is configured to exchange heat between the refrigerant flowing out of the depressurization device and outside air. The bypass passage guides an other stream of the refrigerant branched at the branch portion toward a suction port side of the compressor. The bypass flow rate adjustment portion is configured to adjust a flow rate of the refrigerant flowing through the bypass passage. The merging portion is configured to merge a flow of the refrigerant flowing out of the depressurization device and a flow of the refrigerant flowing out of the bypass flow rate adjustment portion, and to cause the merged refrigerant to flow toward a suction port side of the compressor. The refrigerant circuit switching portion is configured to switch a refrigerant circuit.

The depressurization device includes an outdoor side depressurization unit that depressurizes the refrigerant flowing into the outdoor heat exchange portion, and a bypass side depressurization unit that depressurizes the refrigerant bypassing the outdoor heat exchange portion.

The operation modes, in which the heating portion heats the ventilation air, includes an outside air endothermic heating mode and a hot gas heating mode.

The refrigerant circuit switching portion is configured, in the outside air endothermic heating mode, to switch a refrigerant circuit in which the refrigerant discharged from the compressor circulates in order of the heating portion, the outdoor side depressurization unit, the outdoor heat exchange portion, and the suction port of the compressor.

The refrigerant circuit switching portion is configured, in the hot gas heating mode, to switch a refrigerant circuit in which (i) the refrigerant discharged from the compressor circulates in order of the branch portion, the heating portion, the bypass side depressurization unit, the merging portion, and the suction port of the compressor; and (ii) the refrigerant discharged from the compressor circulates in order of the branch portion, the bypass passage, the merging portion, and the suction port of the compressor.

Thus, in the outside air endothermic heating mode, by adjusting at least one of the refrigerant discharge capability of the compressor and the throttle opening degree of the outdoor side depressurization unit, it is possible to adjust the heating capability of the ventilation air at the heating portion.

In the hot gas heating mode, the refrigerant having relatively high enthalpy is merged with the refrigerant flowing out of the bypass side depressurization unit, via the bypass passage. Accordingly, by increasing the refrigerant discharge capability of the compressor, the cycle can be balanced even if the heating capability of the ventilation air at the heating portion is improved.

Furthermore, in the hot gas heating mode, an increase amount in the compression work amount when the refrigerant discharge capability of the compressor is increased can be used as a heating source of the ventilation air. Therefore, when the heating capability of the ventilation air at the heating portion is improved, a decrease in operation efficiency can be suppressed.

As a result, according to the refrigeration cycle device of the second aspect of the present disclosure, by switching between the outside air endothermic heating mode and the hot gas heating mode, it is possible to continuously adjust a temperature of ventilation air in a wide range of temperatures while suppressing a decrease in operation efficiency.

A plurality of embodiments for carrying out the present disclosure will be described below with reference to the drawings. In each embodiment, parts corresponding to matters described in a preceding embodiment are denoted by the same reference signs, and redundant description may be omitted. In a case where only a part of a configuration is described in each embodiment, other parts of the configuration can be applied with other embodiments described previously. It is possible not only to combine parts explicitly described to be specifically combinable in each embodiment but also to partially combine the embodiments even if not explicitly described as long as there is no problem in the combination.

### First Embodiment

Hereinafter, the first embodiment of a refrigeration cycle device according to the present disclosure will be described with reference to the drawings. In the present embodiment, the refrigeration cycle device according to the present disclosure is applied to a vehicle air conditioner 1 mounted on an electric vehicle. The electric vehicle is a vehicle that obtains traveling drive force from an electric motor. The vehicle air conditioner 1 of the present embodiment performs air conditioning of a vehicle interior that is a space to be air conditioned, and performs temperature adjustment of in-vehicle equipment that is an object to be cooled. Therefore, the vehicle air conditioner 1 is an air conditioner with an in-vehicle equipment temperature adjustment function.

The vehicle air conditioner 1 specifically performs temperature adjustment of a battery 70 as in-vehicle equipment. The battery 70 is a secondary battery that stores electric power supplied to a plurality of pieces of in-vehicle equipment operated by electricity. The battery 70 is an assembled battery formed by electrically connecting, in series or in parallel, a plurality of stacked battery cells 71. The battery cell 71 of the present embodiment is a lithium ion battery.

The battery 70 generates heat during operation (i.e., during charging and discharging). The battery 70 is likely to have low output at low temperatures, and deterioration is likely to progress at high temperatures. For this reason, the temperature of the battery 70 needs to be maintained within an appropriate temperature range (in the present embodiment, 15° C. or higher and 55° C. or lower). Then, in the electric vehicle of the present embodiment, the temperature adjustment of the battery 70 is performed using the vehicle air conditioner 1.

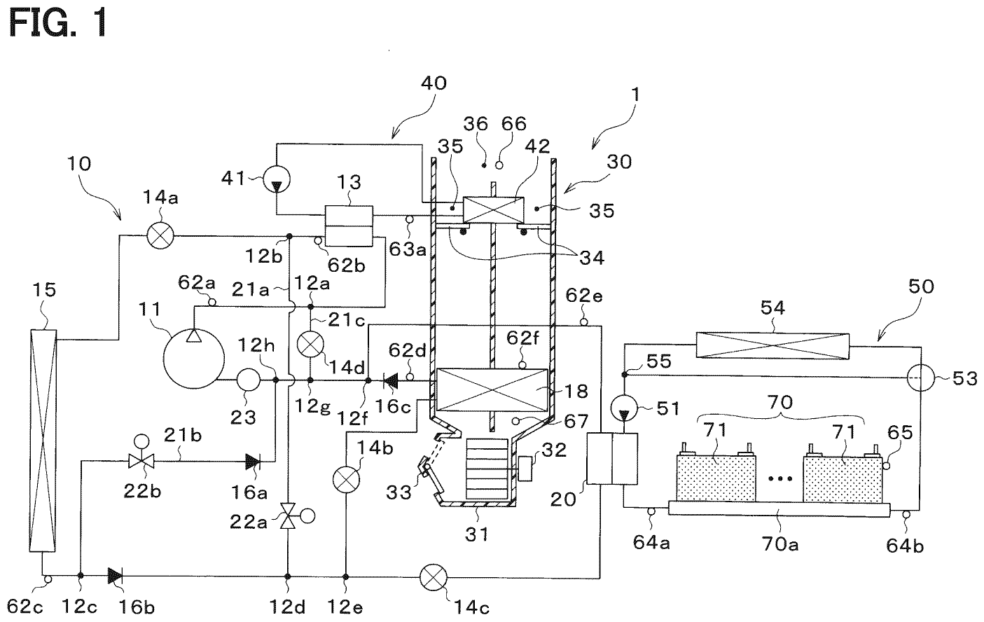

As illustrated in the overall configuration diagram of FIG. 1, the vehicle air conditioner 1 includes a heat pump cycle 10, an indoor air conditioning unit 30, a high-temperature side heat medium circuit 40, and a low-temperature side heat medium circuit 50.

The heat pump cycle 10 constitutes a vapor compression refrigeration cycle for adjusting the temperatures of the ventilation air blowing the vehicle interior, the high-temperature side heat medium circulating through the high-temperature side heat medium circuit 40, and the low-temperature side heat medium circulating through the low-temperature side heat medium circuit 50. The heat pump cycle 10 is configured to be able to switch the refrigerant circuit according to various operation modes described later for air conditioning in the vehicle interior and temperature adjustment of the in-vehicle equipment.

The heat pump cycle 10 employs an HFO refrigerant (specifically, R1234yf) as a refrigerant. The heat pump cycle 10 constitutes a vapor compression subcritical refrigeration cycle in which the pressure of the high-pressure side refrigerant does not exceed the critical pressure of the refrigerant. The refrigerant is mixed with refrigerant oil for lubricating a compressor 11. The refrigerant oil of the present embodiment is PAG oil having compatibility with a liquid phase refrigerant. Part of the refrigerant oil circulates in the cycle together with the refrigerant.

The compressor 11 sucks, compresses, and discharges the refrigerant in the heat pump cycle 10. The compressor 11 is an electric compressor that rotationally drives a fixed capacity type compression mechanism having a fixed discharge capacity by an electric motor. Refrigerant discharge capability (i.e., rotation speed) of the compressor 11 is controlled by a control signal output from a control device 60 described later.

The compressor 11 is disposed in a drive device room formed on the front side of the vehicle interior. The drive device room forms a space in which at least part of equipment (e.g., travel electric motor) or the like used for generation or adjustment of a vehicle travel drive force is disposed.

The inflow port side of a first three-way joint 12a is connected to a discharge port of the compressor 11. The first three-way joint 12a has three inflow and outflow ports communicating with one another. As the first three-way joint 12a, a joint portion formed by joining a plurality of pipes or a joint portion formed by providing a metal block or a resin block with a plurality of refrigerant passages can be employed.

Furthermore, as described later, the heat pump cycle 10 includes a second three-way joint 12b to an eighth three-way joint 12h. The basic configurations of the second three-way joint 12b to the eighth three-way joint 12h are similar to those of the first three-way joint 12a. The basic configuration of each three-way joint described in the embodiments described later is also similar to that of the first three-way joint 12a.

These three-way joints branch the flow of the refrigerant when one of the three inflow and outflow ports is used as an inflow port and the remaining two are used as outflow ports. When two of the three inflow and outflow ports are used as inflow ports and the remaining one is used as an outflow port, the flows of the refrigerant are merged. The first three-way joint 12a is an upstream side branch portion that branches the flow of the discharge refrigerant discharged from the compressor 11.

The inlet side of a refrigerant passage of a water refrigerant heat exchanger 13 is connected to one outflow port of the first three-way joint 12a. One inflow port side of a seventh three-way joint 12g is connected to the other outflow port of the first three-way joint 12a.

The refrigerant passage from the other outflow port of the first three-way joint 12a to the one inflow port of the seventh three-way joint 12g is a bypass passage 21c. A bypass side flow rate adjustment valve 14d is disposed in the bypass passage 21c.

The bypass side flow rate adjustment valve 14d is a bypass passage side depressurization portion that depressurizes the discharge refrigerant (i.e., the other refrigerant branched at the first three-way joint 12a) flowing out of the other outflow port of the first three-way joint 12a during the hot gas dehumidification heating mode or the like described later. The bypass side flow rate adjustment valve 14d is a bypass flow rate adjustment portion that adjusts the flow rate (mass flow rate) of the refrigerant flowing through the bypass passage 21c.

The bypass side flow rate adjustment valve 14d is an electric variable throttle mechanism including a valve body that changes the throttle opening degree and an electric actuator that displaces the valve body. As the electric actuator, a stepping motor or a brushless motor can be employed. Operation of the bypass side flow rate adjustment valve 14d is controlled by a control signal output from the control device 60.

The bypass side flow rate adjustment valve 14d has a full open function that functions as a simple refrigerant passage without exhibiting a refrigerant depressurization action and a flow rate adjustment action by setting the throttle opening degree to a full open state. The bypass side flow rate adjustment valve 14d has a full close function of closing the refrigerant passage by bringing the throttle opening degree to a full close state.

Furthermore, as described later, the heat pump cycle 10 includes a heating expansion valve 14a, an air conditioning expansion valve 14b, and a cooling expansion valve 14c. The basic configurations of the heating expansion valve 14a, the air conditioning expansion valve 14b, and the cooling expansion valve 14c are similar to those of the bypass side flow rate adjustment valve 14d.

The heating expansion valve 14a, the air conditioning expansion valve 14b, the cooling expansion valve 14c, and the bypass side flow rate adjustment valve 14d can switch the refrigerant circuit of the heat pump cycle 10 by exhibiting the above-described full close function. Therefore, the heating expansion valve 14a, the air conditioning expansion valve 14b, the cooling expansion valve 14c, and the bypass side flow rate adjustment valve 14d also function as a refrigerant circuit switching portion.

Of course, the heating expansion valve 14a, the air conditioning expansion valve 14b, the cooling expansion valve 14c, and the bypass side flow rate adjustment valve 14d may be formed by combining a variable throttle mechanism not having a full close function and an on-off valve that opens and closes the throttle passage. In this case, each on-off valve serves as a refrigerant circuit switching portion.

The water refrigerant heat exchanger 13 is a high-temperature side heat exchange portion that exchanges heat between the discharge refrigerant (i.e., one refrigerant branched at the first three-way joint 12a) flowing out of one outflow port of the first three-way joint 12a and the high-temperature side heat medium circulating through the high-temperature side heat medium circuit 40. The water refrigerant heat exchanger 13 is a refrigerant heat dissipation portion that heats the high-temperature side heating medium by dissipating heat of the discharge refrigerant to the high-temperature side heating medium.

The inflow port side of the second three-way joint 12b is connected to an outlet of the refrigerant passage of the water refrigerant heat exchanger 13. The refrigerant inlet side of the outdoor heat exchanger 15 is connected to one outflow port of the second three-way joint 12b. One inflow port side of a fourth three-way joint 12d is connected to the other outflow port of the second three-way joint 12b.

The refrigerant passage from the other outflow port of the second three-way joint 12b to the one inflow port of the fourth three-way joint 12d is a high-pressure side passage 21a. A high-pressure side on-off valve 21a is disposed at the high-pressure side passage 22a.

The high-pressure side on-off valve 22a is an on-off valve that opens and closes the high-pressure side passage 21a. The high-pressure side on-off valve 22a is an electromagnetic valve whose opening-closing operation is controlled by the control voltage output from the control device 60. The high-pressure side on-off valve 22a can switch the refrigerant circuit by opening and closing the high-pressure side passage 21a. Therefore, the high-pressure side on-off valve 22a is a refrigerant circuit switching portion.

The heating expansion valve 14a is disposed in a refrigerant passage from one outflow port of the second three-way joint 12b to the refrigerant inlet of the outdoor heat exchanger 15. The heating expansion valve 14a is an outdoor side depressurization portion that depressurizes the refrigerant flowing into the outdoor heat exchanger 15 during the outside air endothermic heating mode or the like described later. The heating expansion valve 14a is an outdoor side flow rate adjustment portion that adjusts the flow rate (mass flow rate) of the refrigerant flowing into the outdoor heat exchanger 15.

The outdoor heat exchanger 15 is an outdoor heat exchange portion that exchanges heat between the refrigerant flowing out of the heating expansion valve 14a and outside air blowing by an outside air fan not illustrated. The outdoor heat exchanger 15 is disposed on the front side of the drive device room. For this reason, during traveling of the vehicle, it is possible to blow travel wind flowing into the drive device room via a grill to the outdoor heat exchanger 15.

The inlet side of the third three-way joint 12c is connected to a refrigerant outlet of the outdoor heat exchanger 15. The other inflow port side of the fourth three-way joint 12d is connected to the one outflow port of the third three-way joint 12c. One inflow port side of the eighth three-way joint 12h is connected to the other outflow port of the third three-way joint 12c.

The refrigerant passage from the other outflow port of the third three-way joint 12c to the one inflow port of the eighth three-way joint 12h is a low-pressure side passage 21b. A low-pressure side on-off valve 22b and a first check valve 16a are disposed in the low-pressure side passage 21b.

The low-pressure side on-off valve 22b is an on-off valve that opens and closes the low-pressure side passage 21b. The basic configuration of the low-pressure side on-off valve 22b is similar to that of the high-pressure side on-off valve 22a. Therefore, the low-pressure side on-off valve 22b is a refrigerant circuit switching portion. The first check valve 16a permits the refrigerant to flow from the third three-way joint 12c side to the eighth three-way joint 12h side, and prohibits the refrigerant from flowing from the eighth three-way joint 12h side to the third three-way joint 12c side.

A second check valve 16b is disposed in the refrigerant passage from one outflow port of the third three-way joint 12c to the other inflow port of the fourth three-way joint 12d. The second check valve 16b permits the refrigerant to flow from the third three-way joint 12c side to the fourth three-way joint 12d side, and prohibits the refrigerant from flowing from the fourth three-way joint 12d side to the third three-way joint 12c side.

The inflow port side of the fifth three-way joint 12e is connected to the outflow port of the fourth three-way joint 12d. The refrigerant inlet side of an indoor evaporator 18 is connected to one outflow port of the fifth three-way joint 12e. The refrigerant inlet side of a chiller 20 is connected to the other outflow port of the fifth three-way joint 12e.

An air conditioning expansion valve 14b is disposed in the refrigerant passage from one outflow port of the fifth three-way joint 12e to the refrigerant inlet of the indoor evaporator 18. The air conditioning expansion valve 14b is an indoor side depressurization portion that depressurizes the refrigerant flowing out of one outflow port of the fifth three-way joint 12e during a single air conditioning mode or the like described later. The air conditioning expansion valve 14b is an indoor side flow rate adjustment portion that adjusts the flow rate (mass flow rate) of the refrigerant flowing into the indoor evaporator 18.

The indoor evaporator 18 is disposed in an air conditioning case 31 of the indoor air conditioning unit 30 described later. The indoor evaporator 18 is an air cooling heat exchange portion that exchanges heat between the low pressure refrigerant depressurized by the air conditioning expansion valve 14b and the ventilation air blowing toward the vehicle interior from an indoor blower 32. The indoor evaporator 18 is an indoor evaporation portion that cools the ventilation air by evaporating the low pressure refrigerant and exerts an endotherm action.

One inflow port side of the sixth three-way joint 12f is connected to the refrigerant outlet of the indoor evaporator 18. A third check valve 16c is disposed in the refrigerant passage from the refrigerant outlet of the indoor evaporator 18 to one inflow port of the sixth three-way joint 12f. The third check valve 16c permits the refrigerant to flow from the indoor evaporator 18 side to the sixth three-way joint 12f side, and prohibits the refrigerant from flowing from the sixth three-way joint 12f side to the indoor evaporator 18 side.

The cooling expansion valve 14c is disposed in the refrigerant passage from the other outflow port of the fifth three-way joint 12e to the refrigerant inlet of the chiller 20. The cooling expansion valve 14c is a cooling side depressurization portion that depressurizes the refrigerant flowing out of the other outflow port of the fifth three-way joint 12e during a cooling mode or the like described later. The cooling expansion valve 14c is a cooling side flow rate adjustment portion that adjusts the flow rate (mass flow rate) of the refrigerant flowing into the chiller 20.

Furthermore, the cooling expansion valve 14c serves as a bypass side depressurization portion that depressurizes the refrigerant bypassing the outdoor heat exchanger 15 and the indoor evaporation portion 18 during a hot gas (HG) dehumidification heating mode or the like described later.

The chiller 20 is a low-temperature side heat exchange portion that exchanges heat between the low pressure refrigerant depressurized by the cooling expansion valve 14c and the low-temperature side heat medium circulating through the low-temperature side heat medium circuit 50. The chiller 20 is a cooling evaporation portion that cools the low-temperature side heat medium by evaporating the low pressure refrigerant and exerts the endotherm action.

The other inflow port side of the sixth three-way joint 12f is connected to the refrigerant outlet of the chiller 20. The other inflow port side of the seventh three-way joint 12g is connected to the outflow port of the sixth three-way joint 12f. The other inflow port side of the eighth three-way joint 12h is connected to the outflow port of the seventh three-way joint 12g.

The inlet side of an accumulator 23 is connected to the outflow port of the eighth three-way joint 12h. The accumulator 23 is a low-pressure side gas-liquid separation unit that separates gas and liquid of the refrigerant flowing inside, and stores the separated liquid phase refrigerant as a surplus refrigerant of the cycle. The gas phase refrigerant outlet of the accumulator 23 is connected to the suction port side of the compressor 11.

As apparent from the above description, the seventh three-way joint 12g and the eighth three-way joint 12h merge the flow of the refrigerant flowing out of the heating expansion valve 14a, the air conditioning expansion valve 14b, and the cooling expansion valve 14c and the flow flowing out of the bypass side flow rate adjustment valve 14d. The seventh three-way joint 12g and the eighth three-way joint 12h serve as a merging portion through which the merged refrigerant flows into the suction port side of the compressor 11.

Next, the high-temperature side heat medium circuit 40 will be described. The high-temperature side heat medium circuit 40 is a heat medium circulation circuit that circulates the high-temperature side heat medium. The present embodiment employs an ethylene glycol aqueous solution as a high-temperature side heat medium. In the high-temperature side heat medium circuit 40, the heat medium passage of the water refrigerant heat exchanger 13, a high-temperature side pump 41, a heater core 42, and the like are disposed.

The high-temperature side pump 41 is a high-temperature side heat medium pump unit that pumps the high-temperature side heat medium to the inlet side of the heat medium passage of the water refrigerant heat exchanger 13. The high-temperature side pump 41 is an electric water pump whose rotation speed (i.e., the pumping capability) is controlled by the control voltage output from the control device 60.

The heat medium inlet side of the heater core 42 is connected to the outlet of the heat medium passage of the water refrigerant heat exchanger 13. The heater core 42 is an air heating heat exchange portion that exchanges heat between the high-temperature side heat medium heated by the water refrigerant heat exchanger 13 and the ventilation air having passed through the indoor evaporator 18. The heater core 42 is a heat medium heat dissipation portion that heats the ventilation air by dissipating heat of the high-temperature side heat medium to the ventilation air.

The heater core 42 is disposed in the air conditioning case 31 of the indoor air conditioning unit 30. The suction port side of the high-temperature side pump 41 is connected to the outlet of the heat medium passage of the heater core 42.

Therefore, each piece of constituent equipment of the water refrigerant heat exchanger 13 and the high-temperature side heat medium circuit 40 of the present embodiment is a heating portion that heats ventilation air blowing the vehicle interior, using, as a heat source, the refrigerant flowing out of one outflow port of the first three-way joint 12a. Furthermore, the heating expansion valve 14a, the air conditioning expansion valve 14b, and the cooling expansion valve 14c are all included in the depressurization device that depressurizes the refrigerant flowing out of the water refrigerant heat exchanger 13 forming the heating portion.

Next, the low-temperature side heat medium circuit 50 will be described. The low-temperature side heat medium circuit 50 is a heat medium circulation circuit that circulates the low-temperature side heat medium. The present embodiment employs the same type of fluid as the high-temperature side heat medium as the low-temperature side heat medium. In the low-temperature side heat medium circuit 50, the heat medium passage of the chiller 20, a low-temperature side pump 51, a cooling water passage 70a of the battery 70, a heat medium three-way valve 53, a low-temperature side radiator 54, and the like are disposed.

The low-temperature side pump 51 is a low-temperature side heat medium pump unit that pumps the low-temperature side heat medium to the inlet side of the heat medium passage of the chiller 20. The basic configuration of the low-temperature side pump 51 is similar to that of the high-temperature side pump 41.

The inlet side of the cooling water passage 70a of the battery 70 is connected to the outlet of the heat medium passage of the chiller 20. The cooling water passage 70a of the battery 70 is a cooling water passage through which the battery 70 is cooled by circulating the low-temperature side heat medium flowing out of the chiller 20. In other words, the cooling water passage 70a is a battery cooling heat exchange portion that cools the battery 70 by exchanging heat between the low-temperature side heat medium flowing through a heat medium flow path and the battery cell 71.

The cooling water passage 70a is formed inside a battery dedicated case accommodating the plurality of stacked battery cells 71. The passage configuration of the cooling water passage 70a is a passage configuration in which a plurality of passages are connected in parallel inside the battery dedicated case. Accordingly, in the cooling water passage 70a, all the battery cells 71 can be uniformly cooled.

The inflow port side of the heat medium three-way valve 53 is connected to the outlet of the cooling water passage 70a of the battery 70. The heat medium three-way valve 53 is an electric three-way flow rate adjustment valve that has one inflow port and two outflow ports and can continuously adjust a passage area ratio of the two outflow ports. Operation of the heat medium three-way valve 53 is controlled by a control signal output from the control device 60.

The heat medium inlet side of the low-temperature side radiator 54 is connected to one outflow port of the heat medium three-way valve 53. One inflow port side of a heat medium three-way joint 55 is connected to the other outflow port of the heat medium three-way valve 53. The basic configuration of the heat medium three-way joint 55 is similar to that of the refrigerant the first three-way joint 12a and the like.

The low-temperature side radiator 54 is an outside air heat exchange portion for a heat medium that exchanges heat between the refrigerant flowing out of the cooling water passage 70a and outside air blowing by an outside air fan not illustrated. The low-temperature side radiator 54 is disposed on the front side of the drive device room. For this reason, during traveling of the vehicle, it is possible to blow travel wind to the low-temperature side radiator 54. The low-temperature side radiator 54 may be formed integrally with the outdoor heat exchanger 15.

The other inflow port side of the heat medium three-way joint 55 is connected to the heat medium outlet of the low-temperature side radiator 54. The suction port side of the low-temperature side pump 51 is connected to the outflow port of the heat medium three-way joint 55.

Therefore, each piece of constituent equipment of the chiller 20 and the low-temperature side heat medium circuit 50 of the present embodiment is a cooling portion that cools the battery 70, which is an object to be cooled, by the low-temperature side heat medium flowing out of the heat medium passage of the chiller 20.

In the cooling portion of the present embodiment, the heat medium three-way valve 53 can cause the low-temperature side heat medium flowing out of the cooling water passage 70a to flow into the heat medium passage of the chiller 20. Accordingly, the heat absorbed from the battery 70 by the low-temperature side heat medium in the cooling water passage 70a can be absorbed by the low pressure refrigerant at the chiller 20.

In the cooling portion of the present embodiment, the heat medium three-way valve 53 can cause the low-temperature side heat medium flowing out of the cooling water passage 70a to flow into the low-temperature side radiator 54. Accordingly, the heat absorbed from the battery 70 by the low-temperature side heat medium in the cooling water passage 70a can be dissipated to the outside air at the low-temperature side radiator 54.

Next, the indoor air conditioning unit 30 will be described. The indoor air conditioning unit 30 is an air distribution unit in which a plurality of pieces of constituent equipment are integrated in order to blow ventilation air adjusted to an appropriate temperature for air conditioning in the vehicle interior to an appropriate site in the vehicle interior. The indoor air conditioning unit 30 is disposed inside an instrument panel at the foremost part of the vehicle interior.

As illustrated in FIG. 1, the indoor air conditioning unit 30 is formed by accommodating the indoor blower 32, the indoor evaporator 18, the heater core 42, and the like in the air conditioning case 31 forming an air passage for ventilation air. The air conditioning case 31 is shaped of resin (e.g., polypropylene) having a certain degree of elasticity and excellent strength.

An inside-outside air switching device 33 is disposed on the ventilation air flow most upstream side of the air conditioning case 31. The inside-outside air switching device 33 switches and introduces inside air (i.e., vehicle interior inside air) and outside air (i.e., vehicle interior outside air) into the air conditioning case 31. Operation of the inside-outside air switching device 33 is controlled by a control signal output from the control device 60.

The indoor blower 32 is disposed on the ventilation air flow downstream side of the inside-outside air switching device 33. The indoor blower 32 is an indoor ventilation portion that blows, toward the vehicle interior, air sucked via the inside-outside air switching device 33. The rotation speed (i.e., ventilation capability) of the indoor blower 32 is controlled by a control voltage output from the control device 60.

The indoor evaporator 18 and the heater core 42 are disposed on the ventilation air flow downstream side of the indoor blower 32. The indoor evaporator 18 is disposed on the ventilation air flow upstream side relative to the heater core 42. In the air conditioning case 31, a cold air bypass passage 35 through which the ventilation air after passing through the indoor evaporator 18 bypasses the heater core 42 is formed.

An air mix door 34 is disposed on the ventilation air flow downstream side of the indoor evaporator 18 in the air conditioning case 31 and on the ventilation air flow upstream side of the heater core 42 and the cold air bypass passage 35.

The air mix door 34 is an air volume ratio adjustment portion that adjusts an air volume ratio between the air volume of the ventilation air passing through the heater core 42 side and the air volume of the ventilation air passing through the cold air bypass passage 35 in the ventilation air after passing through the indoor evaporator 18. Operation of the driving actuator of the air mix door 34 is controlled by a control signal output from the control device 60.

A mixing space 36 is formed on the ventilation air flow downstream side of the heater core 42 and the cold air bypass passage 35 in the air conditioning case 31. The mixing space 36 is a space for mixing the ventilation air heated by the heater core 42 and the ventilation air passing through the cold air bypass passage 35 and not heated.

Therefore, in the indoor air conditioning unit 30, by adjusting the air volume ratio, the air mix door 34 adjusts the temperature of the ventilation air (i.e., conditioned air) mixed in the mixing space 36 and blown to the vehicle interior.

Furthermore, an opening hole for blowing, into the vehicle interior, the ventilation air mixed and temperature-adjusted in the mixing space is disposed in a ventilation air flow downstream portion of the air conditioning case 31.

As the opening hole, a face opening hole, a foot opening hole, and a defroster opening hole (all not illustrated) are provided. The face opening hole is an opening hole for blowing conditioned air toward the upper body of an occupant in the vehicle interior. The foot opening hole is an opening hole for blowing conditioned air toward the feet of the occupant. The defroster opening hole is an opening hole for blowing conditioned air toward a vehicle front window glass inside surface.

A face door, a foot door, and a defroster door (all not illustrated) are disposed on the ventilation air flow upstream side of the face opening hole, the foot opening hole, and the defroster opening hole, respectively. The face door adjusts the opening area of the face opening hole. The foot door adjusts the opening area of the foot opening hole. The defroster door adjusts the opening area of the defroster opening hole.

The face door, the foot door, and the defroster door are blowing port mode switching portions that switch the blowing port mode. These doors are coupled to a common blowing port mode door driving electric actuator via a link mechanism or the like, and are rotationally operated in conjunction therewith. Operation of the blowing port mode door driving electric actuator is controlled by a control signal output from the control device 60.

Therefore, in the indoor air conditioning unit 30, by the blowing port mode switching portion switching the blowing port mode by switching the opening hole that opens and closes, the conditioned air adjusted to an appropriate temperature can be blown from the mixing space 36 to an appropriate site in the vehicle interior.

Next, an outline of the electric control unit of the present embodiment will be described. The control device 60 includes a known microcomputer including a CPU, a ROM, and a RAM, and peripheral circuits thereof. Then, the control device 60 performs various calculations and processes based on a control program stored in the ROM, and controls the operations of the various pieces of equipment 11, 14a to 14d, 22a, 22b, 32, 41, 51, and 53 to be controlled and the like that are connected to the output side thereof.

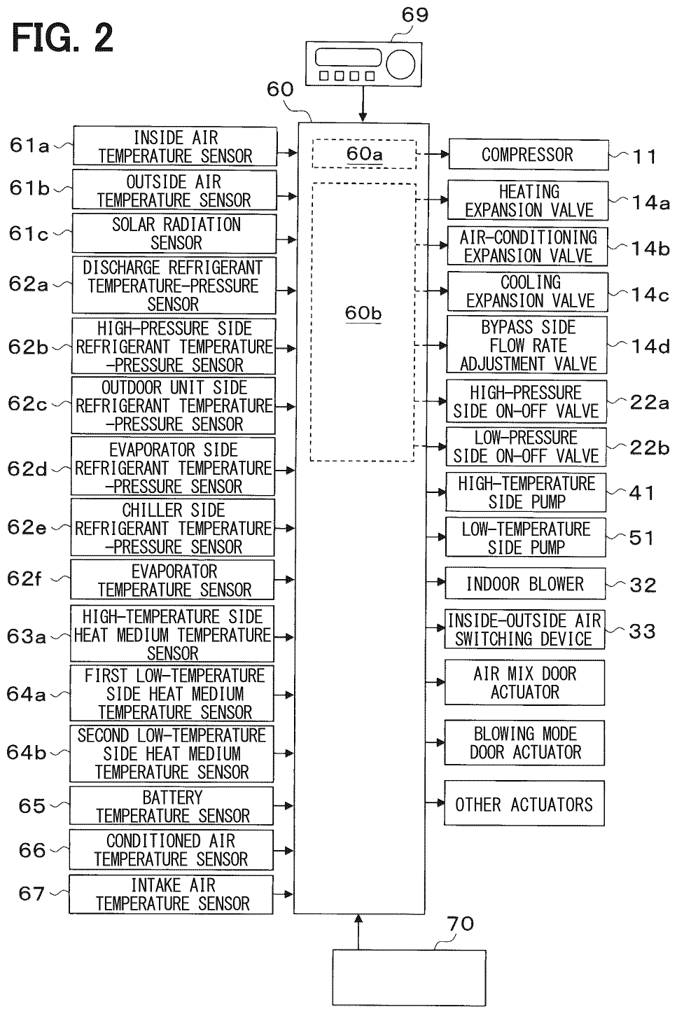

As illustrated in the block diagram of FIG. 2, a control sensor group is connected to the input side of the control device 60. A detection signal of a control sensor group is input to the control device 60. Each sensor will be described below.

An inside air temperature sensor 61a is an inside air temperature detection unit that detects a vehicle interior inside temperature (inside air temperature) Tr. An outside air temperature sensor 61b is an outside air temperature detection unit that detects a vehicle interior outside temperature (outside air temperature) Tam. A solar radiation sensor 61c is a solar radiation amount detection unit that detects a solar radiation amount As with which the vehicle interior is irradiated.

A discharge refrigerant temperature pressure sensor 62a is a discharge refrigerant temperature pressure detection unit that detects a discharge refrigerant temperature Td and a discharge refrigerant pressure Pd of the discharge refrigerant discharged from the compressor 11.

A high-pressure side refrigerant temperature pressure sensor 62b is a high-pressure side refrigerant temperature pressure detection unit that detects a high-pressure side refrigerant temperature T1 and a high-pressure side refrigerant pressure P1 of the refrigerant flowing out of the water refrigerant heat exchanger 13.

An outdoor unit side refrigerant temperature pressure sensor 62c is an outdoor unit side refrigerant temperature pressure detection unit that detects an outdoor unit side refrigerant temperature T2 and an outdoor unit side refrigerant pressure P2 of the refrigerant flowing out of the outdoor heat exchanger 15.

An evaporator side refrigerant temperature pressure sensor 62d is an evaporator side refrigerant temperature pressure detection unit that detects an evaporator side refrigerant temperature Te and an evaporator side refrigerant pressure Pe of the refrigerant flowing out of the indoor evaporator 18.

A chiller side refrigerant temperature pressure sensor 62e is a chiller side refrigerant temperature pressure detection unit that detects a chiller side refrigerant temperature Tc and a chiller side refrigerant pressure Pc of the refrigerant flowing out of the refrigerant passage of the chiller 20.

In the present embodiment, as the refrigerant temperature pressure sensor, a detection unit in which the pressure detection unit and the temperature detection unit are integrated is employed, but of course, a pressure detection unit and a temperature detection unit configured separately may be employed.

An evaporator temperature sensor 62f is an evaporator temperature detection unit that detects a refrigerant evaporation temperature (evaporator temperature) Tefin at the indoor evaporator 18. Specifically, the evaporator temperature sensor 62f of the present embodiment detects a heat exchange fin temperature of the indoor evaporator 18.

A high-temperature side heat medium temperature sensor 63a is a high-temperature side heat medium temperature detection unit that detects a high-temperature side heat medium temperature TWH, which is the temperature of the high-temperature side heat medium flowing out of the heat medium passage of the water refrigerant heat exchanger 13 and flowing into the heater core 42.

A first low-temperature side heat medium temperature sensor 64a is a first low-temperature side heat medium temperature detection unit that detects a first low-temperature side heat medium temperature TWL1, which is the temperature of the low-temperature side heat medium flowing into the cooling water passage 70a. A second low-temperature side heat medium temperature sensor 64b is a second low-temperature side heat medium temperature detection unit that detects a second low-temperature side heat medium temperature TWL2, which is the temperature of the low-temperature side heat medium flowing out of the cooling water passage 70a.

A battery temperature sensor 65 is a battery temperature detection unit that detects a battery temperature TB, which is the temperature of the battery 70. The battery temperature sensor 65 includes a plurality of temperature sensors, and detects temperatures at a plurality of sites of the battery 70. For this reason, the control device 60 can detect a temperature difference and a temperature distribution of each battery cell forming the battery 70. Furthermore, a mean value of detection values of a plurality of temperature sensors is employed as the battery temperature TB.

A conditioned air temperature sensor 66 is a conditioned air temperature detection unit that detects a ventilation air temperature TAV, which is the temperature of the ventilation air blowing the vehicle interior from the mixing space 36. An intake air temperature sensor 67 is an intake air temperature detection unit that detects an intake air temperature Tin, which is the temperature of the ventilation air flowing into the indoor evaporator 18.

Furthermore, as illustrated in FIG. 2, an operation panel 69 disposed near an instrument panel in the vehicle interior front portion is connected to the input side of the control device 60. Operation signals from various operation switches provided at the operation panel 69 are input to the control device 60.

Specific examples of the various operation switches provided at the operation panel 69 include an automatic switch, an air conditioner switch, an air volume setting switch, a temperature setting switch, and a blowing port mode switch.

The automatic switch is an automatic control setting unit that sets or cancels automatic control operation of the vehicle air conditioner 1. The air conditioner switch is a cooling request unit that requests cooling of the ventilation air at the indoor evaporator 18. The air volume setting switch is an air volume setting unit that manually sets the ventilation air volume of the indoor blower 32. The temperature setting switch is a temperature setting unit that sets a vehicle interior setting temperature Tset. The blowing port mode switch is a blowing port mode setting unit that manually sets the blowing port mode.

Note that the control device 60 of the present embodiment is integrally configured with the control unit that controls various pieces of equipment to be controlled that are connected to the output side thereof. Therefore, a configuration (hardware and software) that controls the operation of the equipment to be controlled constitutes a control unit that controls the operation of respective pieces of equipment to be controlled.

For example, in the control device 60, a configuration that controls the rotation speed of the compressor 11 constitutes a discharge capability control unit 60a. The configuration that controls the operation of the refrigerant circuit switching portion such as the high-pressure side on-off valve 22a or the low-pressure side on-off valve 22b constitutes a refrigerant circuit switching control unit 60b.

Next, the operation of the present embodiment in the above configuration will be described. As mentioned earlier, the vehicle air conditioner 1 of the present embodiment performs air conditioning of the inside of the vehicle interior and performs temperature adjustment of the battery 70. Therefore, the vehicle air conditioner 1 can execute the following 16 types of operation modes.
(1) Single air conditioning mode: The single air conditioning mode is included in a cooling mode for cooling the vehicle interior by cooling and blowing, into the vehicle interior, the ventilation air. The single air conditioning mode is an operation mode for cooling the vehicle interior without cooling the battery 70.
(2) Series dehumidification heating mode: The series dehumidification heating mode is included in a dehumidification heating mode for performing dehumidification heating of the vehicle interior by reheating and blowing, into the vehicle interior, cooled and dehumidified ventilation air. The series dehumidification heating mode is an operation mode for performing dehumidification heating of the vehicle interior without cooling the battery 70.
(3-1) Hot gas dehumidification heating mode (Hereinafter, HG dehumidification heating mode): The HG dehumidification heating mode is included in the dehumidification heating mode. The HG dehumidification heating mode is an operation mode for performing dehumidification heating of the vehicle interior with higher heating capability than that in the series dehumidification heating mode without cooling the battery 70.
(3-2) Outside air endothermic hot gas dehumidification heating mode (Hereinafter, outside air endothermic HG dehumidification heating mode): The outside air endothermic HG dehumidification heating mode is included in the dehumidification heating mode. The outside air endothermic HG dehumidification heating mode is an operation mode for performing dehumidification heating of the vehicle interior with higher heating capability than that in the series dehumidification heating mode and higher operation efficiency than that of the HG dehumidification heating mode without cooling the battery 70.
(4-1) Outside air endothermic heating mode: The outside air endothermic heating mode is included in a heating mode for heating the vehicle interior by heating and blowing, into the vehicle interior, the ventilation air. The outside air endothermic heating mode is an operation mode for heating the vehicle interior without cooling the battery 70.
(4-2) Hot gas heating mode (Hereinafter, HG heating mode): The HG heating mode is included in the heating mode. The HG heating mode is an operation mode for heating the vehicle interior with higher heating capability than that in the outside air endothermic heating mode without cooling the battery 70.
(5) Cooling air conditioning mode: The cooling air conditioning mode is included in the air conditioning mode. The cooling air conditioning mode is an operation mode for performing air conditioning of the vehicle interior together with cooling the battery 70.
(6) Cooling series dehumidification heating mode: The cooling series dehumidification heating mode is included in the dehumidification heating mode. The cooling series dehumidification heating mode is an operation mode for performing dehumidification heating of the vehicle interior together with cooling the battery 70.
(7-1) Cooling hot gas dehumidification heating mode (Hereinafter, cooling HG dehumidification heating mode): The cooling HG dehumidification heating mode is included in the dehumidification heating mode. The cooling HG dehumidification heating mode is an operation mode for performing dehumidification heating of the vehicle interior with higher heating capability than that in the cooling series dehumidification heating mode together with cooling the battery 70.
(7-2) Cooling outside air endothermic hot-gas dehumidification heating mode (Hereinafter, cooling outside air endothermic HG dehumidification heating mode): The cooling outside air endothermic HG dehumidification heating mode is included in the dehumidification heating mode. The cooling outside air endothermic HG dehumidification heating mode is an operation mode for performing dehumidification heating of the vehicle interior with higher heating capability than that in the cooling series dehumidification heating mode and higher operation efficiency than that in the cooling HG dehumidification heating mode together with cooling the battery 70.
(8) Cooling equipment endothermic heating mode: The cooling equipment endothermic heating mode is included in the heating mode. The cooling equipment endothermic heating mode is an operation mode for heating the vehicle interior using waste heat absorbed from the battery 70 by the refrigerant together with cooling the battery 70.
(9) Cooling outside air endothermic heating mode: The cooling outside air endothermic heating mode is included in the heating mode. The cooling outside air endothermic heating mode is an operation mode for heating the vehicle interior using heat absorbed from the outside air by the refrigerant together with cooling the battery 70.
(10-1) Cooling hot gas heating mode (Hereinafter, cooling HG heating mode): The cooling HG heating mode is included in the heating mode. The cooling HG heating mode is an operation mode for heating the vehicle interior with higher heating capability than that in the cooling outside air endothermic heating mode together with cooling the battery 70.
(10-2) Cooling outside air endothermic hot gas heating mode (Hereinafter, cooling outside air endothermic HG heating mode): The cooling outside air endothermic HG heating mode is included in the heating mode. The cooling outside air endothermic HG heating mode is an operation mode for heating the vehicle interior with higher heating capability than that in the cooling outside air endothermic heating mode and higher operation efficiency than that in the cooling HG heating mode together with cooling the battery 70.
(11) Cooling mode: An operation mode for cooling the battery 70 without performing air conditioning of the vehicle interior.
(12) Ventilation mode: An operation mode for blowing ventilation air into the vehicle interior without performing cooling of the battery 70 and temperature adjustment of conditioned air.

Switching between these operation modes is performed by a control program stored in advance in the control device 60 being executed. The control program is executed not only when a start switch (what is called ignition switch) of the vehicle system is turned on and the vehicle system is activated but also when the battery 70 is charged from an external power source. In the control program, the vehicle interior is air conditioned when the automatic switch is turned on.

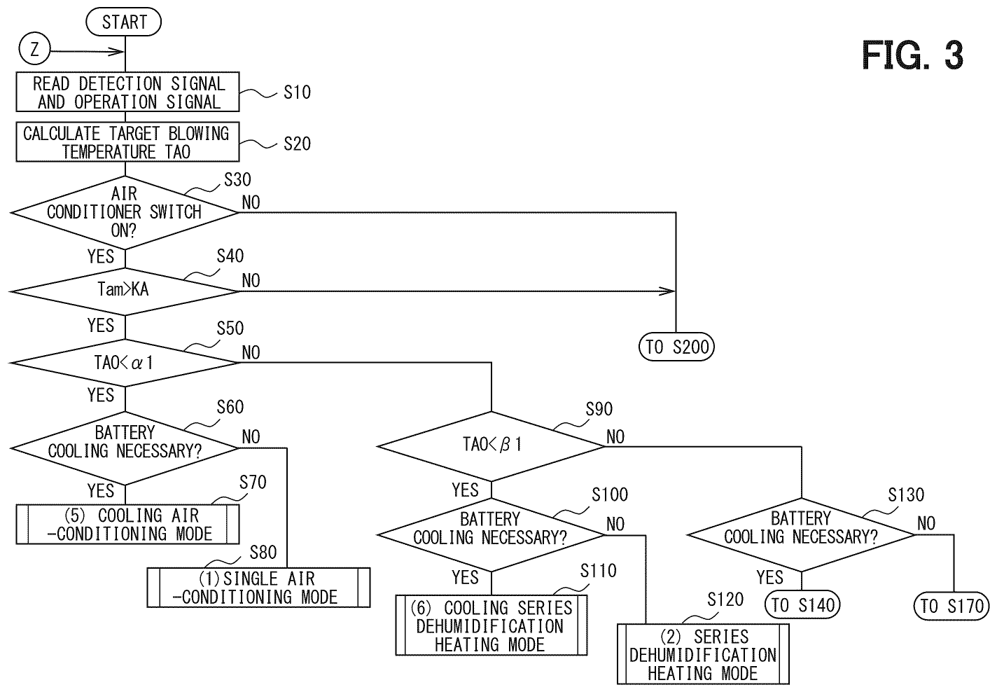

The control program will be described with reference to FIG. 3 and the like. Each control step described in the flowchart of FIG. 3 and the like is various function implementation units included in the control device 60.

First, in step S10 of FIG. 3, a detection signal of the sensor group and an operation signal of the operation panel 69 described above are read. Next, in step S20, a target blowing temperature TAO, which is a target temperature of the ventilation air blowing the vehicle interior, is determined based on the detection signal and the operation signal read in step S10. Therefore, step S20 is a target blowing temperature determination unit.

Specifically, the target blowing temperature TAO is calculated by the following Formula F1.

TAO=Kset×Tset−Kr×Tr−Kam×Tam−Ks×As+C (F1)

Tset is a vehicle interior setting temperature set by the temperature setting switch. Tr is an inside air temperature detected by the inside air temperature sensor 61a. Tam is an outside air temperature detected by the outside air temperature sensor 61b. As is a solar radiation amount detected by the solar radiation sensor 61c. Kset, Kr, Kam, and Ks are control gains, and C is a correction constant.

Next, in step S30, it is determined whether the air conditioner switch is turned on. As mentioned earlier, the air conditioner switch is a cooling request unit that requests cooling of the ventilation air at the indoor evaporator 18. Therefore, turning on the air conditioner switch means that the occupant requests cooling or dehumidifying and heating of the vehicle interior.

If it is determined in step S30 that the air conditioner switch is turned ON, the process proceeds to step S40. If it is determined in step S30 that the air conditioner switch is not turned ON, the process proceeds to step S200.

In step S40, it is determined whether the outside air temperature Tam is higher than a predetermined reference outside air temperature KA (in the present embodiment, 0° C.). The reference outside air temperature KA is set such that cooling the ventilation air by the indoor evaporator 18 is valid for cooling or dehumidifying the space to be air conditioned.

More specifically, in the present embodiment, the refrigerant evaporation temperature at the indoor evaporator 18 is adjusted to be equal to or greater than the frost formation suppressing temperature (in the present embodiment, 1° C.) at which frost formation at the indoor evaporator 18 can be suppressed in the operation mode for evaporating the refrigerant at the indoor evaporator 18. For this reason, the indoor evaporator 18 cannot cool the ventilation air to a temperature lower than the frost formation suppressing temperature.

That is, when the temperature of the ventilation air flowing into the indoor evaporator 18 is lower than the frost formation suppressing temperature, it is not valid to cool the ventilation air at the indoor evaporator 18. Therefore, the reference outside air temperature KA is set to a value lower than the frost formation suppressing temperature, and the indoor evaporator 18 does not cool the ventilation air when the outside air temperature Tam is equal to or less than the reference outside air temperature KA.

If it is determined in step S40 that the outside air temperature Tam is higher than the reference outside air temperature KA, the process proceeds to step S50. If it is determined in step S40 that the outside air temperature Tam is not higher than the reference outside air temperature KA, the process proceeds to step S200.

In step S50, it is determined whether the target blowing temperature TAO is lower than a cooling reference temperature α1. The cooling reference temperature α1 is a reference value for determining whether to cool the vehicle interior. The cooling reference temperature α1 is determined with reference to a control map stored in advance in the control device 60 based on the outside air temperature Tam.

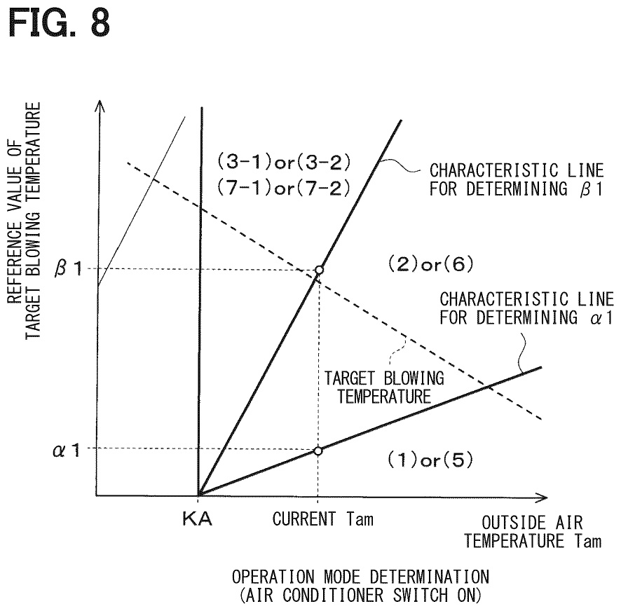

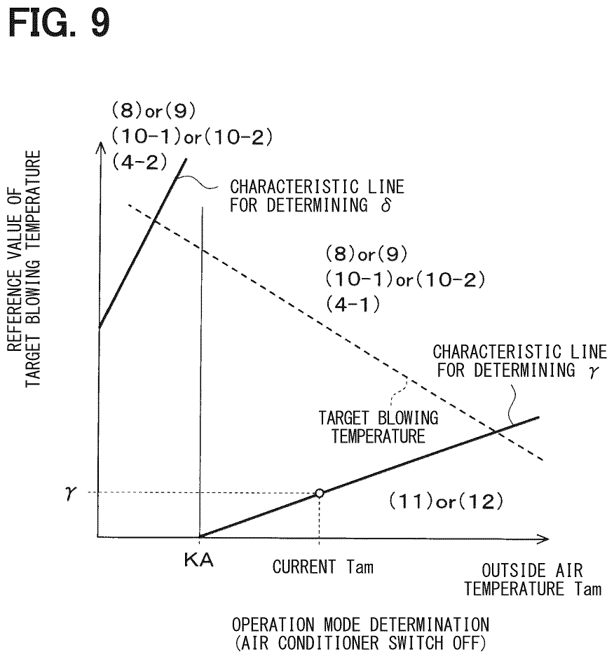

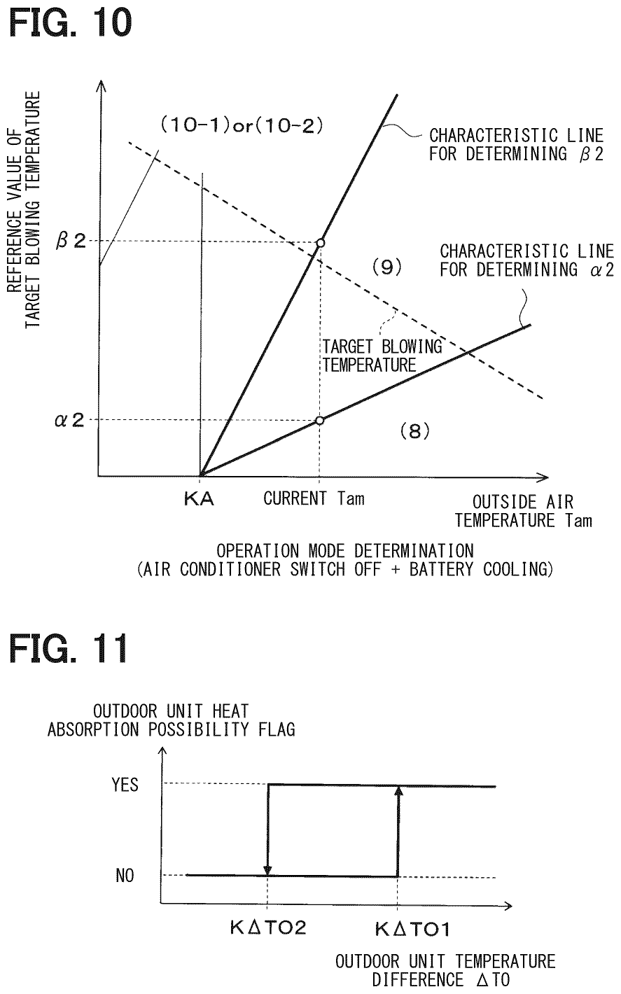

In the control map of the present embodiment, as shown in FIG. 8, the cooling reference temperature α1 is determined to be a low value along with the decrease in the outside air temperature Tam. FIG. 8 is a control characteristic diagram for determining the operation mode when the air conditioner switch is on. The number in parentheses in the drawing corresponds to the above-described operation mode. The same applies to the control characteristic diagrams of FIGS. 9 and 10.

If it is determined in step S50 that the target blowing temperature TAO is lower than the cooling reference temperature α1, the process proceeds to step S60. If it is determined in step S50 that the target blowing temperature TAO is not lower than the cooling reference temperature α1, the process proceeds to step S90.

In step S60, it is determined whether cooling of the battery 70 is necessary. Specifically, in the present embodiment, when the battery temperature TB detected by the battery temperature sensor 65 is equal to or greater than a predetermined reference cooling temperature KTB (in the present embodiment, 35° C.), it is determined that cooling of the battery 70 is necessary. When the battery temperature TB is lower than the reference cooling temperature KTB, it is determined that cooling of the battery 70 is not necessary.

Of course, in a case where the battery temperature TB is in the process of rising, it may be determined that cooling of the battery 70 is necessary when the battery temperature TB is equal to or greater than the reference cooling temperature KTB. Furthermore, in a case where the battery temperature TB is in the process of lowering, it may be determined that cooling of the battery 70 is not necessary when the battery temperature TB is equal to or less than a low-temperature side reference cooling temperature KTBL.

If it is determined in step S60 that cooling of the battery 70 is necessary, the process proceeds to step S70, and the (5) cooling air conditioning mode is selected as an operation mode. If it is determined in step S60 that cooling of the battery 70 is not necessary, the process proceeds to step S80, and the (1) single air conditioning mode is selected as an operation mode.

In step S90, it is determined whether the target blowing temperature TAO is lower than a dehumidification reference temperature β1. The dehumidification reference temperature β1 is a reference value for determining whether to need to heat the ventilation air with high heating capability when performing dehumidification and heating of the vehicle interior.

The dehumidification reference temperature β1 is determined with reference to a control map stored in advance in the control device 60 based on the outside air temperature Tam. In the control map of the present embodiment, as shown in FIG. 8, similarly to the cooling reference temperature α1, the dehumidification reference temperature β1 is determined to be a low value along with the decrease in the outside air temperature Tam. Furthermore, at the same outside air temperature Tam, the dehumidification reference temperature β1 is determined to be a value higher than the cooling reference temperature α1.

If it is determined in step S90 that the target blowing temperature TAO is lower than the dehumidification reference temperature β1, the process proceeds to step S100. If it is determined in step S90 that the target blowing temperature TAO is not lower than the dehumidification reference temperature β1, the process proceeds to step S130.

In step S100, similarly to step S60, it is determined whether cooling of the battery 70 is necessary.

If it is determined in step S100 that cooling of the battery 70 is necessary, the process proceeds to step S110, and the (6) cooling series dehumidification heating mode is selected as an operation mode. If it is determined in step S100 that cooling of the battery 70 is not necessary, the process proceeds to step S120, and the (2) series dehumidification heating mode is selected as an operation mode.

In step S130, similarly to step S60, it is determined whether cooling of the battery 70 is necessary. If it is determined in step S130 that cooling of the battery 70 is necessary, the process proceeds to step S140. If it is determined in step S130 that cooling of the battery 70 is not necessary, the process proceeds to step S170.

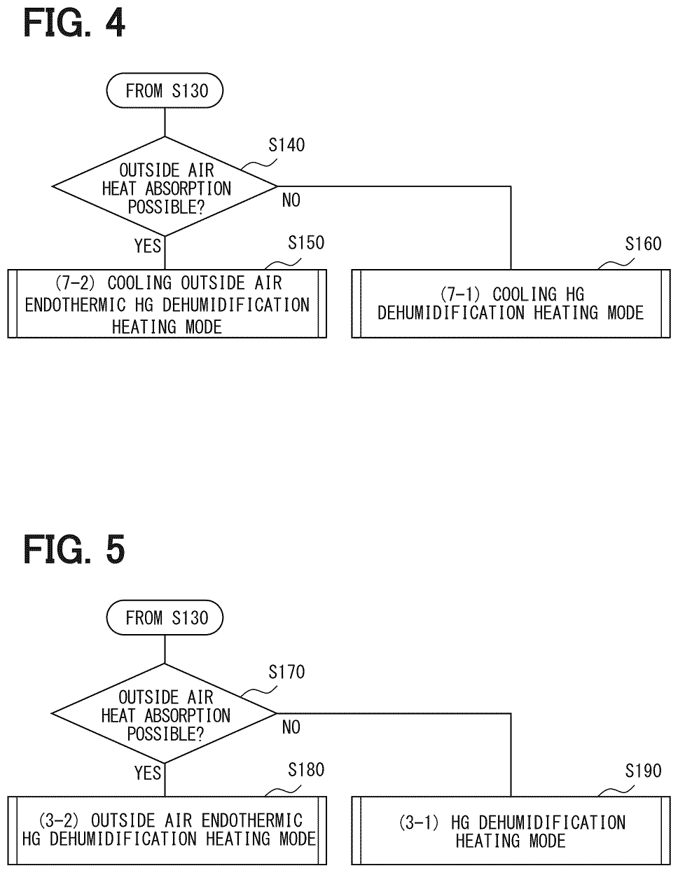

In step S140, as shown in FIG. 4, it is determined whether the outdoor heat exchanger 15 can cause the refrigerant to appropriately absorb heat of the outside air. In step S140 of the present embodiment, it is determined whether the outside air heat absorption is possible using an outdoor unit heat absorption possibility flag and a blowing temperature excess flag.

As shown in FIG. 11, the outdoor unit heat absorption possibility flag is determined using an outdoor unit temperature difference ΔTO. The outdoor unit temperature difference ΔTO is a value (Tam−Tout) in which an outdoor unit temperature Tout corresponding to the refrigerant temperature at the outdoor heat exchanger 15 is subtracted from the outside air temperature Tam.

In step S140, a target evaporator temperature TEO is employed as the outdoor unit temperature Tout. The target evaporator temperature TEO is a target value of the refrigerant evaporation temperature at the indoor evaporator 18. As in the dehumidification heating mode, in the refrigerant circuit in which the indoor evaporator 18 and the outdoor heat exchanger 15 are connected in parallel to the refrigerant flow, the outdoor unit temperature Tout at the outdoor heat exchanger 15 also approaches the target evaporator temperature TEO.

As shown in FIG. 11, in a case where the outdoor unit temperature difference ΔTO is in the process of increasing, the outdoor unit heat absorption possibility flag is set to “possible” when the outdoor unit temperature difference ΔTO becomes equal to or greater than a first reference temperature difference KΔTO1. When the outdoor unit heat absorption possibility flag is “possible”, the refrigerant temperature at the outdoor heat exchanger 15 is sufficiently lower than the outside air temperature Tam, and the refrigerant can absorb heat from the outside air at the outdoor heat exchanger 15.

In a case where the outdoor unit temperature difference ΔTO is in the process of decreasing, the outdoor unit heat absorption possibility flag is set to “impossible” when the outdoor unit temperature difference ΔTO becomes equal to or less than a second reference temperature difference KΔTO2. When the outdoor unit heat absorption possibility flag is “impossible”, it means that the refrigerant temperature at the outdoor heat exchanger 15 is not sufficiently lower than the outside air temperature Tam, and the refrigerant cannot absorb heat from the outside air at the outdoor heat exchanger 15.

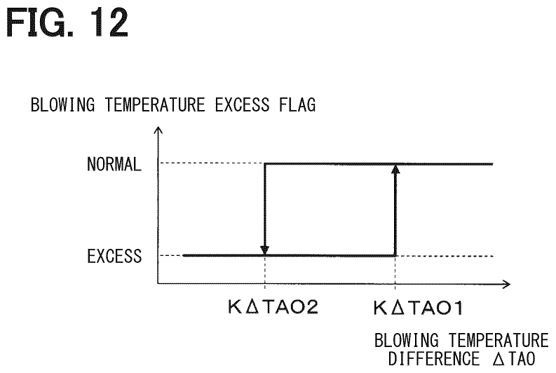

As shown in FIG. 12, the blowing temperature excess flag is determined using a blowing temperature difference ΔTAO. The blowing temperature difference ΔTAO is a value (TAO−TAOA) in which an estimated blowing temperature TAOA is subtracted from the target blowing temperature TAO.

The estimated blowing temperature TAOA is determined with reference to a control map stored in the control device 60 based on the outside air temperature Tam and the intake air temperature Tin detected by the intake air temperature sensor 67. In the control map of the present embodiment, the estimated blowing temperature TAOA is determined to rise along with rise of the outside air temperature Tam. The estimated blowing temperature TAOA is determined to rise along with rise of the intake air temperature Tin.

As shown in FIG. 12, in a case where the blowing temperature difference ΔTAO is in the process of increasing, the blowing temperature excess flag is set to “normal” when the blowing temperature difference ΔTAO is equal to or greater than a first reference blowing temperature difference KΔTAO1. When the blowing temperature excess flag is “normal”, the estimated blowing temperature TAOA is sufficiently lower than the target blowing temperature TAO, which means that the ventilation air can be heated using the heat absorbed from the outside air by the refrigerant.

In a case where the blowing temperature difference ΔTAO is in the process of decreasing, the blowing temperature excess flag is set to “excess” when the blowing temperature difference ΔTAO is equal to or less than a second reference blowing temperature difference KΔTAO2. When the blowing temperature excess flag is “excess”, the estimated blowing temperature TAOA is close to the target blowing temperature TAO, which means that the heating capability of the ventilation air becomes excessive if the ventilation air is heated using the heat absorbed from the outside air by the refrigerant.

Therefore, in step S140 of the present embodiment, when the outdoor unit heat absorption possibility flag is “possible” and the blowing temperature excess flag is “normal”, it is determined to be able to cause the refrigerant to appropriately absorb the heat of the outside air at the outdoor heat exchanger 15. That is, it is determined that outside air heat absorption is possible.

If it is determined in step S140 that outside air heat absorption is possible, as shown in FIG. 4, the process proceeds to step S150, and the (7-2) cooling outside air endothermic HG dehumidification heating mode is selected as an operation mode. If it is determined in step S140 that outside air heat absorption is not possible, the process proceeds to step S160, and the (7-1) cooling HG dehumidification heating mode is selected as an operation mode.

In step S170, as shown in FIG. 5, similarly to step S140, it is determined whether outside air heat absorption is possible. In step S170, the target evaporator temperature TEO is employed as the outdoor unit temperature Tout.

If it is determined in step S170 that outside air heat absorption is possible, the process proceeds to step S180, and the (3-2) outside air endothermic HG dehumidification heating mode is selected as an operation mode. If it is determined in step S170 that outside air heat absorption is not possible, the process proceeds to step S190, and the (3-1) HG dehumidification heating mode is selected as an operation mode.

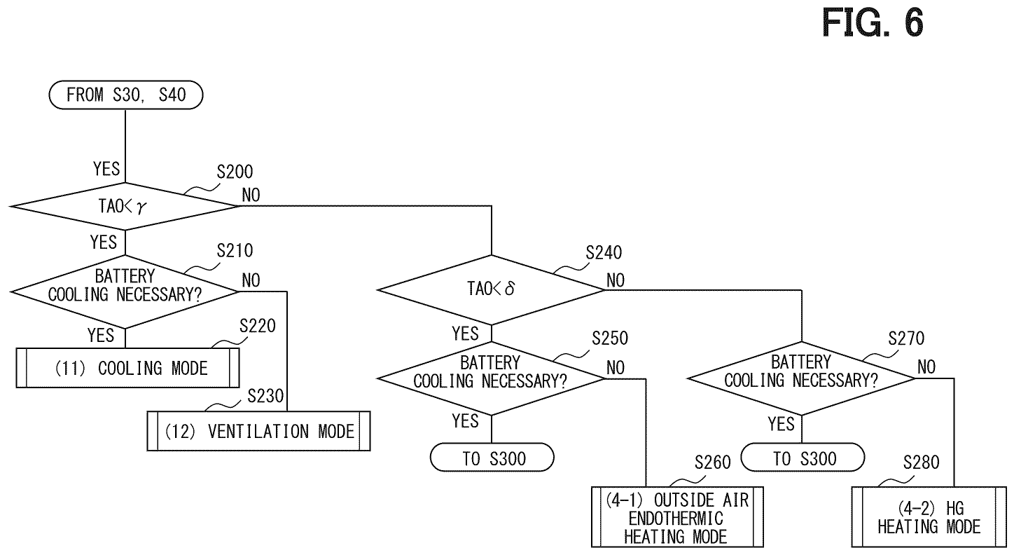

Next, a case where the process proceeds from step S30 or step S40 to step S200 will be described. In step S200, as shown in FIG. 6, it is determined whether the target blowing temperature TAO is lower than a heating reference temperature γ. The heating reference temperature γ is a reference value for determining whether to heat the vehicle interior.

The heating reference temperature γ is determined with reference to a control map stored in advance in the control device 60 based on the outside air temperature Tam. In the control map of the present embodiment, as shown in FIG. 9, the heating reference temperature γ is determined to be a low value along with the decrease in the outside air temperature Tam. The heating reference temperature γ is set such that heating the ventilation air by the heater core 42 forming the heating portion is valid for heating the space to be air conditioned.

If it is determined in step S200 that the target blowing temperature TAO is lower than the heating reference temperature γ, it is a case where the heater core 42 does not need to heat the ventilation air, and the process proceeds to step S210. If it is determined in step S200 that the target blowing temperature TAO is not lower than the heating reference temperature γ, it is a case where the heater core 42 needs to heat the ventilation air, and the process proceeds to step S240.

In step S210, similarly to step S60, it is determined whether cooling of the battery 70 is necessary.

If it is determined in step S210 that cooling of the battery 70 is necessary, the process proceeds to step S220, and the (11) cooling mode is selected as the operation mode. If it is determined in step S210 that cooling of the battery 70 is not necessary, the process proceeds to step S230, and the (12) ventilation mode is selected as an operation mode.

In step S240, it is determined whether the target blowing temperature TAO is lower than a hot gas reference temperature δ. The hot gas reference temperature δ is a reference value for determining whether to need to heat the ventilation air with high heating capability when heating the vehicle interior.

The hot gas reference temperature δ is determined with reference to a control map stored in advance in the control device 60 based on the outside air temperature Tam. In the control map of the present embodiment, as shown in FIG. 9, similarly to the heating reference temperature γ, the hot gas reference temperature δ is determined to be a low value along with the decrease in the outside air temperature Tam. Furthermore, the hot gas reference temperature δ is determined to be a value higher than the heating reference temperature γ.

If it is determined in step S240 that the target blowing temperature TAO is lower than the hot gas reference temperature δ, the process proceeds to step S250. If it is determined in step S240 that the target blowing temperature TAO is not lower than the hot gas reference temperature δ, the process proceeds to step S270.

In step S250, similarly to step S60, it is determined whether cooling of the battery 70 is necessary.

If it is determined in step S250 that cooling of the battery 70 is necessary, the process proceeds to step S300. If it is determined in step S250 that cooling of the battery 70 is not necessary, the process proceeds to step S260, and the (4-1) outside air endothermic heating mode is selected as an operation mode.

In step S270, similarly to step S60, it is determined whether cooling of the battery 70 is necessary.

If it is determined in step S270 that cooling of the battery 70 is necessary, the process proceeds to step S300. If it is determined in step S270 that cooling of the battery 70 is not necessary, the process proceeds to step S280, and the (4-2) HG heating mode is selected as an operation mode.

Here, when it is determined in steps S250 and S270 that cooling of the battery 70 is necessary and the process proceeds to step S300, both heating of the vehicle interior and cooling of the battery 70 need to be performed. For this reason, in the heat pump cycle 10, it is necessary to appropriately adjust the heat dissipation amount at which the refrigerant dissipates heat to the high-temperature side heat medium in the water refrigerant heat exchanger 13 and the heat absorption amount at which the refrigerant absorbs heat from the low-temperature side heat medium at the chiller 20.

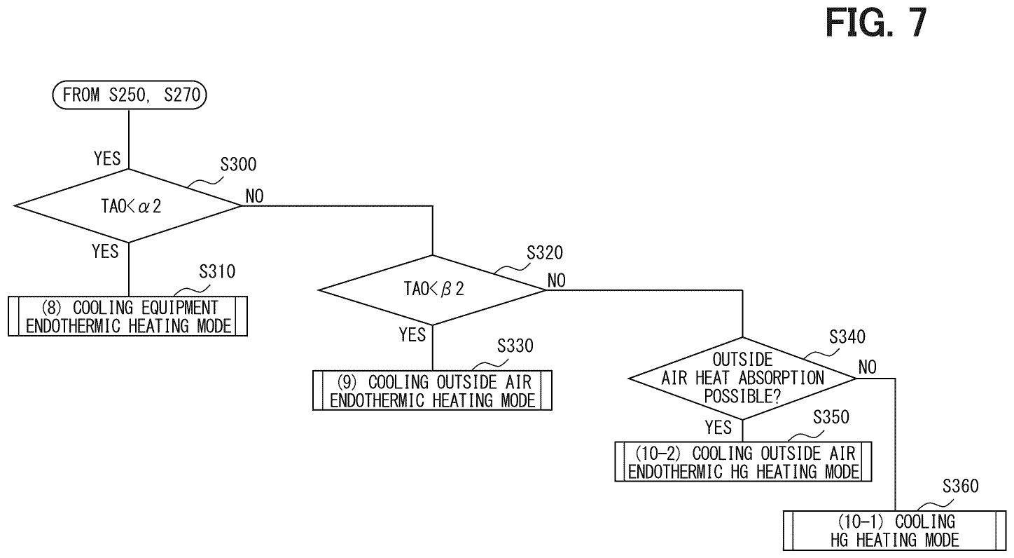

Then, in step S300, as shown in FIG. 7, it is determined whether the target blowing temperature TAO is lower than a first cooling heating reference temperature α2. The first cooling heating reference temperature α2 is a reference value for determining whether to need to heat the ventilation air with high heating capability when heating the vehicle interior.

The first cooling heating reference temperature α2 is determined with reference to a control map stored in advance in the control device 60 based on the outside air temperature Tam. In the control map of the present embodiment, as shown in FIG. 10, the first cooling heating reference temperature α2 is determined to be a low value along with the decrease in the outside air temperature Tam. Here, at the same outside air temperature Tam, the first cooling heating reference temperature α2 is determined to be a value higher than the cooling reference temperature α1.

If it is determined in step S300 that the target blowing temperature TAO is lower than the first cooling heating reference temperature α2, the process proceeds to step S310, and the (8) cooling equipment endothermic heating mode is selected as an operation mode. If it is determined in step S300 that the target blowing temperature TAO is not lower than the first cooling heating reference temperature α2, the process proceeds to step S320.

In step S320, it is determined whether the target blowing temperature TAO is lower than a second cooling heating reference temperature β2. The second cooling heating reference temperature β2 is a reference value for determining whether to need to heat the ventilation air with higher heating capability when heating the vehicle interior.

The second cooling heating reference temperature β2 is determined with reference to a control map stored in advance in the control device 60 based on the outside air temperature Tam. In the control map of the present embodiment, as shown in FIG. 10, similarly to the first cooling heating reference temperature α2, the second cooling heating reference temperature β2 is determined to be a low value along with the decrease in the outside air temperature Tam. Furthermore, at the same outside air temperature Tam, the second cooling heating reference temperature β2 is determined to be a value higher than the dehumidification reference temperature β1.

If it is determined in step S320 that the target blowing temperature TAO is lower than the second cooling heating reference temperature 2, the process proceeds to step S330, and the (9) cooling outside air endothermic heating mode is selected as an operation mode. If it is determined in step S320 that the target blowing temperature TAO is not lower than the second cooling heating reference temperature β2, the process proceeds to step S340.

In step S340, it is determined whether outside air heat absorption is possible. In step S340, the saturation temperature of the refrigerant at a target low pressure PSO is employed as the outdoor unit temperature Tout. The target low pressure PSO is a target value of the temperature of the refrigerant sucked into the compressor 11. In the refrigerant circuit in the heating mode, the outdoor unit temperature Tout at the outdoor heat exchanger 15 also approaches the saturation temperature of the refrigerant at the target low pressure PSO. The others are determined similarly to step S140.

If it is determined in step S340 that outside air heat absorption is possible, the process proceeds to step S350, and the (10-2) cooling outside air endothermic HG heating mode is selected as an operation mode. If it is determined in step S340 that outside air heat absorption is not possible, the process proceeds to step S360, and the (10-1) cooling HG heating mode is selected as an operation mode.

In the control program of the present embodiment, the operation mode is switched as described above. Then, a control routine such as reading of the detection signal and the operation signal described above, calculation of the target blowing temperature TAO, selection of the operation mode, and control of various pieces of equipment to be controlled according to the operation mode is repeated every predetermined control cycle until an end condition of the predetermined control program is established. The detailed operation of each operation mode will be described below.

### (1) Single Air Conditioning Mode

In the single air conditioning mode, the control device 60 executes a single air conditioning mode control flow. In the single air conditioning mode control flow, the control device 60 determines the target evaporator temperature TEO. The target evaporator temperature TEO is a target value of the refrigerant evaporation temperature at the indoor evaporator 18. Therefore, the single air conditioning mode control flow includes a target evaporator temperature determination unit that determines the target evaporator temperature TEO.

The target evaporator temperature determination unit determines the target evaporator temperature TEO with reference to a control map stored in advance in the control device 60 based on the target blowing temperature TAO. In the control map of the single air conditioning mode, the target evaporator temperature TEO is determined to rise along with the target blowing temperature TAO. The target evaporator temperature TEO is determined to be a temperature (in the present embodiment, 1° C. or higher) at which frost formation does not occur at the indoor evaporator 18.

Furthermore, the control device 60 determines an increase-decrease amount ΔIVO of the rotation speed of the compressor 11. The increase-decrease amount ΔIVO in the single air conditioning mode is determined such that the evaporator temperature Tefin approaches the target evaporator temperature TEO by a feedback control method based on a deviation between the target evaporator temperature TEO and the evaporator temperature Tefin detected by the evaporator temperature sensor 62f.

The control device 60 determines a target subcooling degree SCO2 of the refrigerant flowing out of the outdoor heat exchanger 15. The target subcooling degree SCO2 is determined with reference to a control map stored in advance in the control device 60 based on the outside air temperature Tam. In the control map of the single air conditioning mode, the target subcooling degree SCO2 is determined such that the coefficient of performance (COP) of the cycle approaches the maximum value.

Furthermore, the control device 60 determines an increase-decrease amount ΔEVC of the throttle opening degree of the air conditioning expansion valve 14b. The increase-decrease amount ΔEVC in the single air conditioning mode is determined such that the subcooling degree SC2 of the outlet side refrigerant at the outdoor heat exchanger 15 approaches the target subcooling degree SCO2 by a feedback control method based on a deviation between the target subcooling degree SCO2 and the subcooling degree SC2 of the outlet side refrigerant at the outdoor heat exchanger 15.

The subcooling degree SC2 of the outlet side refrigerant at the outdoor heat exchanger 15 is calculated using the outdoor unit side refrigerant temperature T2 and the outdoor unit side refrigerant pressure P2 detected by the outdoor unit side refrigerant temperature pressure sensor 62c.

The control device 60 calculates an opening degree SW of the air mix door 34. Specifically, the opening degree SW is calculated by the following Formula F2.

SW={TAO+(Te+C2)}/{TWH+(Te+C2)}×100(%) (F2)

Te is an evaporator side refrigerant temperature detected by the evaporator side refrigerant temperature pressure sensor 62d. TWH is a high-temperature side heat medium temperature detected by the high-temperature side heat medium temperature sensor 63a. C2 is a control constant.

Furthermore, the control device 60 determines a control signal to be output to the driving actuator of the air mix door 34 according to the opening degree SW.

For example, at the opening degree SW=100%, the control signal is determined such that the air mix door 34 is displaced to what is called a max hot position where the air passage on the heater core 42 side is fully opened and the cold air bypass passage 35 is fully closed. At the opening degree SW=0%, the control signal is determined such that the air mix door 34 is displaced to what is called a max cool position where the air passage on the heater core 42 side is fully closed and the cold air bypass passage 35 is fully opened.

The control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full open state, the air conditioning expansion valve 14b is brought into a throttle state that exerts a refrigerant depressurization action, the cooling expansion valve 14c is brought into a full close state, and the bypass side flow rate adjustment valve 14d is brought into a full close state. The control device 60 determines the control voltages to be output to the high-pressure side on-off valve 22a and the low-pressure side on-off valve 22b so as to close the high-pressure side on-off valve 22a and close the low-pressure side on-off valve 22b.

Furthermore, the control device 60 appropriately determines the operation state of another piece of equipment to be controlled. For example, the control device 60 determines the control voltage to be output to the high-temperature side pump 41 so as to exhibit predetermined reference pumping capability, and stops the low-temperature side pump 51.

For example, the control device 60 determines the control voltage to be output to the indoor blower 32 with reference to a control map stored in advance in the control device 60 based on the target blowing temperature TAO. In the control map of the present embodiment, the control voltage is determined such that the ventilation air volume of the indoor blower 32 is maximized in an extremely low temperature range (maximum air conditioning range) and an extremely high temperature range (maximum heating range) of the target blowing temperature TAO, and the ventilation air volume decreases as it gets closer to an intermediate temperature range.

The control device 60 outputs a control signal or a control voltage to various pieces of equipment to be controlled so as to obtain the control states of the various pieces of equipment to be controlled determined as described above. Then, as indicated by Z in FIG. 3, the control flow returns to step S10.

Therefore, in the heat pump cycle 10 in the single air conditioning mode, the refrigerant circuit is switched to the refrigerant circuit in which the refrigerant discharged from the compressor 11 circulates in order of the water refrigerant heat exchanger 13, the heating expansion valve 14a that is fully opened, the outdoor heat exchanger 15, the air conditioning expansion valve 14b, the indoor evaporator 18, the accumulator 23, and the suction port of the compressor 11.

For this reason, in the heat pump cycle 10 in the single air conditioning mode, a vapor compression refrigeration cycle is configured in which the water refrigerant heat exchanger 13 and the outdoor heat exchanger 15 are caused to function as a condenser that dissipates heat of, and condenses, the refrigerant, and the indoor evaporator 18 is caused to function as an evaporator that evaporates the refrigerant.

In the water refrigerant heat exchanger 13, the refrigerant dissipates heat to the high-temperature side heat medium, whereby the high-temperature side heat medium is heated. In the indoor evaporator 18, the ventilation air is cooled by the refrigerant absorbing heat from the ventilation air.

In the high-temperature side heat medium circuit 40 in the single air conditioning mode, the high-temperature side heat medium pumped from the high-temperature side pump 41 circulates in order of the heat medium passage of the water refrigerant heat exchanger 13, the heater core 42, and the suction port of the high-temperature side pump 41. Accordingly, the high-temperature side heat medium heated by the water refrigerant heat exchanger 13 flows into the heater core 42.

In the indoor air conditioning unit 30 in the single air conditioning mode, the ventilation air blown from the indoor blower 32 is cooled at the indoor evaporator 18. The ventilation air cooled at the indoor evaporator 18 is heated at the heater core 42 according to the opening degree of the air mix door 34. The conditioned air whose temperature has been adjusted so as to approach the target blowing temperature TAO is blown to the vehicle interior. This achieves air conditioning of the vehicle interior.

### (2) Series Dehumidification Heating Mode

In the series dehumidification heating mode, the control device 60 executes a series dehumidification heating mode control flow. In the series dehumidification heating mode control flow, the control device 60 determines the target evaporator temperature TEO similarly to the single air conditioning mode. Therefore, the series dehumidification heating mode control flow includes the target evaporator temperature determination unit. Furthermore, similarly to the single air conditioning mode, the control device 60 determines the increase-decrease amount ΔIVO of the rotation speed of the compressor 11.

The control device 60 determines a target high-temperature side heat medium temperature TWHO so that the ventilation air can be sufficiently heated at the heater core 42. This is a target value of the high-temperature side heat medium temperature TWH detected by the high-temperature side heat medium temperature sensor 63a.

The target high-temperature side heat medium temperature TWHO is determined with reference to a control map stored in advance in the control device 60 based on the target blowing temperature TAO and the efficiency of the heater core 42. In the control map of the series dehumidification heating mode, the target high-temperature side heat medium temperature TWHO is determined to rise along with the target blowing temperature TAO.

The control device 60 determines a change amount ΔKPN1 of an opening degree pattern KPN1 with reference to a control map stored in advance in the control device 60 based on the target blowing temperature TAO and the target high-temperature side heat medium temperature TWHO.

The opening degree pattern KPN1 is a parameter for determining a combination of the throttle opening degree of the heating expansion valve 14a and the throttle opening degree of the air conditioning expansion valve 14b. The opening degree pattern KPN1 corresponds to the opening degree ratio of the throttle opening degree of the air conditioning expansion valve 14b to the throttle opening degree of the heating expansion valve 14a.

In the control map of the series dehumidification heating mode, as the target blowing temperature TAO rises, the opening degree pattern KPN1 is increased. That is, as the target blowing temperature TAO rises, the opening degree ratio of the throttle opening degree of the air conditioning expansion valve 14b to the throttle opening degree of the heating expansion valve 14a is increased.

Similarly to the single air conditioning mode, the control device 60 calculates the opening degree SW of the air mix door 34.

The control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a throttle state, the cooling expansion valve 14c is brought into a full close state, and the bypass side flow rate adjustment valve 14d is brought into a full close state. The control device 60 determines the control voltages to be output to the high-pressure side on-off valve 22a and the low-pressure side on-off valve 22b so as to close the high-pressure side on-off valve 22a and close the low-pressure side on-off valve 22b.

Furthermore, similarly to the single air conditioning mode, the control device 60 appropriately determines the operation state of another piece of equipment to be controlled.

The control device 60 outputs a control signal or a control voltage to various pieces of equipment to be controlled so as to obtain the control states of the various pieces of equipment to be controlled determined as described above. Then, as indicated by Z in FIG. 3, the control flow returns to step S10.

Therefore, in the heat pump cycle 10 in the series dehumidification heating mode, the refrigerant circuit is switched to the refrigerant circuit in which the refrigerant discharged from the compressor 11 circulates in order of the water refrigerant heat exchanger 13, the heating expansion valve 14a, the outdoor heat exchanger 15, the air conditioning expansion valve 14b, the indoor evaporator 18, the accumulator 23, and the suction port of the compressor 11.

For this reason, in the heat pump cycle 10 in the series dehumidification heating mode, a vapor compression refrigeration cycle is configured in which the water refrigerant heat exchanger 13 is caused to function as a condenser and the indoor evaporator 18 is caused to function as an evaporator.

Furthermore, in the heat pump cycle 10 in the series dehumidification heating mode, when the saturation temperature of the refrigerant at the outdoor heat exchanger 15 is higher than the outside air temperature Tam, the outdoor heat exchanger 15 is caused to function as a condenser. When the saturation temperature of the refrigerant at the outdoor heat exchanger 15 is lower than the outside air temperature Tam, the outdoor heat exchanger 15 is caused to function as an evaporator.

In the water refrigerant heat exchanger 13, the refrigerant dissipates heat to the high-temperature side heat medium, whereby the high-temperature side heat medium is heated. In the indoor evaporator 18, the ventilation air is cooled by the refrigerant absorbing heat from the ventilation air.

In the high-temperature side heat medium circuit 40 in the series dehumidification heating mode, the high-temperature side heat medium heated by the water refrigerant heat exchanger 13 flows into the heater core 42, similarly to the single air conditioning mode.

In the indoor air conditioning unit 30 in the series dehumidification heating mode, the ventilation air blown from the indoor blower 32 is cooled and dehumidified at the indoor evaporator 18. The ventilation air cooled and dehumidified at the indoor evaporator 18 is reheated at the heater core 42 according to the opening degree of the air mix door 34. The conditioned air whose temperature has been adjusted so as to approach the target blowing temperature TAO is blown to the vehicle interior. This achieves dehumidification heating of the vehicle interior.

### (3-1) HG Dehumidification Heating Mode

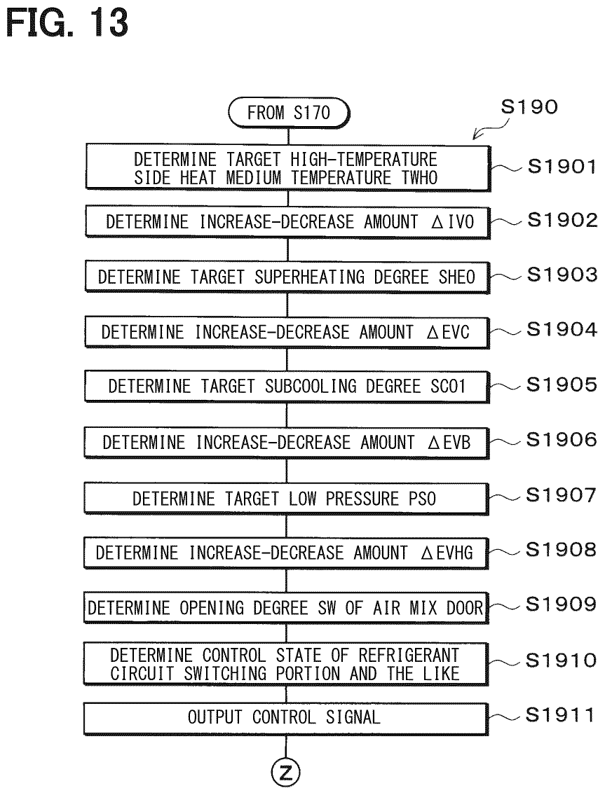

In the HG dehumidification heating mode, the control device 60 executes an HG dehumidification heating mode control flow shown in FIG. 13.

First, in step S1901, the target high-temperature side heat medium temperature TWHO of the high-temperature side heat medium is determined. The target high-temperature side heat medium temperature TWHO is determined with reference to a control map based on the vehicle interior setting temperature Tset set by the temperature setting switch. In the control map of the HG dehumidification heating mode, the target high-temperature side heat medium temperature TWHO is determined to rise along with the decrease in the outside air temperature Tam at the vehicle interior setting temperature Tset in a predetermined range.

In step S1902, the increase-decrease amount ΔIVO of the rotation speed of the compressor 11 is determined. The increase-decrease amount ΔIVO in the HG dehumidification heating mode is determined such that the high-temperature side heat medium temperature TWH approaches the target high-temperature side heat medium temperature TWHO by a feedback control method based on a deviation between the target high-temperature side heat medium temperature TWHO and the high-temperature side heat medium temperature TWH.

In step S1903, a target superheating degree SHEO of the outlet side refrigerant of the indoor evaporator 18 is determined. As the target superheating degree SHEO, a predetermined constant (in the present embodiment, 5° C.) can be employed.

In step S1904, the increase-decrease amount ΔEVC of the throttle opening degree of the air conditioning expansion valve 14b is determined. The increase-decrease amount ΔEVC in the HG dehumidification heating mode is determined such that the superheating degree SHE of the outlet side refrigerant at the indoor evaporator 18 approaches the target superheating degree SHEO by a feedback control method based on a deviation between the target superheating degree SHEO and the superheating degree SHE of the outlet side refrigerant at the indoor evaporator 18.

The superheating degree SHE of the outlet side refrigerant at the indoor evaporator 18 is calculated using the evaporator side refrigerant temperature Te and the evaporator side refrigerant pressure Pe detected by the evaporator side refrigerant temperature pressure sensor 62d.

In step S1905, a target subcooling degree SCO1 of the refrigerant flowing out of the water refrigerant heat exchanger 13 is determined. The target subcooling degree SCO1 is determined with reference to a control map stored in advance in the control device 60 based on the outside air temperature Tam. The target subcooling degree SCO1 may be a constant value.

In step S1906, an increase-decrease amount ΔEVB of the throttle opening degree of the cooling expansion valve 14c is determined. The increase-decrease amount ΔEVB in the HG dehumidification heating mode is determined such that the subcooling degree SC1 of the refrigerant flowing out of the water refrigerant heat exchanger 13 approaches the target subcooling degree SCO1 by a feedback control method based on a deviation between the target subcooling degree SCO1 and the subcooling degree SC1 of the refrigerant flowing out of the water refrigerant heat exchanger 13.

The subcooling degree SC1 of the refrigerant flowing out of the water refrigerant heat exchanger 13 is calculated using the high-pressure side refrigerant temperature T1 and the high-pressure side refrigerant pressure P1 detected by the high-pressure side refrigerant temperature pressure sensor 62b.

In step S1907, the target low pressure PSO, which is a target value of the sucked refrigerant to be sucked into the compressor 11, is determined. In the HG dehumidification heating mode, the target low pressure PSO is determined such that the refrigerant evaporation temperature at the indoor evaporator 18 becomes a temperature at which dehumidification of the ventilation air can be performed without causing frost formation at the indoor evaporator 18. For this reason, the saturation temperature of the refrigerant at the target low pressure PSO corresponds to the target evaporator temperature TEO. Therefore, in the HG dehumidification heating mode, step S1907 serves as the target evaporator temperature determination unit.

In step S1908, an increase-decrease amount ΔEVHG of the opening degree of the bypass side flow rate adjustment valve 14d is determined. The increase-decrease amount ΔEVHG in the HG dehumidification heating mode is determined such that the chiller side refrigerant pressure Pc approaches the target low pressure PSO by a feedback control method based on a deviation between the target low pressure PSO and the chiller side refrigerant pressure Pc detected by the chiller side refrigerant temperature pressure sensor 62e.

In step S1909, the opening degree SW of the air mix door 34 is calculated, similarly to the single air conditioning mode.

In step S1910, the control signals to be output to the heating expansion valve 14a, the air conditioning expansion valve 14b, the cooling expansion valve 14c, and the bypass side flow rate adjustment valve 14d are determined such that the heating expansion valve 14a is brought into a full close state, the air conditioning expansion valve 14b is brought into a throttle state, the cooling expansion valve 14c is brought into a throttle state, and the bypass side flow rate adjustment valve 14d is brought into a throttle state. The control voltages to be output to the high-pressure side on-off valve 22a and the low-pressure side on-off valve 22b are determined so as to open the high-pressure side on-off valve 22a and close the low-pressure side on-off valve 22b.

Furthermore, similarly to the single air conditioning mode, the control device 60 appropriately determines the operation state of another piece of equipment to be controlled.

In step S1911, a control signal or a control voltage is output to each piece of equipment to be controlled so as to obtain the control states of the various pieces of equipment to be controlled determined as described above. Then, as indicated by Z in FIGS. 3 and 13, the control flow returns to step S10.

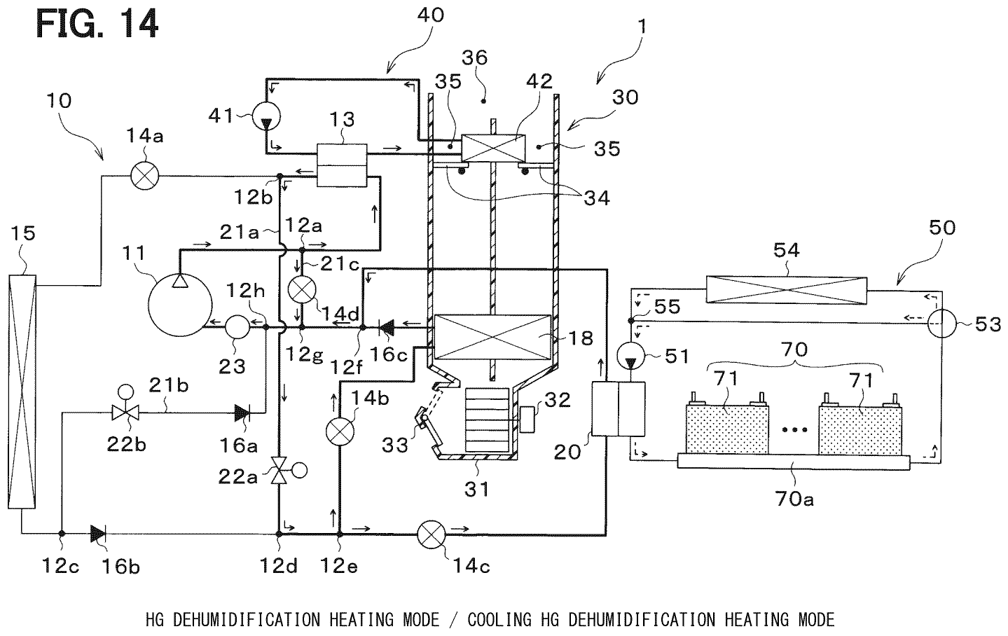

Therefore, in the heat pump cycle 10 in the HG dehumidification heating mode, as indicated by the solid arrows in FIG. 14, the refrigerant discharged from the compressor 11 circulates in order of the first three-way joint 12a, the water refrigerant heat exchanger 13, the high-pressure side passage 21a, the fifth three-way joint 12e, the air conditioning expansion valve 14b, the indoor evaporator 18, the sixth three-way joint 12f, the seventh three-way joint 12g, the accumulator 23, and the suction port of the compressor 11. Furthermore, the refrigerant discharged from the compressor 11 circulates in order of the first three-way joint 12a, the water refrigerant heat exchanger 13, the high-pressure side passage 21a, the fifth three-way joint 12e, the cooling expansion valve 14c, the chiller 20, the sixth three-way joint 12f, the seventh three-way joint 12g, the accumulator 23, and the suction port of the compressor 11. At the same time, the refrigerant circuit is switched to the refrigerant circuit in which the refrigerant discharged from the compressor 11 circulates in order of the first three-way joint 12a, the bypass side flow rate adjustment valve 14d disposed in the bypass passage 21c, the seventh three-way joint 12g, the accumulator 23, and the suction port of the compressor 11.

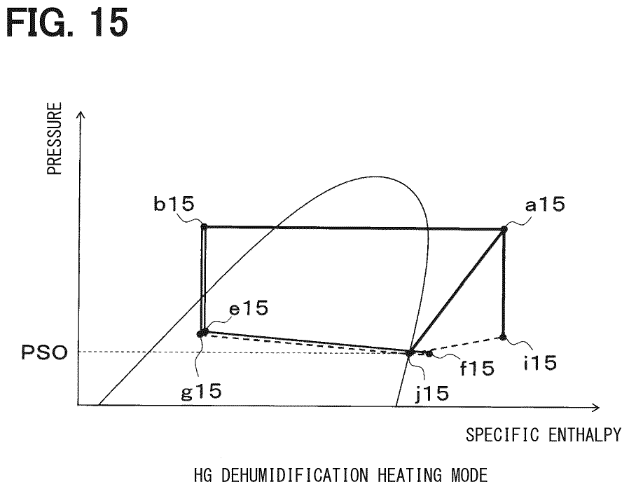

For this reason, in the heat pump cycle 10 in the HG dehumidification heating mode, the state of the refrigerant changes as shown in the Mollier chart of FIG. 15.

The flow of the discharge refrigerant (point a15 in FIG. 15) discharged from the compressor 11 is branched at the first three-way joint 12a. One refrigerant branched at the first three-way joint 12a flows into the water refrigerant heat exchanger 13, and dissipates heat to the high-temperature side heating medium (from point a15 to point b15 in FIG. 15). Accordingly, the high-temperature side heat medium is heated. The refrigerant flowing out of the water refrigerant heat exchanger 13 flows into the high-pressure side passage 21a. The flow of the refrigerant flowing out of the high-pressure side passage 21a is branched at the fifth three-way joint 12e. One refrigerant branched at the fifth three-way joint 12e flows into the air conditioning expansion valve 14b and is depressurized (from point b15 to point e15 in FIG. 15).

The refrigerant depressurized at the air conditioning expansion valve 14b flows into the indoor evaporator 18. The refrigerant flowing into the indoor evaporator 18 absorbs heat from the ventilation air blown from the indoor blower 32 and evaporates (from point e15 to point f15 in FIG. 15). Accordingly, the ventilation air is cooled and dehumidified. The refrigerant flowing out of the indoor evaporator 18 flows into one inflow port of the sixth three-way joint 12f via the third check valve 16c.

The other refrigerant branched at the fifth three-way joint 12e flows into the cooling expansion valve 14c and is depressurized (from point b15 to point g15 in FIG. 15). The refrigerant depressurized at the cooling expansion valve 14c flows into the chiller 20. In the HG dehumidification heating mode, since the low-temperature side pump 51 is stopped, the refrigerant and the low-temperature side heating medium do not exchange heat at the chiller 20. The refrigerant flowing out of the chiller 20 flows into the other inflow port of the sixth three-way joint 12f.

At the sixth three-way joint 12f, the refrigerant flowing out of the indoor evaporator 18 and the refrigerant flowing out of the chiller 20 are merged and mixed. The refrigerant flowing out of the sixth three-way joint 12f flows into the other inflow port of the seventh three-way joint 12g.

The other refrigerant branched at the first three-way joint 12a flows into the bypass passage 21c. The flow rate of the refrigerant flowing into the bypass passage 21c is adjusted and the refrigerant is depressurized by the bypass side flow rate adjustment valve 14d (from point a15 to point i15 in FIG. 15). The refrigerant depressurized at the bypass side flow rate adjustment valve 14d flows into one inflow port of the seventh three-way joint 12g.

At the seventh three-way joint 12g, the refrigerant flowing out of the sixth three-way joint 12f and the refrigerant flowing out of the bypass passage 21c are merged and mixed. The refrigerant flowing out of the seventh three-way joint 12g flows into the accumulator 23 via the eighth three-way joint 12h. The refrigerant flowing into the accumulator 23 is mixed more homogeneously (point j15 in FIG. 15). The refrigerant flowing out of the accumulator 23 is sucked into the compressor 11 and compressed again.

In the high-temperature side heat medium circuit 40 in the HG dehumidification heating mode, as indicated by the solid arrows in FIG. 14, the high-temperature side heat medium heated by the water refrigerant heat exchanger 13 flows into the heater core 42, similarly to the single air conditioning mode.

In the indoor air conditioning unit 30 in the HG dehumidification heating mode, similarly to the series dehumidification heating mode, the conditioned air whose temperature has been adjusted so as to approach the target blowing temperature TAO is blown to the vehicle interior. This achieves dehumidification heating of the vehicle interior.

In the HG dehumidification heating mode, the refrigerant having relatively high enthalpy is merged with the refrigerant flowing out of the chiller 20 via the bypass passage 21c.

Accordingly, when the refrigerant discharge capability of the compressor 11 is increased, the heating capability of the high-temperature side heat medium at the water refrigerant heat exchanger 13 can be improved without lowering the refrigerant evaporation pressure at the indoor evaporation portion 18. That is, when the refrigerant discharge capability of the compressor 11 is increased, the heating capability of the high-temperature side heat medium at the water refrigerant heat exchanger 13 can be improved without causing frost formation of the indoor evaporation portion 18.

Therefore, in the HG dehumidification heating mode, the heating capability of the ventilation air at the heating portion can be improved more than the series dehumidification heating mode.

### (3-2) Outside Air Endothermic HG Dehumidification Heating Mode

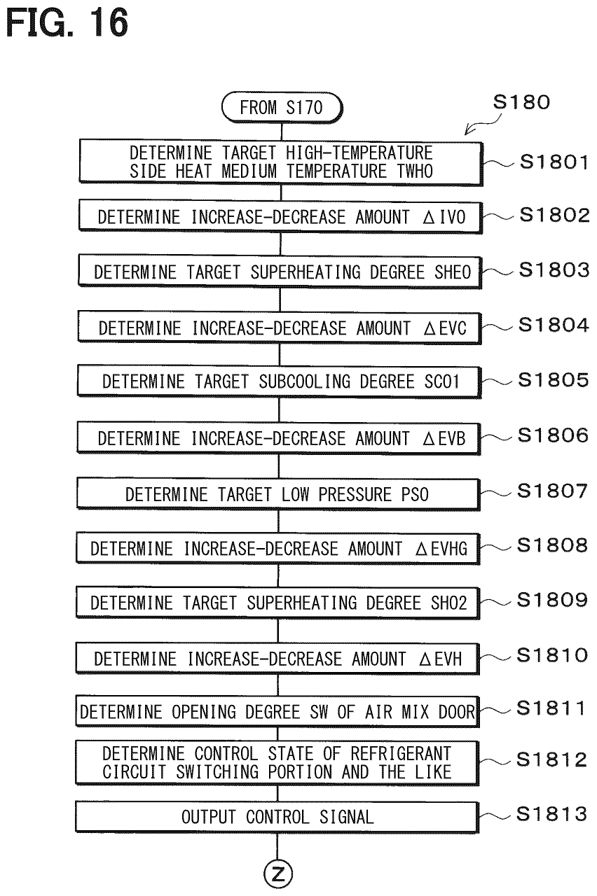

In the outside air endothermic HG dehumidification heating mode, the control device 60 executes an outside air endothermic HG dehumidification heating mode control flow shown in FIG. 16.

In steps S1801 to S1808 of FIG. 16, the control states of the various pieces of equipment to be controlled are determined similarly to steps S1901 to S1908 of FIG. 13 in the HG dehumidification heating mode. Therefore, in the outside air endothermic HG dehumidification heating mode, step S1807 serves as the target evaporator temperature determination unit.

In step S1809, a target superheating degree SHO2 of the outlet side refrigerant of the outdoor heat exchanger 15 is determined. As the target superheating degree SHO2, a predetermined constant (in the present embodiment, 5° C.) can be employed, similarly to the target superheating degree SHEO of the outlet side refrigerant of the indoor evaporator 18.

In step S1810, an increase-decrease amount ΔEVH of the throttle opening degree of the heating expansion valve 14a is determined. The increase-decrease amount ΔEVH in the outside air endothermic HG dehumidification heating mode is determined such that the superheating degree SH2 of the outlet side refrigerant of the outdoor heat exchanger 15 approaches the target superheating degree SHO2 by a feedback control method based on a deviation between the target superheating degree SHO2 and the superheating degree SH2 of the outlet side refrigerant of the outdoor heat exchanger 15.

The superheating degree SH2 of the outlet side refrigerant at the outdoor heat exchanger 15 is calculated using the outdoor unit side refrigerant temperature T2 and the outdoor unit side refrigerant pressure P2 detected by the outdoor unit side refrigerant temperature pressure sensor 62c.

In step S1811, the opening degree SW of the air mix door 34 is calculated, similarly to the single air conditioning mode.

In step S1812, the control signals to be output to the heating expansion valve 14a, the air conditioning expansion valve 14b, the cooling expansion valve 14c, and the bypass side flow rate adjustment valve 14d are determined such that the heating expansion valve 14a is brought into a throttle state, the air conditioning expansion valve 14b is brought into a throttle state, the cooling expansion valve 14c is brought into a throttle state, and the bypass side flow rate adjustment valve 14d is brought into a throttle state. The control voltages to be output to the high-pressure side on-off valve 22a and the low-pressure side on-off valve 22b are determined so as to open the high-pressure side on-off valve 22a and open the low-pressure side on-off valve 22b.

Furthermore, similarly to the single air conditioning mode, the control device 60 appropriately determines the operation state of another piece of equipment to be controlled.

In step S1813, a control signal or a control voltage is output to each piece of equipment to be controlled so as to obtain the control states of the various pieces of equipment to be controlled determined as described above. Then, as indicated by Z in FIGS. 3 and 16, the control flow returns to step S10.

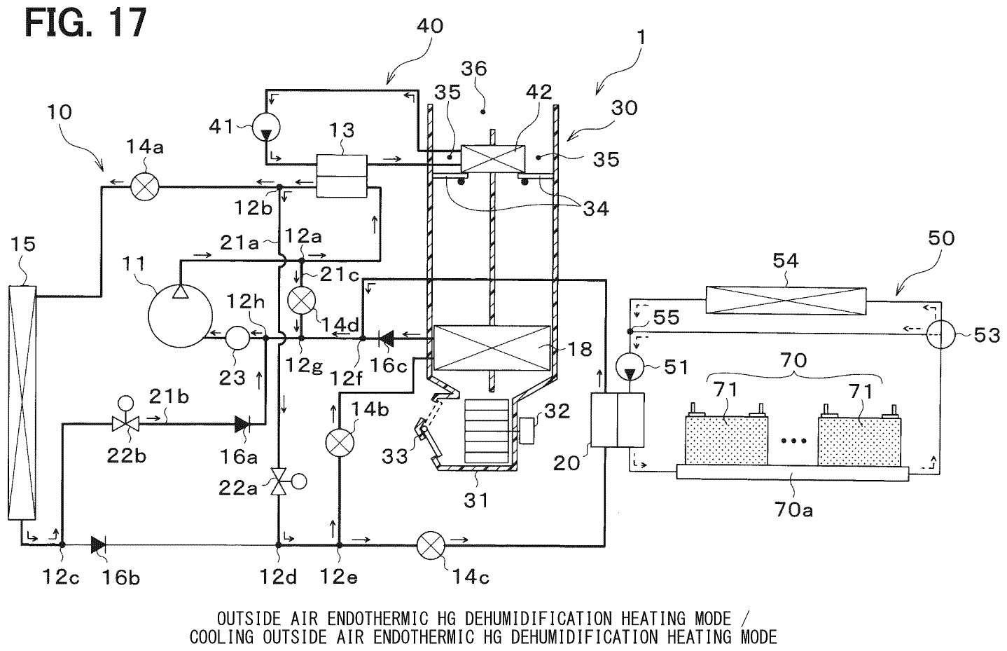

Therefore, in the heat pump cycle 10 in the outside air endothermic HG dehumidification heating mode, as indicated by the solid arrows in FIG. 17, the refrigerant discharged from the compressor 11 flows similarly to the HG dehumidification heating mode. Furthermore, the refrigerant circuit is switched to the refrigerant circuit in which the refrigerant discharged from the compressor 11 circulates in order of the first three-way joint 12a, the water refrigerant heat exchanger 13, the second three-way joint 12b, the heating expansion valve 14a, the outdoor heat exchanger 15, the low-pressure side passage 21b, the eighth three-way joint 12h, the accumulator 23, and the suction port of the compressor 11.

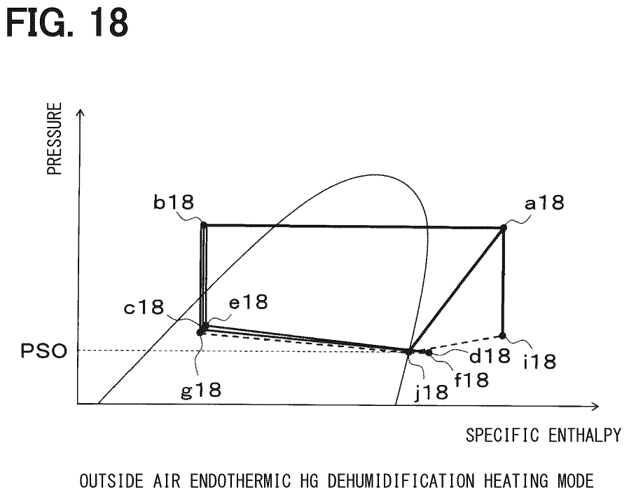

That is, the refrigerant circuit is switched to a refrigerant circuit in which the indoor evaporator 18 and the outdoor heat exchanger 15 are connected in parallel to the flow of the refrigerant flowing out of the water refrigerant heat exchanger 13. For this reason, in the heat pump cycle 10 in the HG dehumidification heating mode, the state of the refrigerant changes as shown in the Mollier chart of FIG. 18.

In FIG. 18, the state of the refrigerant at a site equal in terms of the cycle configuration to the Mollier chart of FIG. 15 described in the HG dehumidification heating mode is indicated by the same reference sign (alphabet) as in FIG. 15, and only the subscript (numeral) is changed according to the figure number. The same applies to the following Mollier chart.

In the outside air endothermic HG dehumidification heating mode, the flow of the refrigerant flowing out of the water refrigerant heat exchanger 13 is branched at the second three-way joint 12b with respect to the HG dehumidification heating mode. One refrigerant flowing out of one outflow port of the second three-way joint 12b flows into the heating expansion valve 14a and is depressurized (from point b18 to point c18 in FIG. 18).

The refrigerant depressurized at the heating expansion valve 14a flows into the outdoor heat exchanger 15. The refrigerant flowing into the outdoor heat exchanger 15 absorbs heat from the outside air and evaporates (from point c18 to point d18 in FIG. 18). The refrigerant flowing out of the outdoor heat exchanger 15 flows into one inflow port of the eighth three-way joint 12h via the low-pressure side passage 21b.

In the present embodiment, the target superheating degree SHEO of the outlet side refrigerant of the indoor evaporator 18 and the target superheating degree SHO2 of the outlet side refrigerant of the outdoor heat exchanger 15 are set to the equal value. For this reason, the state (point d18 in FIG. 18) of the refrigerant flowing out of the outdoor heat exchanger 15 and the state (point f18 in FIG. 18) of the refrigerant flowing out of the indoor evaporator 18 are substantially equal.

At the eighth three-way joint 12h, the refrigerant flowing out of the outdoor heat exchanger 15 and the refrigerant flowing out of the seventh three-way joint 12g are merged and mixed. The refrigerant flowing out of the eighth three-way joint 12h flows into the accumulator 23. The refrigerant flowing into the accumulator 23 is mixed more homogeneously (point j18 in FIG. 18). The refrigerant flowing out of the accumulator 23 is sucked into the compressor 11 and compressed again. Other operations are similar to those in the HG dehumidification heating mode.

In the high-temperature side heat medium circuit 40 in the outside air endothermic HG dehumidification heating mode, as indicated by the solid arrows in FIG. 17, the high-temperature side heat medium heated by the water refrigerant heat exchanger 13 flows into the heater core 42, similarly to the single air conditioning mode.

In the indoor air conditioning unit 30 in the outside air endothermic HG dehumidification heating mode, similarly to the series dehumidification heating mode, the conditioned air whose temperature has been adjusted so as to approach the target blowing temperature TAO is blown to the vehicle interior. This achieves dehumidification heating of the vehicle interior.

In the outside air endothermic HG dehumidification heating mode, similarly to the HG dehumidification heating mode, the heating capability of the ventilation air at the heating portion can be improved more than the series dehumidification heating mode. Furthermore, in the outside air endothermic HG dehumidification heating mode, the ventilation air can be heated using the heat absorbed from the outside air by the refrigerant at the outdoor heat exchanger 15. Therefore, in the outside air endothermic HG dehumidification heating mode, the operation efficiency of the heat pump cycle 10 can be improved more than that in the HG dehumidification heating mode.

### (4-1) Outside Air Endothermic Heating Mode

In the outside air endothermic heating mode, the control device 60 executes an outside air endothermic heating mode control flow. In the outside air endothermic heating mode control flow, the control device 60 determines the target high-temperature side heat medium temperature TWHO of the high-temperature side heat medium, similarly to the HG dehumidification heating mode. Furthermore, similarly to the HG dehumidification heating mode, the control device 60 determines the increase-decrease amount ΔIVO of the rotation speed of the compressor 11.

The control device 60 determines the target subcooling degree SCO1 of the refrigerant flowing out of the water refrigerant heat exchanger 13. The target subcooling degree SCO1 in the outside air endothermic heating mode is determined with reference to a control map stored in advance in the control device 60 based on at least one of the intake air temperature Tin and the outside air temperature Tam. In the control map of the outside air endothermic heating mode, the target subcooling degree SCO1 is determined such that the coefficient of performance (COP) of the cycle approaches the maximum value.

Furthermore, the control device 60 determines the increase-decrease amount ΔEVH of the throttle opening degree of the heating expansion valve 14a. The increase-decrease amount ΔEVH in the outside air endothermic heating mode is determined such that the subcooling degree SC1 of the refrigerant flowing out of the water refrigerant heat exchanger 13 approaches the target subcooling degree SCO1 by a feedback control method based on a deviation between the target subcooling degree SCO1 and the subcooling degree SC1 of the refrigerant flowing out of the water refrigerant heat exchanger 13.

Similarly to the single air conditioning mode, the control device 60 calculates the opening degree SW of the air mix door 34.

The control device 60 determines the control signals to be output to the heating expansion valve 14a in the throttle state, the air conditioning expansion valve 14b in the full close state, the cooling expansion valve 14c in the full close state, and the bypass side flow rate adjustment valve 14d such that the heating expansion valve 14a is brought into a throttle state, the air conditioning expansion valve 14b is brought into a full open state, the cooling expansion valve 14c is brought into a full open state, and the bypass side flow rate adjustment valve 14d is brought into a full open state. The control device 60 also determines the control voltages to be output to the high-pressure side on-off valve 22a and the low-pressure side on-off valve 22b so as to close the high-pressure side on-off valve 22a and open the low-pressure side on-off valve 22b.

Furthermore, similarly to the single air conditioning mode, the control device 60 appropriately determines the operation state of another piece of equipment to be controlled.

The control device 60 outputs a control signal or a control voltage to various pieces of equipment to be controlled so as to obtain the control states of the various pieces of equipment to be controlled determined as described above. Then, as indicated by Z in FIG. 3, the control flow returns to step S10.

Therefore, in the heat pump cycle 10 in the outside air endothermic heating mode, the refrigerant circuit is switched to the refrigerant circuit in which the refrigerant discharged from the compressor 11 circulates in order of the water refrigerant heat exchanger 13, the heating expansion valve 14a, the outdoor heat exchanger 15, the low-pressure side passage 21b, the accumulator 23, and the suction port of the compressor 11.

For this reason, in the heat pump cycle 10 in the outside air endothermic heating mode, a vapor compression refrigeration cycle is configured in which the water refrigerant heat exchanger 13 is caused to function as a condenser and the outdoor heat exchanger 15 is caused to function as an evaporator. In the water refrigerant heat exchanger 13, the refrigerant dissipates heat to the high-temperature side heat medium, whereby the high-temperature side heat medium is heated. In the outdoor heat exchanger 15, the refrigerant absorbs heat from the outside air and evaporates.

In the high-temperature side heat medium circuit 40 in the outside air endothermic heating mode, the high-temperature side heat medium heated by the water refrigerant heat exchanger 13 flows into the heater core 42, similarly to the single air conditioning mode.

In the indoor air conditioning unit 30 in the outside air endothermic heating mode, the ventilation air blown from the indoor blower 32 passes through the indoor evaporator 18. The ventilation air passing through the indoor evaporator 18 is heated at the heater core 42 according to the opening degree of the air mix door 34. The conditioned air whose temperature has been adjusted so as to approach the target blowing temperature TAO is blown to the vehicle interior. This achieves heating of the vehicle interior.

### (4-2) HG Heating Mode

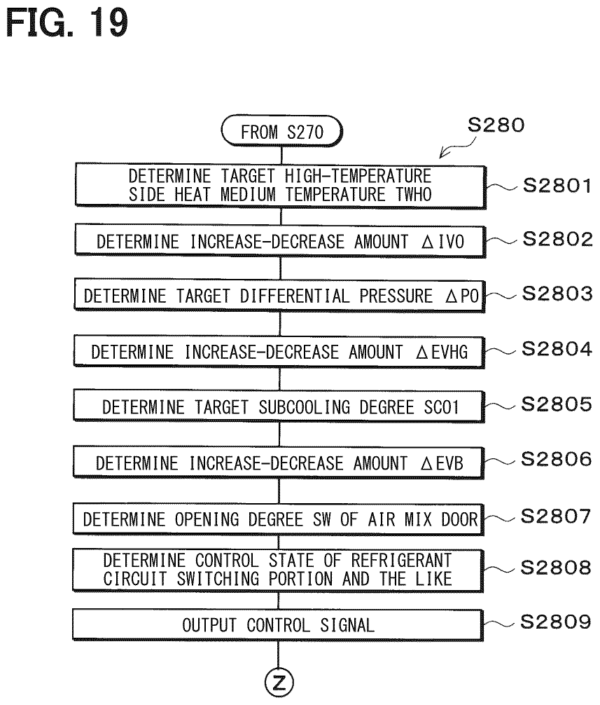

In the HG heating mode, the control device 60 executes an HG heating mode control flow shown in FIG. 19.

First, in step S2801, similarly to the HG dehumidification heating mode, the target high-temperature side heat medium temperature TWHO of the high-temperature side heat medium is determined. In step S2802, the increase-decrease amount ΔIVO of the rotation speed of the compressor 11 is determined, similarly to the HG dehumidification heating mode.

In step S2803, a target differential pressure ΔPO is determined. The target differential pressure ΔPO is a target value of an actual differential pressure ΔP of the heat pump cycle 10. The actual differential pressure ΔP can be calculated by subtracting the chiller side refrigerant pressure Pc from the discharge refrigerant pressure Pd detected by the discharge refrigerant temperature pressure sensor 62a. The target differential pressure ΔPO is a value in which the target low pressure PSO is subtracted from a target high pressure PDO, which is a target value of the discharge refrigerant pressure Pd.

The target high pressure PDO can be determined based on the target high-temperature side heat medium temperature TWHO. The target low pressure PSO is determined such that the compression work amount of the compressor 11 can secure heat that can sufficiently heat the high-temperature side heat medium to a desired temperature.

In step S2804, the increase-decrease amount ΔEVHG of the opening degree of the bypass side flow rate adjustment valve 14d is determined. The increase-decrease amount ΔEVHG in the HG heating mode is determined such that the actual differential pressure ΔP approaches the target differential pressure ΔPO by a feedback control method based on a deviation between the target differential pressure ΔPO and the actual differential pressure ΔP.

In step S2805, similarly to the HG dehumidification heating mode, the target subcooling degree SCO1 is determined. In step S2806, similarly to the HG dehumidification heating mode, the increase-decrease amount ΔEVB of the throttle opening degree of the cooling expansion valve 14c is determined.

In step S2807, the opening degree SW of the air mix door 34 is calculated, similarly to the single air conditioning mode.

In step S2808, the control signals to be output to the heating expansion valve 14a, the air conditioning expansion valve 14b, the cooling expansion valve 14c, and the bypass side flow rate adjustment valve 14d are determined such that the heating expansion valve 14a is brought into a full close state, the air conditioning expansion valve 14b is brought into a full close state, the cooling expansion valve 14c is brought into a throttle state, and the bypass side flow rate adjustment valve 14d is brought into a throttle state. The control voltages to be output to the high-pressure side on-off valve 22a and the low-pressure side on-off valve 22b are determined so as to open the high-pressure side on-off valve 22a and close the low-pressure side on-off valve 22b.

Furthermore, similarly to the single air conditioning mode, the control device 60 appropriately determines the operation state of another piece of equipment to be controlled.

In step S2809, a control signal or a control voltage is output to each piece of equipment to be controlled so as to obtain the control states of the various pieces of equipment to be controlled determined as described above. Then, as indicated by Z in FIGS. 3 and 19, the control flow returns to step S10.

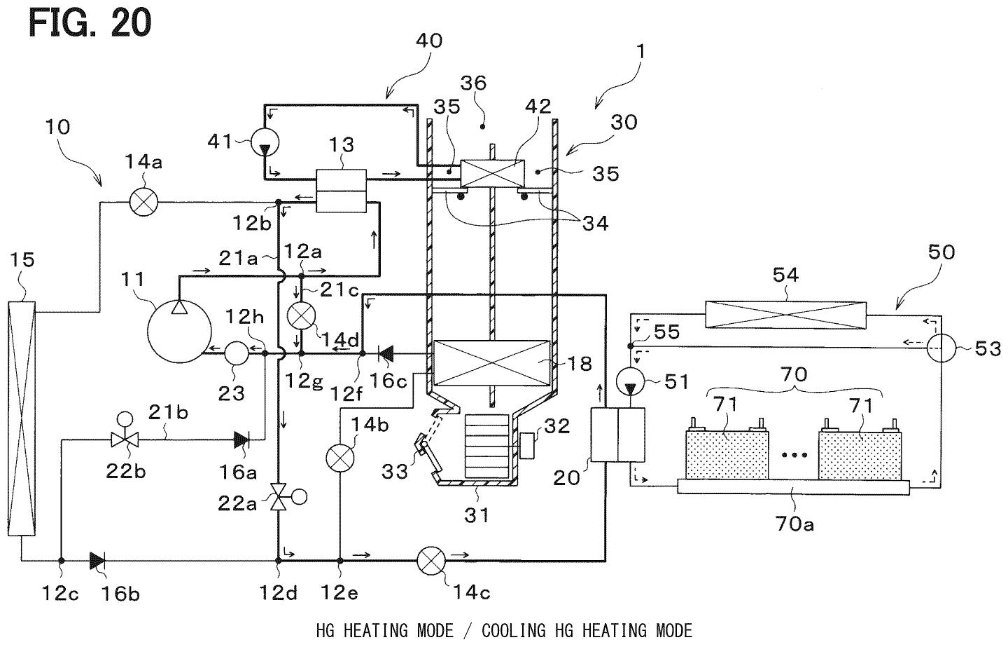

Therefore, in the heat pump cycle 10 in the HG heating mode, as indicated by the solid arrows in FIG. 20, the refrigerant discharged from the compressor 11 circulates in order of the first three-way joint 12a, the water refrigerant heat exchanger 13, the high-pressure side passage 21a, the cooling expansion valve 14c, the chiller 20, the seventh three-way joint 12g, the accumulator 23, and the suction port of the compressor 11. At the same time, the refrigerant circuit is switched to the refrigerant circuit in which the refrigerant discharged from the compressor 11 circulates in order of the first three-way joint 12a, the bypass side flow rate adjustment valve 14d disposed in the bypass passage 21c, the seventh three-way joint 12g, the accumulator 23, and the suction port of the compressor 11.

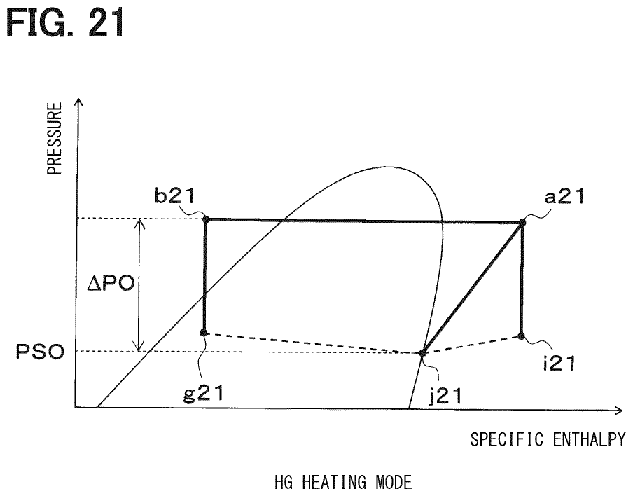

For this reason, in the heat pump cycle 10 in the HG heating mode, the state of the refrigerant changes as shown in the Mollier chart of FIG. 21.

The flow of the discharge refrigerant (point a21 in FIG. 21) discharged from the compressor 11 is branched at the first three-way joint 12a. One refrigerant branched at the first three-way joint 12a flows into the water refrigerant heat exchanger 13, and dissipates heat to the high-temperature side heating medium (from point a21 to point b21 in FIG. 21). Accordingly, the high-temperature side heat medium is heated.

The refrigerant flowing out of the water refrigerant heat exchanger 13 flows into the high-pressure side passage 21a. The flow of the refrigerant having flowed into the high-pressure side passage 21a flows into the cooling expansion valve 14c via the fifth three-way joint 12e and is depressurized (from the point b21 to the point g21 in FIG. 21).

The refrigerant depressurized at the cooling expansion valve 14c flows into the chiller 20. In the HG heating mode, since the low-temperature side pump 51 is stopped, the refrigerant and the low-temperature side heating medium do not exchange heat at the chiller 20 The refrigerant flowing out of the chiller 20 flows into one inflow port of the seventh three-way joint 12g via the sixth three-way joint 12f.

The other refrigerant branched at the first three-way joint 12a flows into the bypass passage 21c. The flow rate of the refrigerant flowing into the bypass passage 21c is adjusted and the refrigerant is depressurized by the bypass side flow rate adjustment valve 14d (from point a21 to point i21 in FIG. 21). The refrigerant depressurized at the bypass side flow rate adjustment valve 14d flows into one inflow port of the seventh three-way joint 12g.

At the seventh three-way joint 12g, the refrigerant flowing out of the sixth three-way joint 12f and the refrigerant flowing out of the bypass passage 21c are merged and mixed. The refrigerant flowing out of the seventh three-way joint 12g flows into the accumulator 23 via the eighth three-way joint 12h. The refrigerant flowing into the accumulator 23 is mixed more homogeneously (point j21 in FIG. 21). The refrigerant flowing out of the accumulator 23 is sucked into the compressor 11 and compressed again.

In the high-temperature side heat medium circuit 40 in the HG heating mode, as indicated by the solid arrows in FIG. 20, the high-temperature side heat medium heated by the water refrigerant heat exchanger 13 flows into the heater core 42, similarly to the single air conditioning mode.

In the indoor air conditioning unit 30 in the HG heating mode, similarly to the outside air endothermic heating mode, the conditioned air whose temperature has been adjusted so as to approach the target blowing temperature TAO is blown to the vehicle interior. This achieves heating of the vehicle interior.

In the HG heating mode, the refrigerant having relatively high enthalpy is merged with the refrigerant flowing out of the cooling side expansion valve 14c via the bypass passage 21c. Accordingly, by increasing the refrigerant discharge capability of the compressor 11, the cycle can be balanced even if the heat dissipation amount to the high-temperature side heat medium of the refrigerant at the water refrigerant heat exchanger 13 is increased.

Therefore, in the HG heating mode, the heating capability of the ventilation air at the heating portion can be improved more than the outside air endothermic heating mode.

### (5) Cooling Air Conditioning Mode

In the cooling air conditioning mode, the control device 60 executes a cooling air conditioning mode control flow. In the cooling air conditioning mode control flow, the control device 60 determines the target evaporator temperature TEO, similarly to the single air conditioning mode. Furthermore, similarly to the single air conditioning mode, the control device 60 determines the increase-decrease amount ΔIVO of the rotation speed of the compressor 11.

Similarly to the single air conditioning mode, the control device 60 determines a target subcooling degree SCO2 of the refrigerant flowing out of the outdoor heat exchanger 15. Furthermore, similarly to the single air conditioning mode, the control device 60 determines the increase-decrease amount ΔEVC of the throttle opening degree of the air conditioning expansion valve 14b.

The control device 60 determines a target superheating degree SHCO of the outlet side refrigerant of the refrigerant passage of the chiller 20. As the target superheating degree SHCO, a predetermined constant (in the present embodiment, 5° C.) can be employed.

Furthermore, the control device 60 determines the increase-decrease amount ΔEVB of the throttle opening degree of the cooling expansion valve 14c. The increase-decrease amount ΔEVB in the cooling air conditioning mode is determined such that the superheating degree SHC of the refrigerant flowing out of the refrigerant passage of the chiller 20 approaches the target superheating degree SHCO by a feedback control method based on a deviation between the target superheating degree SHCO and the superheating degree SHC of the refrigerant flowing out of the refrigerant passage of the chiller 20.

The superheating degree SHC of the refrigerant flowing out of the refrigerant passage of the chiller 20 is calculated using the chiller side refrigerant temperature Tc and the chiller side refrigerant pressure Pc detected by the chiller side refrigerant temperature pressure sensor 62e.

The control device 60 determines a target low-temperature side heat medium temperature TWLO of the low-temperature side heat medium flowing out of the heat medium passage of the chiller 20. The target low-temperature side heat medium temperature TWLO is determined with reference to a control map stored in advance in the control device 60 based on the heat generation amount of the battery 70 and the outside air temperature Tam.

In the control map of the cooling air conditioning mode, the target low-temperature side heat medium temperature TWLO is determined to decrease along with rise in the heat generation amount of the battery 70 and rise in the outside air temperature Tam so that the battery 70 can be appropriately cooled. Furthermore, when the first low-temperature side heat medium temperature TWL1 is lower than the target low-temperature side heat medium temperature TWLO, the control device 60 brings the cooling expansion valve 14c into a full close state.

Similarly to the single air conditioning mode, the control device 60 calculates the opening degree SW of the air mix door 34.

The control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full open state, the air conditioning expansion valve 14b is brought into a throttle state, the cooling expansion valve 14c is brought into a throttle state, and the bypass side flow rate adjustment valve 14d is brought into a full close state. The control device 60 determines the control voltages to be output to the high-pressure side on-off valve 22a and the low-pressure side on-off valve 22b so as to close the high-pressure side on-off valve 22a and close the low-pressure side on-off valve 22b.

Furthermore, the control device 60 appropriately determines the operation state of another piece of equipment to be controlled. For example, the control device 60 determines the control voltages to be output to the high-temperature side pump 41 and the low-temperature side pump 51 so as to exhibit predetermined reference pumping capability. For example, the control device 60 determines the operation state of the heat medium three-way valve 53 such that the first low-temperature side heat medium temperature TWL1 detected by the first low-temperature side heat medium temperature sensor 64a approaches the target low-temperature side heat medium temperature TWLO.

The control device 60 outputs a control signal or a control voltage to various pieces of equipment to be controlled so as to obtain the control states of the various pieces of equipment to be controlled determined as described above. Then, as indicated by Z in FIG. 3, the control flow returns to step S10.

Therefore, in the heat pump cycle 10 in the cooling air conditioning mode, the refrigerant discharged from the compressor 11 circulates in order of the water refrigerant heat exchanger 13, the heating expansion valve 14a that is fully opened, the outdoor heat exchanger 15, the fifth three-way joint 12e, the air conditioning expansion valve 14b, the indoor evaporator 18, the accumulator 23, and the suction port of the compressor 11. At the same time, the refrigerant circuit is switched to the refrigerant circuit in which the refrigerant discharged from the compressor 11 circulates in order of the water refrigerant heat exchanger 13, the heating expansion valve 14a that is fully opened, the outdoor heat exchanger 15, the fifth three-way joint 12e, the cooling expansion valve 14c, the chiller 20, the accumulator 23, and the suction port of the compressor 11.

That is, the refrigerant circuit is switched to a refrigerant circuit in which the indoor evaporator 18 and the chiller 20 are connected in parallel to the flow of the refrigerant flowing out of the water refrigerant heat exchanger 13.

For this reason, in the heat pump cycle 10 in the cooling air conditioning mode, a vapor compression refrigeration cycle is configured in which the water refrigerant heat exchanger 13 and the outdoor heat exchanger 15 are caused to function as a condenser, and the indoor evaporator 18 and the chiller 20 are caused to function as an evaporator.

In the water refrigerant heat exchanger 13, the refrigerant dissipates heat to the high-temperature side heat medium, whereby the high-temperature side heat medium is heated. In the indoor evaporator 18, the ventilation air is cooled by the refrigerant absorbing heat from the ventilation air. At the chiller 20, the low-temperature side heat medium is cooled by the refrigerant absorbing heat from the low-temperature side heat medium.

In the high-temperature side heat medium circuit 40 in the cooling air conditioning mode, the high-temperature side heat medium heated by the water refrigerant heat exchanger 13 flows into the heater core 42, similarly to the single air conditioning mode.

In the low-temperature side heat medium circuit 50 in the cooling air conditioning mode, the low-temperature side heat medium cooled so as to approach the target low-temperature side heat medium temperature TWLO flows into the cooling water passage 70a of the battery 70. Then, the low-temperature side heat medium flows through the cooling water passage 70a of the battery 70, whereby the battery 70 is cooled.

In the indoor air conditioning unit 30 in the cooling air conditioning mode, similarly to the single air conditioning mode, the conditioned air whose temperature has been adjusted so as to approach the target blowing temperature TAO is blown to the vehicle interior. This achieves air conditioning of the vehicle interior.

### (6) Cooling Series Dehumidification Heating Mode

In the cooling series dehumidification heating mode, the control device 60 executes a cooling series dehumidification heating mode control flow. In the cooling series dehumidification heating mode control flow, the control device 60 determines the target evaporator temperature TEO, similarly to the series dehumidification heating mode. Therefore, the control flow in the series dehumidification heating mode includes the target evaporator temperature determination unit. Furthermore, similarly to the series dehumidification heating mode, the control device 60 determines the increase-decrease amount ΔIVO of the rotation speed of the compressor 11.

Similarly to the series dehumidification heating mode, the control device 60 determines the target high-temperature side heat medium temperature TWHO of the high-temperature side heat medium. Furthermore, similarly to the series dehumidification heating mode, the control device 60 determines the change amount ΔKPN1 of the opening degree pattern KPN1.

Similarly to the cooling air conditioning mode, the control device 60 determines the target superheating degree SHCO of the outlet side refrigerant of the refrigerant passage of the chiller 20. Furthermore, similarly to the cooling air conditioning mode, the control device 60 determines the increase-decrease amount ΔEVB of the throttle opening degree of the cooling expansion valve 14c.

The control device 60 determines the target low-temperature side heat medium temperature TWLO, similarly to the cooling air conditioning mode.

Similarly to the single air conditioning mode, the control device 60 calculates the opening degree SW of the air mix door 34.

The control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a throttle state, the cooling expansion valve 14c is brought into a throttle state, and the bypass side flow rate adjustment valve 14d is brought into a full close state. The control device 60 determines the control voltages to be output to the high-pressure side on-off valve 22a and the low-pressure side on-off valve 22b so as to close the high-pressure side on-off valve 22a and close the low-pressure side on-off valve 22b.

Furthermore, similarly to the cooling air conditioning mode, the control device 60 appropriately determines the operation state of another piece of equipment to be controlled.

The control device 60 outputs a control signal or a control voltage to various pieces of equipment to be controlled so as to obtain the control states of the various pieces of equipment to be controlled determined as described above. Then, as indicated by Z in FIG. 3, the control flow returns to step S10.

Therefore, in the heat pump cycle 10 in the cooling series dehumidification heating mode, the refrigerant discharged from the compressor 11 circulates in order of the water refrigerant heat exchanger 13, the heating expansion valve 14a, the outdoor heat exchanger 15, the air conditioning expansion valve 14b, the indoor evaporator 18, the accumulator 23, and the suction port of the compressor 11. At the same time, the refrigerant circuit is switched to the refrigerant circuit in which the refrigerant discharged from the compressor 11 circulates in order of the water refrigerant heat exchanger 13, the heating expansion valve 14a, the outdoor heat exchanger 15, the cooling expansion valve 14c, the chiller 20, the accumulator 23, and the suction port of the compressor 11.

That is, the refrigerant circuit is switched to a refrigerant circuit in which the indoor evaporator 18 and the chiller 20 are connected in parallel to the flow of the refrigerant flowing out of the outdoor heat exchanger 15.

For this reason, in the heat pump cycle 10 in the cooling series dehumidification heating mode, a vapor compression refrigeration cycle is configured in which the water refrigerant heat exchanger 13 is caused to function as a condenser and the indoor evaporator 18 and the chiller 20 are caused to function as an evaporator.

Furthermore, in the heat pump cycle 10 in the cooling series dehumidification heating mode, when the saturation temperature of the refrigerant at the outdoor heat exchanger 15 is higher than the outside air temperature Tam, the outdoor heat exchanger 15 is caused to function as a condenser. When the saturation temperature of the refrigerant at the outdoor heat exchanger 15 is lower than the outside air temperature Tam, the outdoor heat exchanger 15 is caused to function as an evaporator.

In the water refrigerant heat exchanger 13, the refrigerant dissipates heat to the high-temperature side heat medium, whereby the high-temperature side heat medium is heated. In the indoor evaporator 18, the ventilation air is cooled by the refrigerant absorbing heat from the ventilation air. At the chiller 20, the low-temperature side heat medium is cooled by the refrigerant absorbing heat from the low-temperature side heat medium.

In the high-temperature side heat medium circuit 40 in the cooling series dehumidification heating mode, the high-temperature side heat medium heated by the water refrigerant heat exchanger 13 flows into the heater core 42, similarly to the single air conditioning mode.

In the low-temperature side heat medium circuit 50 in the cooling series dehumidification heating mode, similarly to the cooling air conditioning mode, the cooled low-temperature side heat medium flows through the cooling water passage 70a of the battery 70, whereby the battery 70 is cooled.

In the indoor air conditioning unit 30 in the cooling series dehumidification heating mode, similarly to the series dehumidification heating mode, the conditioned air whose temperature has been adjusted so as to approach the target blowing temperature TAO is blown to the vehicle interior. This achieves dehumidification heating of the vehicle interior.

### (7-1) Cooling HG Dehumidification Heating Mode

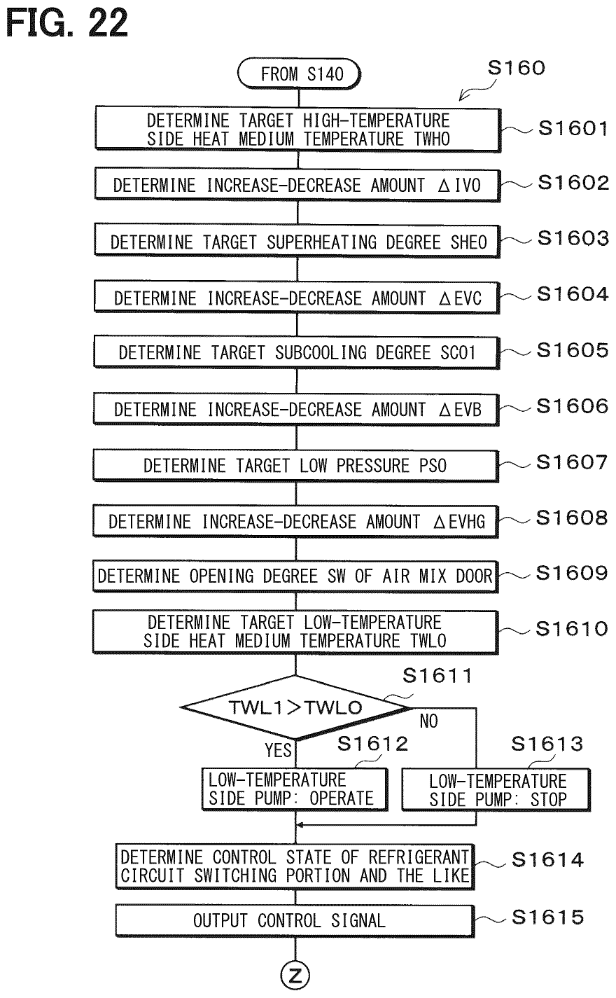

In the cooling HG dehumidification heating mode, the control device 60 executes a cooling HG dehumidification heating mode control flow shown in FIG. 22.

In steps S1601 to S1609 of FIG. 22, the control states of the various pieces of equipment to be controlled are determined similarly to steps S1901 to S1909 of FIG. 13 in the HG dehumidification heating mode. Therefore, in the cooling HG dehumidification heating mode, step S1607 serves as the target evaporator temperature determination unit.

In step S1610, the target low-temperature side heat medium temperature TWLO is determined, similarly to the cooling air conditioning mode.

In step S1611, water temperature determination is performed. Specifically, it is determined whether the first low-temperature side heat medium temperature TWL1 is higher than the target low-temperature side heat medium temperature TWLO.

If it is determined in step S1611 that the first low-temperature side heat medium temperature TWL1 is higher than the target low-temperature side heat medium temperature TWLO, the process proceeds to step S1612. In step S1612, the control voltage to be output to the low-temperature side pump 51 is determined so as to exhibit predetermined reference pumping capability, and the process proceeds to step S1614.

If it is determined in step S1611 that the first low-temperature side heat medium temperature TWL1 is not higher than the target low-temperature side heat medium temperature TWLO, the process proceeds to step S1613. In step S1613, it is determined to stop the low-temperature side pump 51, and the process proceeds to step S1614.

In step S1614, the control signals to be output to the heating expansion valve 14a, the air conditioning expansion valve 14b, the cooling expansion valve 14c, and the bypass side flow rate adjustment valve 14d are determined such that the heating expansion valve 14a is brought into a full close state, the air conditioning expansion valve 14b is brought into a throttle state, the cooling expansion valve 14c is brought into a throttle state, and the bypass side flow rate adjustment valve 14d is brought into a throttle state. The control voltages to be output to the high-pressure side on-off valve 22a and the low-pressure side on-off valve 22b are determined so as to open the high-pressure side on-off valve 22a and close the low-pressure side on-off valve 22b.

Furthermore, similarly to the cooling air conditioning mode, the control device 60 appropriately determines the operation state of another piece of equipment to be controlled.

In step S1615, a control signal or a control voltage is output to each piece of equipment to be controlled so as to obtain the control states of the various pieces of equipment to be controlled determined as described above. Then, as indicated by Z in FIGS. 3 and 22, the control flow returns to step S10.

Therefore, in the heat pump cycle 10 in the cooling HG dehumidification heating mode, as indicated by the solid arrows in FIG. 14, the refrigerant circuit is switched to the refrigerant circuit in which the refrigerant discharged from the compressor 11 circulates in the same order as that in the HG dehumidification heating mode.

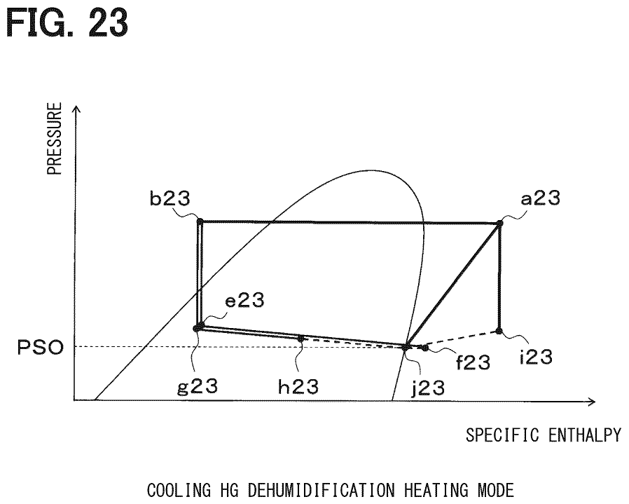

For this reason, in the heat pump cycle 10 in the cooling HG dehumidification heating mode, the state of the refrigerant changes as shown in the Mollier chart of FIG. 23. In the cooling HG dehumidification heating mode, the refrigerant flowing into the chiller 20 absorbs heat from the low-temperature side heating medium (from point g23 to point h23 in FIG. 23) with respect to the HG dehumidification heating mode. Accordingly, the low-temperature side heat medium is cooled. Other operations of the heat pump cycle 10 are similar to those in the HG dehumidification heating mode.

In the high-temperature side heat medium circuit 40 in the cooling HG dehumidification heating mode, as indicated by the solid arrows in FIG. 14, the high-temperature side heat medium heated by the water refrigerant heat exchanger 13 flows into the heater core 42, similarly to the single air conditioning mode.

In the low-temperature side heat medium circuit 50 in the cooling HG dehumidification heating mode, as indicated by the broken arrows in FIG. 14, similarly to the cooling air conditioning mode, the cooled low-temperature side heat medium flows through the cooling water passage 70a of the battery 70, whereby the battery 70 is cooled.

In the indoor air conditioning unit 30 in the cooling HG dehumidification heating mode, similarly to the HG dehumidification heating mode, the conditioned air whose temperature has been adjusted so as to approach the target blowing temperature TAO is blown to the vehicle interior. This achieves dehumidification heating of the vehicle interior.

In the cooling HG dehumidification heating mode, similarly to the HG dehumidification heating mode, the heating capability of the high-temperature side heat medium at the water refrigerant heat exchanger 13 can be improved by increasing the refrigerant discharge capability of the compressor 11. Therefore, in the cooling HG dehumidification heating mode, the battery 70 can be cooled, and the heating capability of the ventilation air at the heating portion can be improved more than the cooling series dehumidification heating mode.

### (7-2) Cooling Outside Air Endothermic HG Dehumidification Heating Mode

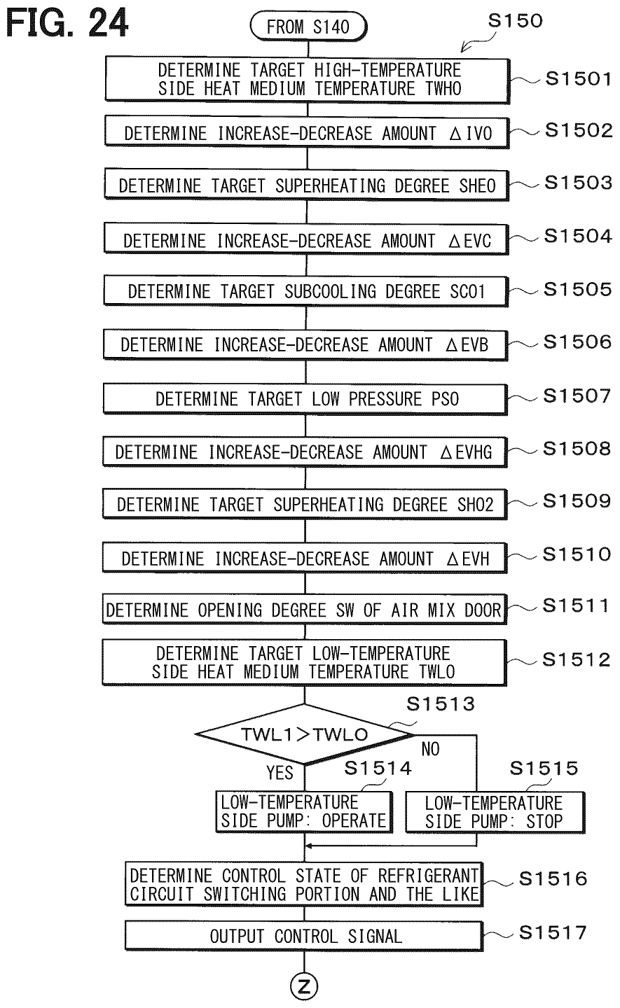

In the cooling outside air endothermic HG dehumidification heating mode, the control device 60 executes a cooling outside air endothermic HG dehumidification heating mode control flow shown in FIG. 24.

In steps S1501 to S1511 of FIG. 24, the control states of the various pieces of equipment to be controlled are determined similarly to steps S1801 to S1811 of FIG. 16 in the outside air endothermic HG dehumidification heating mode. Therefore, in the cooling outside air endothermic HG dehumidification heating mode, step S1507 serves as the target evaporator temperature determination unit.

Furthermore, in steps S1512 to S1515 of FIG. 24, the target low-temperature side heat medium temperature TWLO and the control state of the low-temperature side pump 51 are determined similarly to steps S1610 to S1613 of FIG. 23 in the cooling HG dehumidification heating mode.

In step S1516, the control signals to be output to the heating expansion and the bypass side flow rate adjustment valve 14d are determined such that the heating expansion valve 14a is brought into a throttle state, the air conditioning expansion valve 14b is brought into a throttle state, the cooling expansion valve 14c is brought into a throttle state, and the bypass side flow rate adjustment valve 14d is brought into a throttle state. The control voltages to be output to the high-pressure side on-off valve 22a and the low-pressure side on-off valve 22b are determined so as to open the high-pressure side on-off valve 22a and close the low-pressure side on-off valve 22b.

Furthermore, similarly to the cooling air conditioning mode, the control device 60 appropriately determines the operation state of another piece of equipment to be controlled.

In step S1517, a control signal or a control voltage is output to each piece of equipment to be controlled so as to obtain the control states of the various pieces of equipment to be controlled determined as described above. Then, as indicated by Z in FIGS. 3 and 24, the control flow returns to step S10.

Therefore, in the heat pump cycle 10 in the cooling outside air endothermic HG dehumidification heating mode, as indicated by the solid arrows in FIG. 17, the refrigerant circuit is switched to the refrigerant circuit in which the refrigerant discharged from the compressor 11 circulates in the same order as that in the outside air endothermic HG dehumidification heating mode.

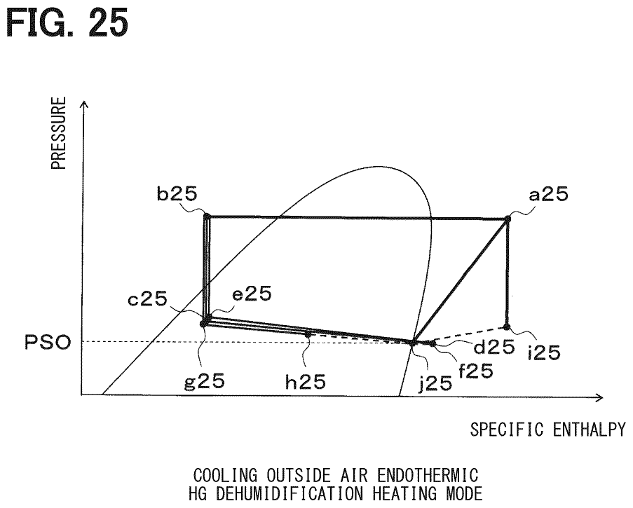

For this reason, in the heat pump cycle 10 in the cooling outside air endothermic HG dehumidification heating mode, the state of the refrigerant changes as shown in the Mollier chart of FIG. 25. In the cooling outside air endothermic HG dehumidification heating mode, the refrigerant flowing into the chiller 20 absorbs heat from the low-temperature side heat medium (from point g25 to point h25 in FIG. 25) with respect to the outside air endothermic HG dehumidification heating mode. Accordingly, the low-temperature side heat medium is cooled. Other operations of the heat pump cycle 10 are similar to those in the outside air endothermic HG dehumidification heating mode.

In the high-temperature side heat medium circuit 40 in the cooling outside air endothermic HG dehumidification heating mode, as indicated by the solid arrows in FIG. 17, the high-temperature side heat medium heated by the water refrigerant heat exchanger 13 flows into the heater core 42, similarly to the single air conditioning mode.

In the low-temperature side heat medium circuit 50 in the cooling outside air endothermic HG dehumidification heating mode, as indicated by the broken arrows in FIG. 17, similarly to the cooling air conditioning mode, the cooled low-temperature side heat medium flows through the cooling water passage 70a of the battery 70, whereby the battery 70 is cooled.

In the indoor air conditioning unit 30 in the cooling outside air endothermic HG dehumidification heating mode, similarly to the outside air endothermic HG dehumidification heating mode, the conditioned air whose temperature has been adjusted so as to approach the target blowing temperature TAO is blown to the vehicle interior. This achieves dehumidification heating of the vehicle interior.

In the cooling outside air endothermic HG dehumidification heating mode, similarly to the cooling HG dehumidification heating mode, the battery 70 is cooled, and at the same time, the heating capability of the ventilation air at the heating portion can be improved more than the cooling series dehumidification heating mode.

Furthermore, in the cooling outside air endothermic HG dehumidification heating mode, the ventilation air can be heated using the heat absorbed from the outside air by the refrigerant at the outdoor heat exchanger 15. Therefore, in the cooling outside air endothermic HG dehumidification heating mode, the operation efficiency of the heat pump cycle 10 can be improved more than that in the cooling HG dehumidification heating mode.

### (8) Cooling Equipment Endothermic Heating Mode

In the cooling equipment endothermic heating mode, the control device 60 executes a cooling equipment endothermic heating mode control flow. In the cooling equipment endothermic heating mode control flow, the control device 60 determines the target low-temperature side heat medium temperature TWLO, similarly to the cooling air conditioning mode.

Furthermore, the control device 60 determines an increase-decrease amount ΔIVO of the rotation speed of the compressor 11. The increase-decrease amount ΔIVO in the cooling equipment endothermic heating mode is determined such that the first low-temperature side heat medium temperature TWL1 approaches the target low-temperature side heat medium temperature TWLO by a feedback control method based on a deviation between the target low-temperature side heat medium temperature TWLO and the first low-temperature side heat medium temperature TWL1.

Similarly to the single air conditioning mode, the control device 60 determines a target subcooling degree SCO2 of the refrigerant flowing out of the outdoor heat exchanger 15.

Furthermore, the control device 60 determines the increase-decrease amount ΔEVB of the throttle opening degree of the cooling expansion valve 14c. The increase-decrease amount ΔEVB in the cooling equipment endothermic heating mode is determined such that the subcooling degree SC2 of the refrigerant flowing out of the water refrigerant heat exchanger 13 approaches the target subcooling degree SCO2 by a feedback control method based on a deviation between the target subcooling degree SCO2 and the subcooling degree SC2 of the refrigerant flowing out of the outdoor heat exchanger 15.

Similarly to the single air conditioning mode, the control device 60 calculates the opening degree SW of the air mix door 34.

The control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full open state, the air conditioning expansion valve 14b is brought into a full close state, the cooling expansion valve 14c is brought into a throttle state, and the bypass side flow rate adjustment valve 14d is brought into a full close state. The control device 60 determines the control voltages to be output to the high-pressure side on-off valve 22a and the low-pressure side on-off valve 22b so as to close the high-pressure side on-off valve 22a and close the low-pressure side on-off valve 22b.

Furthermore, similarly to the cooling air conditioning mode, the control device 60 appropriately determines the operation state of another piece of equipment to be controlled.

The control device 60 outputs a control signal or a control voltage to various pieces of equipment to be controlled so as to obtain the control states of the various pieces of equipment to be controlled determined as described above. Then, as indicated by Z in FIG. 3, the control flow returns to step S10.

Therefore, in the heat pump cycle 10 in the cooling equipment endothermic heating mode, the refrigerant circuit is switched to the refrigerant circuit in which the refrigerant discharged from the compressor 11 circulates in order of the water refrigerant heat exchanger 13, the heating expansion valve 14a that is fully opened, the outdoor heat exchanger 15, the cooling expansion valve 14c, the chiller 20, the accumulator 23, and the suction port of the compressor 11.

For this reason, in the heat pump cycle 10 in the cooling equipment endothermic heating mode, a vapor compression refrigeration cycle is configured in which the water refrigerant heat exchanger 13 and the outdoor heat exchanger 15 are caused to function as a condenser and the chiller 20 is caused to function as an evaporator.

In the water refrigerant heat exchanger 13, the refrigerant dissipates heat to the high-temperature side heat medium, whereby the high-temperature side heat medium is heated. At the chiller 20, the low-temperature side heat medium is cooled by the refrigerant absorbing heat from the low-temperature side heat medium.

In the high-temperature side heat medium circuit 40 in the cooling equipment endothermic heating mode, the high-temperature side heat medium heated by the water refrigerant heat exchanger 13 flows into the heater core 42, similarly to the single air conditioning mode.

In the low-temperature side heat medium circuit 50 in the cooling equipment endothermic heating mode, similarly to the cooling air conditioning mode, the cooled low-temperature side heat medium flows through the cooling water passage 70a of the battery 70, whereby the battery 70 is cooled.

In the indoor air conditioning unit 30 in the cooling equipment endothermic heating mode, similarly to the outside air endothermic heating mode, the conditioned air whose temperature has been adjusted so as to approach the target blowing temperature TAO is blown to the vehicle interior. This achieves heating of the vehicle interior.

### (9) Cooling Outside Air Endothermic Heating Mode

In the cooling outside air endothermic heating mode, the control device 60 executes a cooling outside air endothermic heating mode control flow. In the cooling outside air endothermic heating mode control flow, the control device 60 determines the target low-temperature side heat medium temperature TWLO, similarly to the cooling air conditioning mode.

Furthermore, the control device 60 determines an increase-decrease amount ΔIVO of the rotation speed of the compressor 11. The increase-decrease amount ΔIVO in the cooling outside air endothermic heating mode is determined such that the first low-temperature side heat medium temperature TWL1 approaches the target low-temperature side heat medium temperature TWLO by a feedback control method based on a deviation between the target low-temperature side heat medium temperature TWLO and the first low-temperature side heat medium temperature TWL1.

Similarly to the series dehumidification heating mode, the control device 60 determines the target high-temperature side heat medium temperature TWHO of the high-temperature side heat medium. Furthermore, the control device 60 determines a change amount ΔKPN2 of an opening degree pattern KPN2.

The opening degree pattern KPN2 is a parameter for determining a combination of the throttle opening degree of the heating expansion valve 14a and the throttle opening degree of the cooling expansion valve 14c. The opening degree pattern KPN2 corresponds to the opening degree ratio of the throttle opening degree of the cooling expansion valve 14c to the throttle opening degree of the heating expansion valve 14a.

In the control map of the cooling outside air endothermic heating mode, as the target blowing temperature TAO rises, the opening degree pattern KPN2 is increased. That is, as the target blowing temperature TAO rises, the opening degree ratio of the throttle opening degree of the cooling expansion valve 14c to the throttle opening degree of the heating expansion valve 14a is increased.

Similarly to the single air conditioning mode, the control device 60 calculates the opening degree SW of the air mix door 34.

The control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a full close state, the cooling expansion valve 14c is brought into a throttle state, and the bypass side flow rate adjustment valve 14d is brought into a full close state. The control device 60 determines the control voltages to be output to the high-pressure side on-off valve 22a and the low-pressure side on-off valve 22b so as to close the high-pressure side on-off valve 22a and close the low-pressure side on-off valve 22b.

Furthermore, similarly to the cooling air conditioning mode, the control device 60 appropriately determines the operation state of another piece of equipment to be controlled.

The control device 60 outputs a control signal or a control voltage to various pieces of equipment to be controlled so as to obtain the control states of the various pieces of equipment to be controlled determined as described above. Then, as indicated by Z in FIG. 3, the control flow returns to step S10.

Therefore, in the heat pump cycle 10 in the cooling outside air endothermic heating mode, the refrigerant circuit is switched to the refrigerant circuit in which the refrigerant discharged from the compressor 11 circulates in order of the water refrigerant heat exchanger 13, the heating expansion valve 14a, the outdoor heat exchanger 15, the cooling expansion valve 14c, the chiller 20, the accumulator 23, and the suction port of the compressor 11.

For this reason, in the heat pump cycle 10 in the cooling outside air endothermic heating mode, a vapor compression refrigeration cycle is configured in which the water refrigerant heat exchanger 13 is caused to function as a condenser and the chiller 20 is caused to function as an evaporator.

Furthermore, in the heat pump cycle 10 in the cooling outside air endothermic heating mode, when the saturation temperature of the refrigerant at the outdoor heat exchanger 15 is higher than the outside air temperature Tam, the outdoor heat exchanger 15 is caused to function as a condenser. When the saturation temperature of the refrigerant at the outdoor heat exchanger 15 is lower than the outside air temperature Tam, the outdoor heat exchanger 15 is caused to function as an evaporator.

In the water refrigerant heat exchanger 13, the refrigerant dissipates heat to the high-temperature side heat medium, whereby the high-temperature side heat medium is heated. At the chiller 20, the low-temperature side heat medium is cooled by the refrigerant absorbing heat from the low-temperature side heat medium.

In the high-temperature side heat medium circuit 40 in the cooling outside air endothermic heating mode, the high-temperature side heat medium heated by the water refrigerant heat exchanger 13 flows into the heater core 42, similarly to the single air conditioning mode.

In the low-temperature side heat medium circuit 50 in the cooling outside air endothermic heating mode, similarly to the cooling air conditioning mode, the cooled low-temperature side heat medium flows through the cooling water passage 70a of the battery 70, whereby the battery 70 is cooled.

In the indoor air conditioning unit 30 in the cooling outside air endothermic heating mode, similarly to the outside air endothermic heating mode, the conditioned air whose temperature has been adjusted so as to approach the target blowing temperature TAO is blown to the vehicle interior. This achieves heating of the vehicle interior.

### (10-1) Cooling HG Heating Mode

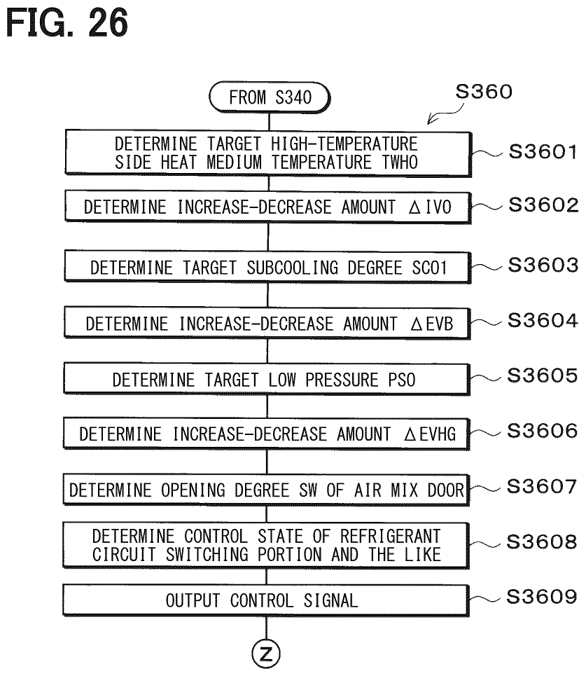

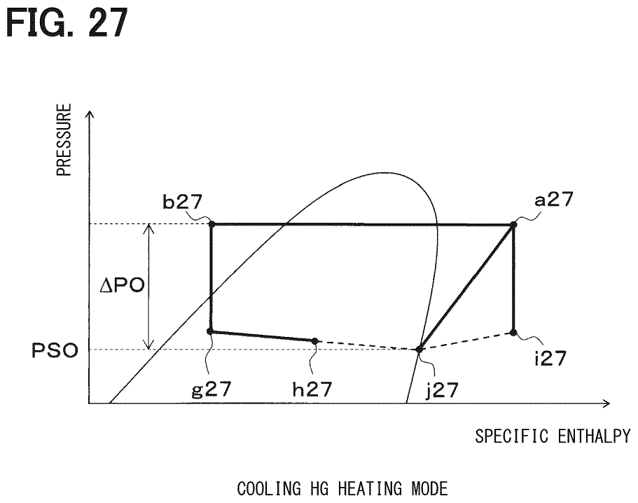

In the cooling HG heating mode, the control device 60 executes a cooling HG heating mode control flow shown in FIG. 26.

In steps S3601 to S3602 in FIG. 26, similarly to steps S1901 to $1902 in FIG. 13 in the HG dehumidification heating mode, the target high-temperature side heat medium temperature TWHO and the increase-decrease amount ΔIVO of the rotation speed of the compressor 11 are determined. In steps S3603 to S3607 of FIG. 26, the control states of the various pieces of equipment to be controlled are determined similarly to steps S1905 to S1909 of FIG. 13 in the HG dehumidification heating mode. Therefore, in the cooling HG heating mode, step S3605 serves as the target evaporator temperature determination unit.

In step S3608, the control signals to be output to the heating expansion valve 14a, the air conditioning expansion valve 14b, the cooling expansion valve 14c, and the bypass side flow rate adjustment valve 14d are determined such that the heating expansion valve 14a is brought into a full close state, the air conditioning expansion valve 14b is brought into a full close state, the cooling expansion valve 14c is brought into a throttle state, and the bypass side flow rate adjustment valve 14d is brought into a throttle state. The control voltages to be output to the high-pressure side on-off valve 22a and the low-pressure side on-off valve 22b are determined so as to open the high-pressure side on-off valve 22a and close the low-pressure side on-off valve 22b.

Furthermore, similarly to the cooling air conditioning mode, the control device 60 appropriately determines the operation state of another piece of equipment to be controlled.

In step S3609, a control signal or a control voltage is output to each piece of equipment to be controlled so as to obtain the control states of the various pieces of equipment to be controlled determined as described above. Then, as indicated by Z in FIGS. 3 and 26, the control flow returns to step S10.

Therefore, in the heat pump cycle 10 in the cooling HG heating mode, as indicated by the solid arrows in FIG. 20, the refrigerant circuit is switched to the refrigerant circuit in which the refrigerant discharged from the compressor 11 circulates in the same order as that in the HG heating mode.

For this reason, in the heat pump cycle 10 in the cooling HG heating mode, the state of the refrigerant changes as shown in the Mollier chart of FIG. 27. In the cooling HG heating mode, the refrigerant flowing into the chiller 20 absorbs heat from the low-temperature side heat medium (from point g27 to point h27 in FIG. 27) with respect to the HG heating mode. Accordingly, the low-temperature side heat medium is cooled. Other operations of the heat pump cycle 10 are similar to those in the HG heating mode.

In the high-temperature side heat medium circuit 40 in the cooling HG heating mode, as indicated by the solid arrows in FIG. 20, the high-temperature side heat medium heated by the water refrigerant heat exchanger 13 flows into the heater core 42, similarly to the single air conditioning mode.

In the low-temperature side heat medium circuit 50 in the cooling HG heating mode, as indicated by the broken arrows in FIG. 20, similarly to the cooling air conditioning mode, the cooled low-temperature side heat medium flows through the cooling water passage 70a of the battery 70, whereby the battery 70 is cooled.

In the indoor air conditioning unit 30 in the cooling HG heating mode, similarly to the HG heating mode, the conditioned air whose temperature has been adjusted so as to approach the target blowing temperature TAO is blown to the vehicle interior. This achieves heating of the vehicle interior.

In the cooling HG heating mode, similarly to the HG heating mode, by increasing the refrigerant discharge capability of the compressor 11, the cycle can be balanced even if the heating capacity of the high-temperature side heat medium at the water refrigerant heat exchanger 13 is improved. Therefore, in the cooling HG heating mode, the battery 70 is cooled, and at the same time, the heating capability of the ventilation air at the heating portion can be improved more than the cooling outside air endothermic heating mode.

### (10-2) Cooling Outside Air Endothermic HG Heating Mode

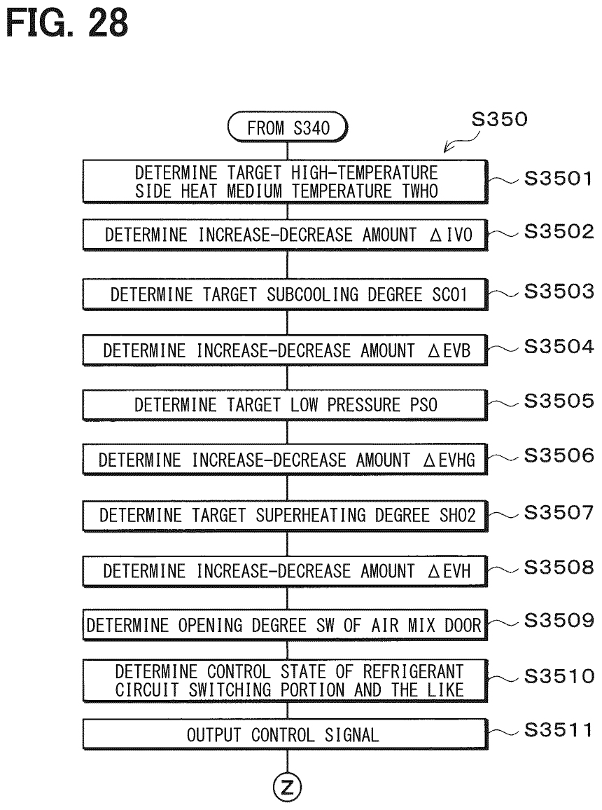

In the cooling outside air endothermic HG heating mode, the control device 60 executes a cooling outside air endothermic HG heating mode control flow shown in FIG. 28.

In steps S3501 to S3506 of FIG. 28, the control states of the various pieces of equipment to be controlled are determined similarly to steps S3601 to S3606 of FIG. 26 in the cooling HG heating mode. Therefore, in the cooling outside air endothermic HG heating mode, step S3505 serves as the target evaporator temperature determination unit.

In step S3507, the target superheating degree SHO2 of the outlet side refrigerant of the outdoor heat exchanger 15 is determined. As the target superheating degree SHO2, a predetermined constant (in the present embodiment, 5° C.) can be employed.

In step S3508, the increase-decrease amount ΔEVH of the throttle opening degree of the heating expansion valve 14a is determined. The increase-decrease amount ΔEVH in the cooling outside air endothermic HG heating mode is determined such that the superheating degree SH2 of the outlet side refrigerant of the outdoor heat exchanger 15 approaches the target superheating degree SHO2 by a feedback control method based on a deviation between the target superheating degree SHO2 and the superheating degree SH2 of the outlet side refrigerant of the outdoor heat exchanger 15.

In step S3509, the opening degree SW of the air mix door 34 is calculated, similarly to the single air conditioning mode.

In step S3510, the control signals to be output to the heating expansion valve 14a, the air conditioning expansion valve 14b, the cooling expansion valve 14c, and the bypass side flow rate adjustment valve 14d are determined such that the heating expansion valve 14a is brought into a throttle state, the air conditioning expansion valve 14b is brought into a full close state, the cooling expansion valve 14c is brought into a throttle state, and the bypass side flow rate adjustment valve 14d is brought into a throttle state. The control voltages to be output to the high-pressure side on-off valve 22a and the low-pressure side on-off valve 22b are determined so as to open the high-pressure side on-off valve 22a and close the low-pressure side on-off valve 22b.

Furthermore, similarly to the cooling air conditioning mode, the control device 60 appropriately determines the operation state of another piece of equipment to be controlled.

In step S3511, a control signal or a control voltage is output to each piece of equipment to be controlled so as to obtain the control states of the various pieces of equipment to be controlled determined as described above. Then, as indicated by Z in FIGS. 3 and 28, the control flow returns to step S10.

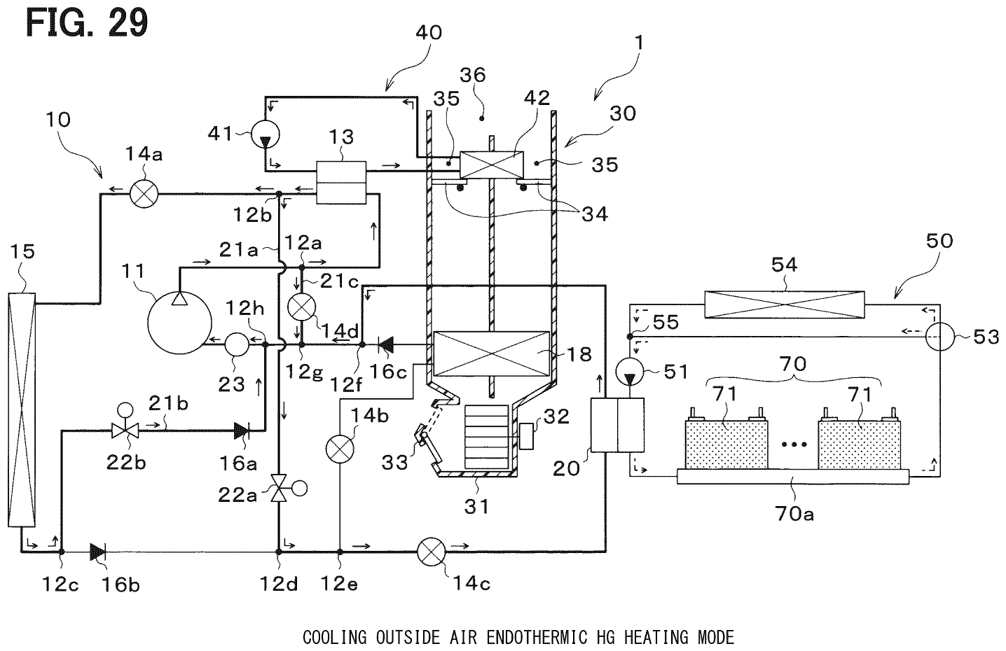

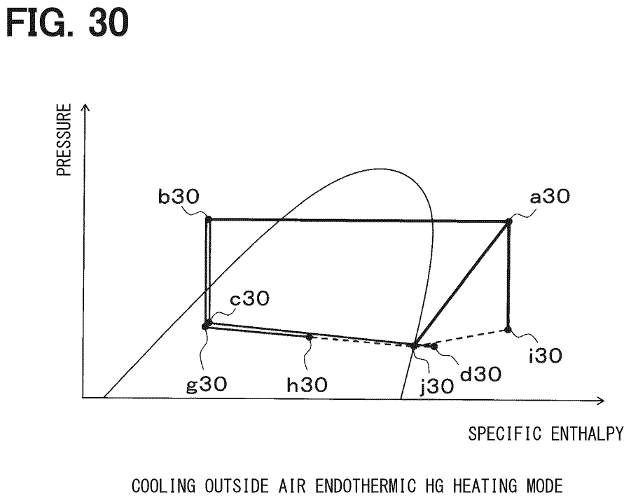

Accordingly, in the heat pump cycle 10 in the cooling outside air endothermic HG heating mode, as indicated by the solid arrows in FIG. 29, the refrigerant discharged from the compressor 11 circulates in the same order as that in the HG heating mode. At the same time, the refrigerant circuit is switched to the refrigerant circuit in which the refrigerant discharged from the compressor 11 circulates in order of the first three-way joint 12a, the water refrigerant heat exchanger 13, the second three-way joint 12b, the heating expansion valve 14a, the outdoor heat exchanger 15, the low-pressure side passage 21b, the accumulator 23, and the suction port of the compressor 11.

That is, the outdoor heat exchanger 15 and chiller 20 are connected in parallel to the flow of the refrigerant flowing out of the water refrigerant heat exchanger 13. For this reason, in the heat pump cycle 10 in the cooling outside air endothermic HG heating mode, the state of the refrigerant changes as shown in the Mollier chart of FIG. 30.

In the cooling outside air endothermic HG heating mode, the flow of the refrigerant flowing out of the water refrigerant heat exchanger 13 is branched at the second three-way joint 12b with respect to the HG heating mode. One refrigerant flowing out of one outflow port of the second three-way joint 12b flows into the heating expansion valve 14a and is depressurized (from point b30 to point c30 in FIG. 30).

The refrigerant depressurized at the heating expansion valve 14a flows into the outdoor heat exchanger 15. The refrigerant flowing into the outdoor heat exchanger 15 absorbs heat from the outside air and evaporates (from point c30 to point d30 in FIG. 30). The refrigerant flowing out of the outdoor heat exchanger 15 flows into one inflow port of the eighth three-way joint 12h via the low-pressure side passage 21b.

Furthermore, in the cooling outside air endothermic HG heating mode, the refrigerant flowing into the chiller 20 absorbs heat from the low-temperature side heat medium (from point g30 to point h30 in FIG. 30) with respect to the HG heating mode. Accordingly, the low-temperature side heat medium is cooled. Other operations of the heat pump cycle 10 are similar to those in the HG heating mode.

In the high-temperature side heat medium circuit 40 in the cooling outside air endothermic HG heating mode, as indicated by the solid arrows in FIG. 29, the high-temperature side heat medium heated by the water refrigerant heat exchanger 13 flows into the heater core 42, similarly to the single air conditioning mode.

In the low-temperature side heat medium circuit 50 in the cooling outside air endothermic HG heating mode, as indicated by the broken arrows in FIG. 29, similarly to the cooling air conditioning mode, the cooled low-temperature side heat medium flows through the cooling water passage 70a of the battery 70, whereby the battery 70 is cooled.

In the indoor air conditioning unit 30 in the cooling outside air endothermic HG heating mode, similarly to the HG heating mode, the conditioned air whose temperature has been adjusted so as to approach the target blowing temperature TAO is blown to the vehicle interior. This achieves heating of the vehicle interior.

In the cooling outside air endothermic HG heating mode, similarly to the cooling HG heating mode, the battery 70 is cooled, and at the same time, the heating capability of the ventilation air at the heating portion can be improved more than the cooling outside air endothermic heating mode.

Furthermore, in the cooling outside air endothermic HG heating mode, the ventilation air can be heated using the heat absorbed from the outside air by the refrigerant at the outdoor heat exchanger 15. Therefore, in the cooling outside air endothermic HG heating mode, the operation efficiency of the heat pump cycle 10 can be improved more than that in the cooling HG heating mode.

### (11) Cooling Mode

In the cooling mode, the control device 60 executes a cooling mode control flow. In the cooling mode control flow, similarly to the cooling equipment endothermic heating mode, the control device 60 determines the target low-temperature side heat medium temperature TWLO and the increase-decrease amount ΔIVO of the rotation speed of the compressor 11. Similarly to the cooling equipment endothermic heating mode, the control device 60 determines the target subcooling degree SCO2 and the increase-decrease amount ΔEVB of the throttle opening degree of the cooling expansion valve 14c.

The control device 60 determines the opening degree SW of the air mix door 34=0%. That is, the control device 60 determines a control signal to be output to the driving actuator of the air mix door 34 so that the air mix door 34 is displaced to a max cool position.

The control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full open state, the air conditioning expansion valve 14b is brought into a full close state, the cooling expansion valve 14c is brought into a throttle state, and the bypass side flow rate adjustment valve 14d is brought into a full close state. The control device 60 determines the control voltages to be output to the high-pressure side on-off valve 22a and the low-pressure side on-off valve 22b so as to close the high-pressure side on-off valve 22a and close the low-pressure side on-off valve 22b.

Furthermore, similarly to the cooling air conditioning mode, the control device 60 appropriately determines the operation state of another piece of equipment to be controlled. For example, the control device 60 stops the indoor blower 32.

The control device 60 outputs a control signal or a control voltage to various pieces of equipment to be controlled so as to obtain the control states of the various pieces of equipment to be controlled determined as described above. Then, as indicated by Z in FIG. 3, the control flow returns to step S10.

Therefore, in the heat pump cycle 10 in the cooling mode, the refrigerant circuit is switched to the refrigerant circuit in which the refrigerant discharged from the compressor 11 circulates in order of the water refrigerant heat exchanger 13, the heating expansion valve 14a that is fully opened, the outdoor heat exchanger 15, the cooling expansion valve 14c, the chiller 20, the accumulator 23, and the suction port of the compressor 11.

For this reason, in the heat pump cycle 10 in the cooling mode, a vapor compression refrigeration cycle is configured in which the outdoor heat exchanger 15 is caused to function as a condenser and the chiller 20 is caused to function as an evaporator. In the cooling mode, the opening degree SW of the air mix door 34=0% is set. For this reason, when the temperature of the high-temperature side heat medium becomes equal to the temperature of the refrigerant, heat exchange between the refrigerant and the high-temperature side heat medium is no longer performed in the water refrigerant heat exchanger 13.

At the outdoor heat exchanger 15, the heat of the refrigerant is dissipated to the outside air. At the chiller 20, the low-temperature side heat medium is cooled by the refrigerant absorbing heat from the low-temperature side heat medium.

In the low-temperature side heat medium circuit 50 in the cooling mode, similarly to the cooling air conditioning mode, the cooled low-temperature side heat medium flows through the cooling water passage 70a of the battery 70, whereby the battery 70 is cooled.

### (12) Ventilation Mode

In the ventilation mode, the control device 60 stops the compressor 11. The control device 60 operates the indoor blower 32 according to a setting signal set by the air volume setting switch.

In the indoor air conditioning unit 30 in the ventilation mode, the ventilation air blown from the indoor blower 32 is blown indoor.

As described above, by switching the various operation modes, the vehicle air conditioner 1 of the present embodiment can achieve comfortable air conditioning in the vehicle interior while appropriately adjusting the temperature of the battery 70.

Furthermore, the vehicle air conditioner 1 of the present embodiment can continuously adjust a temperature of ventilation air in a wide range while suppressing a decrease in operation efficiency when performing dehumidification heating of the vehicle interior. More specifically, the vehicle air conditioner 1 of the present embodiment has, as the dehumidification heating mode, the (2) series dehumidification heating mode and the (3-1) HG dehumidification heating mode.

In the heat pump cycle 10 in the series dehumidification heating mode, by changing the opening degree pattern KPN1, the pressure of the refrigerant in the outdoor heat exchanger 15 can be changed while maintaining the refrigerant evaporation temperature at the indoor evaporator 18 at a temperature at which frost formation at the indoor evaporator 18 can be suppressed.

Accordingly, in the series dehumidification heating mode, it is possible to adjust the heat exchange amount between the refrigerant and the outside air in the outdoor heat exchanger 15 while suppressing frost formation at the indoor evaporator 18. Therefore, by adjusting the heat dissipation amount from the refrigerant to the high-temperature side heat medium in the water refrigerant heat exchanger 13, it is possible to continuously adjust the heating capability of the ventilation air at the heater core 42.

In the heat pump cycle 10 in the HG dehumidification heating mode, by increasing the refrigerant discharge capability of the compressor 11, it is possible to improve the heating capability of the ventilation air at the heater core 42 more than the series dehumidification heating mode while suppressing frost formation of the indoor evaporator 18.

Furthermore, in the heat pump cycle 10 in the HG dehumidification heating mode, an increase amount of the compression work amount when the refrigerant discharge capability of the compressor 11 is increased can be effectively used as a heating source of the ventilation air. Therefore, when the heating capability of the ventilation air at the heating portion is improved, a decrease in operation efficiency can be suppressed.

As a result, the vehicle air conditioner 1 of the present embodiment can continuously adjust the temperature of ventilation air in a wide range while suppressing a decrease in operation efficiency by switching between the series dehumidification heating mode and the HG dehumidification heating mode when performing dehumidification heating of the vehicle interior.

The vehicle air conditioner 1 of the present embodiment can switch from the HG dehumidification heating mode to the series dehumidification heating mode when the target blowing temperature TAO is lower than the dehumidification reference temperature β1 as illustrated in step S90 of FIG. 3. When the target blowing temperature TAO is equal to or greater than the dehumidification reference temperature β1, it is possible to switch the mode from the series dehumidification heating mode to the HG dehumidification heating mode.

Accordingly, the HG dehumidification heating mode and the series dehumidification heating mode can be reliably switched by simple control.

The vehicle air conditioner 1 of the present embodiment has the (3-2) outside air endothermic HG dehumidification heating mode as the dehumidification heating mode. In the outside air endothermic HG dehumidification heating mode, the ventilation air can be heated using the heat of the outside air. Therefore, by decreasing the power consumption of the compressor 11 more than that in the HG dehumidification heating mode, a decrease in operation efficiency can be further suppressed.

The vehicle air conditioner 1 of the present embodiment employs the target evaporator temperature TEO as the outdoor unit temperature Tout as described with reference to steps S140 and S170 of FIG. 5 and FIG. 11. When the outdoor unit temperature difference ΔTO becomes equal to or greater than the first reference temperature difference KΔTO1, the mode is switched from the HG dehumidification heating mode to the outside air endothermic HG dehumidification heating mode.

Accordingly, when the temperature of the refrigerant flowing into the outdoor heat exchanger 15 is lower than the outside air temperature Tam, it is possible to switch from the HG dehumidification heating mode to the outside air endothermic HG dehumidification heating mode. That is, when the refrigerant can reliably absorb heat of the outside air at the outdoor heat exchanger 15, the mode can be switched from the HG dehumidification heating mode to the outside air endothermic HG dehumidification heating mode.

Similarly, when the outdoor unit temperature difference ΔTO becomes equal to or greater than the first reference temperature difference KΔTO1, the mode is switched from the cooling HG dehumidification heating mode to the cooling outside air endothermic HG dehumidification heating mode. Accordingly, when the refrigerant can reliably absorb heat of the outside air at the outdoor heat exchanger 15, the mode can be switched from the cooling HG dehumidification heating mode to the cooling outside air endothermic HG dehumidification heating mode.

The vehicle air conditioner 1 of the present embodiment has, as the dehumidification heating mode, the (6) cooling series dehumidification heating mode and the (7-1) cooling HG dehumidification heating mode.

Therefore, the vehicle air conditioner 1 of the present embodiment can continuously adjust the temperature of ventilation air in a wide range while suppressing a decrease in operation efficiency simultaneously with cooling of the battery 70 by switching between the cooling series dehumidification heating mode and the cooling HG dehumidification heating mode when performing dehumidification heating of the vehicle interior.

The vehicle air conditioner 1 of the present embodiment can continuously adjust the temperature of ventilation air in a wide range while suppressing a decrease in operation efficiency when performing heating the vehicle interior. More specifically, the vehicle air conditioner 1 of the present embodiment has, as the dehumidification heating mode, the (4-1) outside air endothermic heating mode and the (4-2) HG heating mode.

In the heat pump cycle 10 in the heating mode, by adjusting at least one of the refrigerant discharge capability of the compressor 11 and the throttle opening degree of the heating expansion valve 14a, it is possible to adjust the heat dissipation amount from the refrigerant at the water refrigerant heat exchanger 13 to the high-temperature side heat medium. Therefore, it is possible to continuously adjust the heating capability of the ventilation air at the heater core 42.

In the heat pump cycle 10 in the HG heating mode, by increasing the refrigerant discharge capability of the compressor 11, it is possible to improve the heating capability of the ventilation air at the heater core 42 more than that in the heating mode.

Furthermore, in the heat pump cycle 10 in the HG heating mode, an increase amount of the compression work amount when the refrigerant discharge capability of the compressor 11 is increased can be effectively used as a heating source of the ventilation air. Therefore, when the heating capability of the ventilation air at the heating portion is improved, a decrease in operation efficiency can be suppressed.

As a result, the vehicle air conditioner 1 of the present embodiment can continuously adjust the temperature of ventilation air in a wide range while suppressing a decrease in operation efficiency by switching between the outside air endothermic heating mode and the HG heating mode when performing heating the vehicle interior.

In the vehicle air conditioner 1 of the present embodiment, as shown in step S240 of FIG. 6, when the target blowing temperature TAO is lower than the hot gas reference temperature δ, it is possible to switch from the HG heating mode to the outside air endothermic heating mode. When the target blowing temperature TAO is equal to or greater than the hot gas reference temperature δ, it is possible to switch the mode from the outside air endothermic heating mode to the HG heating mode.

Accordingly, the outside air endothermic heating mode and the HG heating mode can be reliably switched by simple control.

In the HG heating mode, by adjusting the refrigerant discharge capability of the compressor 11, it is possible to adjust the heating capability of the heating portion in a wide range. In the outside air endothermic heating mode, since the ventilation air can be heated using the heat absorbed from the outside air by the refrigerant, the operation efficiency can be improved more easily than that in the HG heating mode. Therefore, reliably switchable from the HG heating mode to the outside air endothermic heating mode is valid to suppress a decrease in operation efficiency.

The vehicle air conditioner 1 of the present embodiment employs the saturation temperature of the refrigerant at the target low pressure PSO as the outdoor unit temperature Tout as described with reference to step S340. When the outdoor unit temperature difference ΔTO becomes equal to or greater than the first reference temperature difference KΔTO1, the mode is switched from the cooling HG heating mode to the cooling outside air endothermic HG heating mode.

Accordingly, when the temperature of the refrigerant flowing into the outdoor heat exchanger 15 is lower than the outside air temperature Tam, it is possible to switch from the cooling HG heating mode to the cooling outside air endothermic HG heating mode. That is, when the refrigerant can reliably absorb heat of the outside air at the outdoor heat exchanger 15, the mode can be switched from the cooling HG heating mode to the cooling outside air endothermic HG heating mode.

The vehicle air conditioner 1 of the present embodiment has the (9) cooling outside air endothermic heating mode and the (10-1) cooling HG heating mode as the heating modes.

Therefore, the vehicle air conditioner 1 of the present embodiment can continuously adjust the temperature of ventilation air in a wide range while suppressing a decrease in operation efficiency simultaneously with cooling of the battery 70 by switching between the cooling outside air endothermic heating mode and the cooling HG heating mode when performing heating of the vehicle interior.

### Second Embodiment

In the present embodiment, an example in which a control aspect related to switching of an operation mode in a control program is changed from the first embodiment will be described.

In the control program of the present embodiment, an initial operation mode is selected similarly to the control flow of FIGS. 3 to 12 of the first embodiment. Thereafter, a control routine such as reading of the detection signal and the operation signal, calculation of the target blowing temperature TAO, selection of the operation mode based on the operation mode currently selected, and control of various pieces of equipment to be controlled according to the operation mode is repeated every predetermined control cycle.

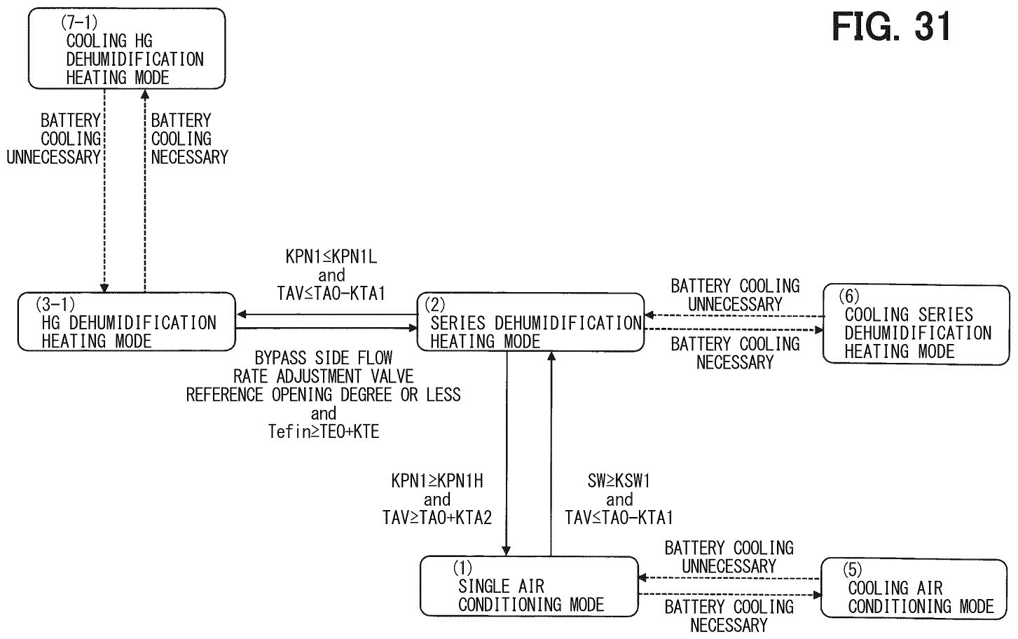

First, selection of the operation mode when the currently selected operation mode is the (1) single air conditioning mode will be described with reference to FIG. 31.

If it is determined that the heating capability of the ventilation air is insufficient when the currently selected operation mode is the (1) single air conditioning mode, the (2) series dehumidification heating mode is selected.

Specifically, during execution of the (1) single air conditioning mode, when the opening degree SW of the air mix door 34 is equal to or greater than a reference upper limit opening degree KSW1 (in the present embodiment, 95%) and the ventilation air temperature TAV is equal to or less than a value in which a predetermined insufficiency determination reference value KTA1 is subtracted from the target blowing temperature TAO, it is determined that the heating capability of the ventilation air is insufficient. Then, the (2) series dehumidification heating mode is selected. The insufficiency determination reference value KTA1 is a positive value. In the present embodiment, the insufficiency determination reference value KTA1 is set to 3° C.

Next, selection of the operation mode when the currently selected operation mode is the (2) series dehumidification heating mode will be described.

If it is determined that the heating capability of the ventilation air is excessive when the currently selected operation mode is the (2) series dehumidification heating mode, the (1) single air conditioning mode is selected.

Specifically, during execution of the (2) series dehumidification heating mode, when the opening degree pattern KPN1 is equal to or greater than a reference upper limit opening degree pattern KPN1H and the ventilation air temperature TAV is equal to or greater than a value in which a predetermined excess determination reference value KTA2 is added to the target blowing temperature TAO, it is determined that the heating capability of the ventilation air is excessive. Then, the (1) single air conditioning mode is selected. The excess determination reference value KTA2 is a positive value. In the present embodiment, the excess determination reference value KTA2 is set to 3° C.

If it is determined that the heating capability of the ventilation air is insufficient when the currently selected operation mode is the (2) series dehumidification heating mode, the (3-1) HG dehumidification heating mode is selected.

Specifically, during execution of the (2) series dehumidification heating mode, when the opening degree pattern KPN1 is equal to or less than a reference lower limit opening degree pattern KPN1L and the ventilation air temperature TAV is equal to or less than a value in which the insufficiency determination reference value KTA1 is subtracted from the target blowing temperature TAO, it is determined that the heating capability of the ventilation air is insufficient, and the (3-1) HG dehumidification heating mode is selected.

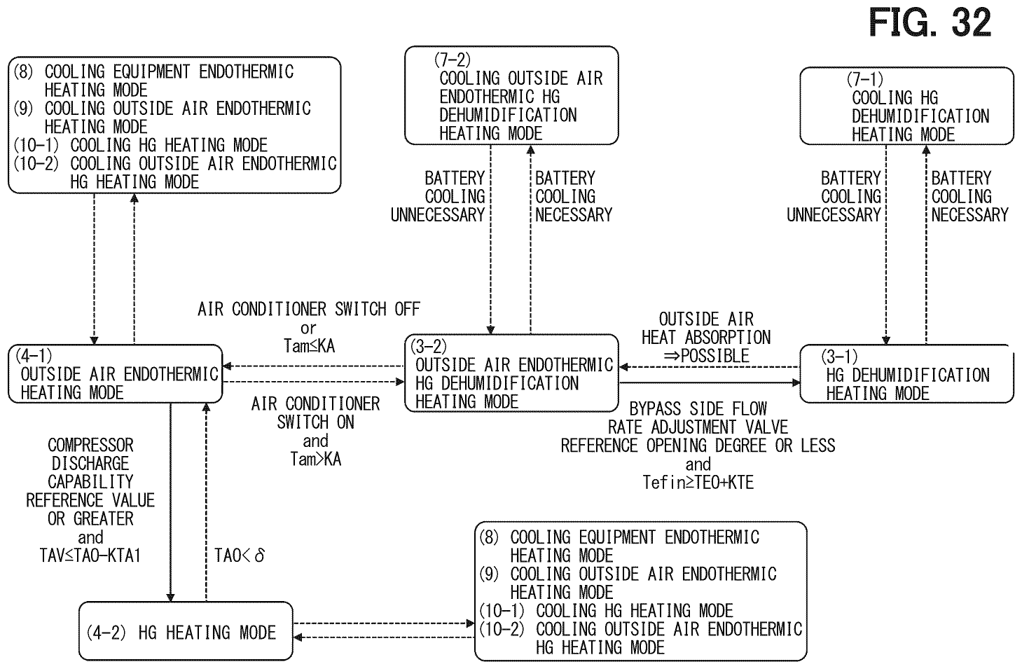

Next, selection of the operation mode when the currently selected operation mode is the (3-1) HG dehumidification heating mode will be described with reference to FIGS. 31 and 32.

If it is determined that the dehumidification capability of the ventilation air is insufficient, when the currently selected operation mode is the (3-1) HG dehumidification heating mode, the (2) series dehumidification heating mode is selected.

Specifically, during execution of the (3-1) HG dehumidification heating mode, when the opening degree of the bypass side flow rate adjustment valve 14d is equal to or less than the reference opening degree and the evaporator temperature Tefin is equal to or greater than a value in which a predetermined dehumidification determination reference value KTE is added to the target evaporator temperature TEO, it is determined that the dehumidification capability of the ventilation air is insufficient. Then, the (2) series dehumidification heating mode is selected.

The dehumidification determination reference value KTE is a positive value. In the present embodiment, the dehumidification determination reference value KTE is set to 3° C. As the reference opening degree of the bypass side flow rate adjustment valve 14d, the minimum opening degree that can be achieved by the control of the bypass side flow rate adjustment valve 14d may be employed.

In a case where the operation mode currently selected is the (3-1) HG dehumidification heating mode, as described in step S170 of the first embodiment, when it is determined that outside air heat absorption is possible, the (3-2) outside air endothermic HG dehumidification heating mode is selected.

Next, selection of the operation mode when the currently selected operation mode is the (3-2) outside air endothermic HG dehumidification heating mode will be described with reference to FIG. 32.

If it is determined that the dehumidification capability of the ventilation air is insufficient, when the currently selected operation mode is the (3-2) outside air endothermic HG dehumidification heating mode, the (3-1) HG dehumidification heating mode is selected.

Specifically, during execution of the (3-2) outside air endothermic HG dehumidification heating mode, when the opening degree of the bypass side flow rate adjustment valve 14d is equal to or less than the reference opening degree and the evaporator temperature Tefin is equal to or greater than a value in which the dehumidification determination reference value KTE is added to the target evaporator temperature TEO, it is determined that the dehumidification capability of the ventilation air is insufficient. Then, the (3-1) HG dehumidification heating mode is selected.

In a case where the currently selected operation mode is the (3-2) outside air endothermic HG dehumidification heating mode, when the indoor evaporator 18 determines that cooling of the ventilation air is not necessary as described in steps S30 and S40 of the first embodiment, the (4-1) outside air endothermic heating mode is selected.

Next, selection of the operation mode when the currently selected operation mode is the (4-1) outside air endothermic heating mode will be described.

In a case where the currently selected operation mode is the (4-1) outside air endothermic heating mode, when the indoor evaporator 18 determines that cooling of the ventilation air is necessary as described in steps S30 and S40 of the first embodiment, the (3-2) outside air endothermic HG dehumidification heating mode is selected.

In a case where the currently selected operation mode is the (4-1) outside air endothermic heating mode, when it is determined that the heating capability of the ventilation air is insufficient, the (4-2) HG heating mode is selected.

Specifically, during execution of the (4-1) outside air endothermic heating mode, when the refrigerant discharge capability (specifically, rotation speed) of the compressor 11 is equal to or greater than a reference value and the ventilation air temperature TAV is equal to or less than a value in which the insufficiency determination reference value KTA1 is subtracted from the target blowing temperature TAO, it is determined that the heating capability of the ventilation air is insufficient. Then, the (4-2) HG heating mode is selected.

As the reference value (specifically, a reference rotational speed) of the compressor 11, the maximum rotation speed determined from the durability or the like of the compressor 11 may be employed.

Next, in a case where the currently selected operation mode is the (4-2) HG heating mode, as described in step S240 of the first embodiment, when the target blowing temperature TAO is lower than the hot gas reference temperature δ, the (4-1) outside air endothermic heating mode is selected.

Other control aspects related to the switching of the operation mode are similar to those in the first embodiment. Here, in FIGS. 31 and 32, regarding the control aspect related to switching of the operation mode, sites similar to those in the first embodiment are indicated by broken line arrows. Other configurations and operations of the vehicle air conditioner 1 are similar to those of the first embodiment.

Since the vehicle air conditioner 1 of the present embodiment detects the heating capability and the defrosting capability of the ventilation air to switch the operation mode, it is possible to achieve more comfortable air conditioning in the vehicle interior.

Specifically, during execution of the series dehumidification heating mode, when the ventilation air temperature TAV is equal to or less than a value in which the insufficiency determination reference value KTA1 is subtracted from the target blowing temperature TAO, the mode is switched to the HG dehumidification heating mode. In other words, when at least the ventilation air temperature TAV is lower than the target blowing temperature TAO, the mode is switched from the series dehumidification heating mode to the HG dehumidification heating mode.

This can reliably detect that the heating capability of the ventilation air is insufficient during the execution of the series dehumidification heating mode and to switch to the HG dehumidification heating mode having a higher heating capability of the ventilation air than that in the series dehumidification heating mode.

During execution of the HG dehumidification heating mode, when the evaporator temperature Tefin becomes equal to or greater than a value in which the dehumidification determination reference value KTE is added to the target evaporator temperature TEO, the mode is switched to the series dehumidification heating mode. In other words, at least when the evaporator temperature Tefin is higher than the target evaporator temperature TEO, the mode is switched from the HG dehumidification heating mode to the series dehumidification heating mode.

This can reliably detect that the dehumidification capability of the ventilation air is insufficient during the execution of the HG dehumidification heating mode and to switch to the series dehumidification heating mode having a higher dehumidification capability of the ventilation air than that in the HG dehumidification heating mode.

During execution of the outside air endothermic HG dehumidification heating mode, when the evaporator temperature Tefin becomes equal to or greater than a value in which the dehumidification determination reference value KTE is added to the target evaporator temperature TEO, the mode is switched to the HG dehumidification heating mode. In other words, at least when the evaporator temperature Tefin is higher than the target evaporator temperature TEO, the mode is switched from the outside air endothermic HG dehumidification heating mode to the HG dehumidification heating mode.

This can reliably detect that the dehumidification capability of the ventilation air is insufficient during the execution of the outside air endothermic HG dehumidification heating mode and to switch to the HG dehumidification heating mode having a higher dehumidification capability of the ventilation air than that in the outside air endothermic HG dehumidification heating mode.

During execution of the outside air endothermic heating mode, when the ventilation air temperature TAV is equal to or less than a value in which the insufficiency determination reference value KTA1 is subtracted from the target blowing temperature TAO, the mode is switched to the HG heating mode. In other words, when at least the ventilation air temperature TAV is lower than the target blowing temperature TAO, the mode is switched from the outside air endothermic heating mode to the HG heating mode.

This can reliably detect that the heating capability of the ventilation air is insufficient during the execution of the outside air endothermic heating mode and to switch to the HG heating mode having a higher dehumidification capability of the ventilation air than that in the outside air endothermic heating mode.

The control aspect when switching from the (1) single air conditioning mode to the (2) series dehumidification heating mode described in the present embodiment may be applied to when switching from the (5) cooling air conditioning mode to the (6) cooling series dehumidification heating mode. Furthermore, the control aspect when switching from the (2) series dehumidification heating mode to the (1) single air conditioning mode may be applied to when switching from the (6) cooling series dehumidification heating mode to the (5) cooling air conditioning mode.

The control aspect when switching from the (2) series dehumidification heating mode is switched to the (3-1) HG dehumidification heating mode described in the present embodiment may be applied to when switching from the (6) cooling series dehumidification heating mode to the (7-1) cooling HG dehumidification heating mode. The control aspect when switching from the (3-1) HG dehumidification heating mode to the (2) series dehumidification heating mode may be applied to when switching from the (7-1) cooling HG dehumidification heating mode to the (6) cooling series dehumidification heating mode.

The control aspect when switching from the (3-1) HG dehumidification heating mode to the (3-2) outside air endothermic HG dehumidification heating mode described in the present embodiment may be applied to when switching from the (7-1) cooling HG dehumidification heating mode to the (7-2) cooling outside air endothermic HG dehumidification heating mode.

### Third Embodiment

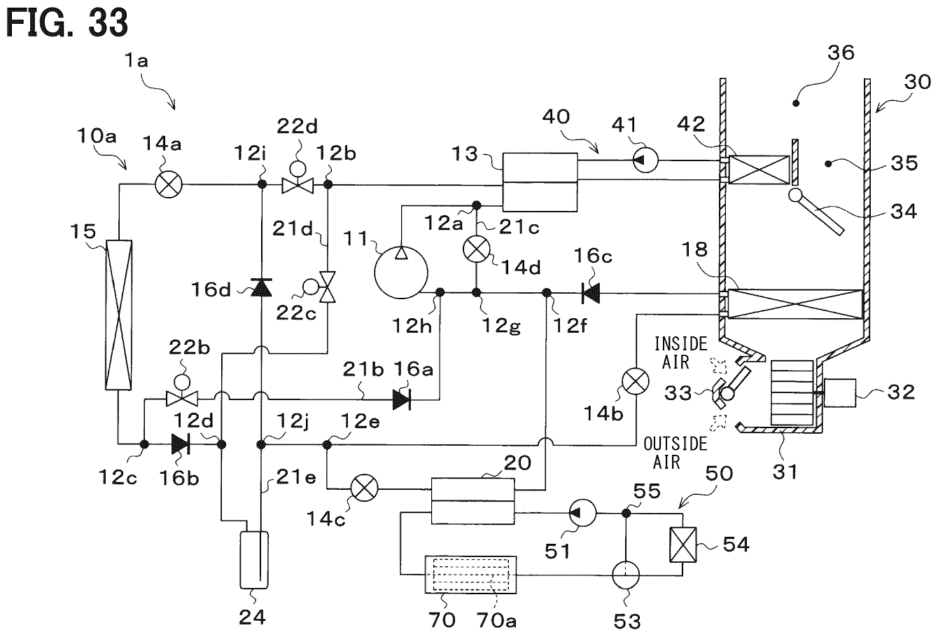

In the present embodiment, an example in which the refrigeration cycle device according to the present disclosure is applied to a vehicle air conditioner 1a illustrated in the overall configuration diagram of FIG. 33 will be described. The vehicle air conditioner 1a includes a heat pump cycle 10a. For clarity of illustration, FIG. 33 omits illustration of the control sensor group.

For the heat pump cycle 10 described in the first embodiment, the heat pump cycle 10a eliminates the accumulator 23 and the like and employs the receiver 24 and the like.

In the heat pump cycle 10a, the inlet side of the receiver 24 is connected to the other outflow port of the second three-way joint 12b. The refrigerant passage from the other outflow port of the second three-way joint 12b to the inlet of the receiver 24 is an inlet side passage 21d. In the inlet side passage 21d, a first inlet side on-off valve 22c and the fourth three-way joint 12d are disposed.

The receiver 24 is a high-pressure side gas-liquid separation unit that separates gas and liquid of the refrigerant flowing inside, and stores the separated liquid phase refrigerant as a surplus refrigerant of the cycle. The receiver 24 causes a part of the separated liquid phase refrigerant to flow out to the downstream side from the liquid phase refrigerant outlet.

The first inlet side on-off valve 22c is an on-off valve that opens and closes the inlet side passage 21d. More specifically, the first inlet side on-off valve 22c opens and closes the refrigerant passage from the other outflow port of the second three-way joint 12b to one inflow port of the seventh three-way joint 12g in the inlet side passage 21d. The first inlet side on-off valve 22c is a refrigerant circuit switching portion.

One inflow port side of the ninth three-way joint 12i is connected to one outflow port of the second three-way joint 12b. A second inlet side on-off valve 22d is disposed in the refrigerant passage from one outflow port of the second three-way joint 12b to one inflow port of the ninth three-way joint 12i. The second inlet side on-off valve 22d opens and closes the refrigerant passage from one outflow port of the second three-way joint 12b to one inflow port of the eighth three-way joint 12h. The second inlet side on-off valve 22d is a refrigerant circuit switching portion.

The basic configurations of the first inlet side on-off valve 22c and the second inlet side on-off valve 22d are similar to those of the high-pressure side on-off valve 22a described in the first embodiment.

The other inflow port side of the ninth three-way joint 12i is connected to the liquid phase refrigerant outlet of the receiver 24. The refrigerant passage from the outlet of the receiver 24 to the other inflow port of the ninth three-way joint 12i is an outlet side passage 21e. A tenth three-way joint 12j and a fourth check valve 16d are disposed in the outlet side passage 21e.

The fourth check valve 16d permits the refrigerant to flow from the tenth three-way joint 12j side to the ninth three-way joint 12i side, and prohibits the refrigerant from flowing from the ninth three-way joint 12i side to the tenth three-way joint 12j side. The inflow port side of the fifth three-way joint 12e is connected to the other outflow port of the tenth three-way joint 12j. Other configurations of the vehicle air conditioner 1a are similar to those of the vehicle air conditioner 1 described in the first embodiment.

Next, the operation of the vehicle air conditioner 1a of the present embodiment in the above configuration will be described. In the vehicle air conditioner 1a of the present embodiment, various operation modes can be switched similarly to the first embodiment in order to perform air conditioning in the vehicle interior and temperature adjustment of the battery 70. The detailed operation of each operation mode will be described below.

### (1) Single Air Conditioning Mode

In the heat pump cycle 10a in the single air conditioning mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full open state, the air conditioning expansion valve 14b is brought into a throttle state, the cooling expansion valve 14c is brought into a full close state, and the bypass side flow rate adjustment valve 14d is brought into a full close state.

The control device 60 determines the control voltages to be output to the low-pressure side on-off valve 22b, the first inlet side on-off valve 22c, and the second inlet side on-off valve 22d so as to close the low-pressure side on-off valve 22b, close the first inlet side on-off valve 22c, and open the second inlet side on-off valve 22d.

The control device 60 determines the operation state of the air conditioning expansion valve 14b such that the superheating degree SH of the sucked refrigerant to be sucked into the compressor 11 approaches a predetermined reference superheating degree KSH (in the present embodiment, 5° C.).

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the single air conditioning mode, the refrigerant circuit is switched to the refrigerant circuit in which the refrigerant discharged from the compressor 11 circulates in order of the water refrigerant heat exchanger 13, the heating expansion valve 14a in the fully opened state, the outdoor heat exchanger 15, the receiver 24, the air conditioning expansion valve 14b, the indoor evaporator 18, and the suction port of the compressor 11.

For this reason, in the heat pump cycle 10a in the single air conditioning mode, a vapor compression refrigeration cycle is configured in which the water refrigerant heat exchanger 13 and the outdoor heat exchanger 15 are caused to function as a condenser and the indoor evaporator 18 is caused to function as an evaporator.

In the high-temperature side heat medium circuit 40 in the single air conditioning mode, the high-temperature side heat medium heated by the water refrigerant heat exchanger 13 flows into the heater core 42, similarly to the first embodiment. In the indoor air conditioning unit 30 in the single air conditioning mode, the conditioned air whose temperature has been adjusted is blown to the vehicle interior, similarly to the first embodiment. This achieves air conditioning of the vehicle interior.

### (2) Series Dehumidification Heating Mode

In the heat pump cycle 10a in the series dehumidification heating mode, the control device 60 determines the control signals to be output to the heating expansion and the bypass side flow rate adjustment valve 14d such that the heating expansion valve 14a is brought into a throttle state, the air conditioning expansion valve 14b is brought into a throttle state, the cooling expansion valve 14c is brought into a full close state, and the bypass side flow rate adjustment valve 14d is brought into a full close state.

The control device 60 determines the control voltages to be output to the low-pressure side on-off valve 22b, the first inlet side on-off valve 22c, and the second inlet side on-off valve 22d so as to close the low-pressure side on-off valve 22b, close the first inlet side on-off valve 22c, and open the second inlet side on-off valve 22d.

The control device 60 determines the operation states of the heating expansion valve 14a and the air conditioning expansion valve 14b such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the series dehumidification heating mode, the refrigerant circuit is switched to the refrigerant circuit in which the refrigerant discharged from the compressor 11 circulates in order of the water refrigerant heat exchanger 13, the heating expansion valve 14a, the outdoor heat exchanger 15, the receiver 24, the air conditioning expansion valve 14b, the indoor evaporator 18, and the suction port of the compressor 11.

For this reason, in the heat pump cycle 10a in the series dehumidification heating mode, a vapor compression refrigeration cycle is configured in which the water refrigerant heat exchanger 13 and the outdoor heat exchanger 15 are caused to function as a condenser and the indoor evaporator 18 is caused to function as an evaporator.

The high-temperature side heat medium circuit 40 and the indoor air conditioning unit 30 in the series dehumidification heating mode operate similarly to the single air conditioning mode of the first embodiment.

In the high-temperature side heat medium circuit 40 in the series dehumidification heating mode, the high-temperature side heat medium heated by the water refrigerant heat exchanger 13 flows into the heater core 42, similarly to the first embodiment. In the indoor air conditioning unit 30 in the series dehumidification heating mode, the conditioned air dehumidified and temperature-adjusted is blown to the vehicle interior, similarly to the first embodiment. This achieves dehumidification heating of the vehicle interior.

Here, the heat pump cycle 10a includes the receiver 24. Therefore, the series dehumidification heating mode is executed in a temperature range in which the saturation temperature of the refrigerant at the outdoor heat exchanger 15 is higher than the outside air temperature Tam.

### (3-1) HG Dehumidification Heating Mode

In the heat pump cycle 10a in the HG dehumidification heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full close state, the air conditioning expansion valve 14b is brought into a throttle state, the cooling expansion valve 14c is brought into a throttle state, and the bypass side flow rate adjustment valve 14d is brought into a throttle state.

The control device 60 determines the control voltages to be output to the low-pressure side on-off valve 22b, the first inlet side on-off valve 22c, and the second inlet side on-off valve 22d so as to close the low-pressure side on-off valve 22b, open the first inlet side on-off valve 22c, and close the second inlet side on-off valve 22d.

The control device 60 determines the operation states of the compressor 11, the air conditioning expansion valve 14b, the cooling expansion valve 14c, and the bypass side flow rate adjustment valve 14d such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

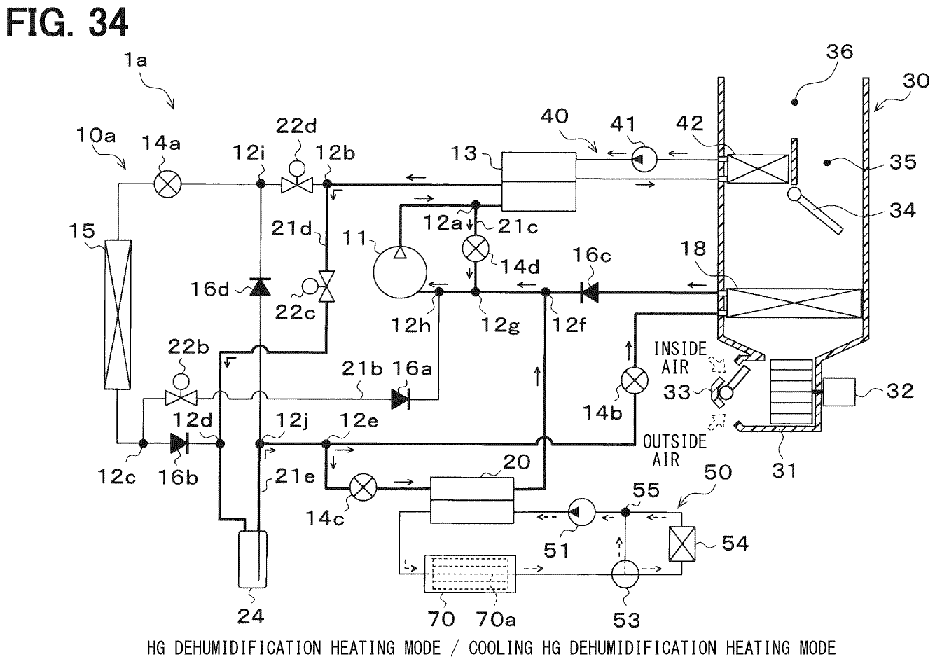

Therefore, in the heat pump cycle 10a in the HG dehumidification heating mode, as indicated by the solid arrows in FIG. 34, the refrigerant discharged from the compressor 11 circulates in order of the first three-way joint 12a, the water refrigerant heat exchanger 13, the inlet side passage 21d, the receiver 24, the fifth three-way joint 12e, the air conditioning expansion valve 14b, the indoor evaporator 18, the sixth three-way joint 12f, the seventh three-way joint 12g, and the suction port of the compressor 11. Furthermore, the refrigerant discharged from the compressor 11 circulates in order of the first three-way joint 12a, the water refrigerant heat exchanger 13, the inlet side passage 21d, the receiver 24, the fifth three-way joint 12e, the cooling expansion valve 14c, the chiller 20, the sixth three-way joint 12f, the seventh three-way joint 12g, and the suction port of the compressor 11. At the same time, the refrigerant circuit is switched to the refrigerant circuit in which the refrigerant discharged from the compressor 11 circulates in order of the first three-way joint 12a, the bypass side flow rate adjustment valve 14d disposed in the bypass passage 21c, the seventh three-way joint 12g, and the suction port of the compressor 11.

For this reason, in the heat pump cycle 10a in the HG dehumidification heating mode, the high-temperature side heat medium is heated at the water refrigerant heat exchanger 13, similarly to the first embodiment. The ventilation air is cooled at the indoor evaporator 18.

In the high-temperature side heat medium circuit 40 in the HG dehumidification heating mode, the high-temperature side heat medium heated by the water refrigerant heat exchanger 13 flows into the heater core 42, similarly to the first embodiment.

In the low-temperature side heat medium circuit 50 in the HG dehumidification heating mode, the refrigerant and the low-temperature side heating medium do not exchange heat at the chiller 20, similarly to the first embodiment.

In the indoor air conditioning unit 30 in the HG dehumidification heating mode, the conditioned air whose temperature has been adjusted is blown to the vehicle interior, similarly to the first embodiment. This achieves heating of the vehicle interior.

In the HG dehumidification heating mode, similarly to the first embodiment, the heating capability of the ventilation air at the heating portion can be improved more than the series dehumidification heating mode.

### (3-2) Outside Air Endothermic HG Dehumidification Heating Mode

In the heat pump cycle 10a in the outside air endothermic HG dehumidification heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a throttle state, the cooling expansion valve 14c is brought into a throttle state, and the bypass side flow rate adjustment valve 14d is brought into a throttle state.

The control device 60 determines the control voltages to be output to the low-pressure side on-off valve 22b, the first inlet side on-off valve 22c, and the second inlet side on-off valve 22d so as to open the low-pressure side on-off valve 22b, open the first inlet side on-off valve 22c, and close the second inlet side on-off valve 22d.

The control device 60 determines the operation states of the compressor 11, the heating expansion valve 14a, the air conditioning expansion valve 14b, and the cooling expansion valve 14c such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

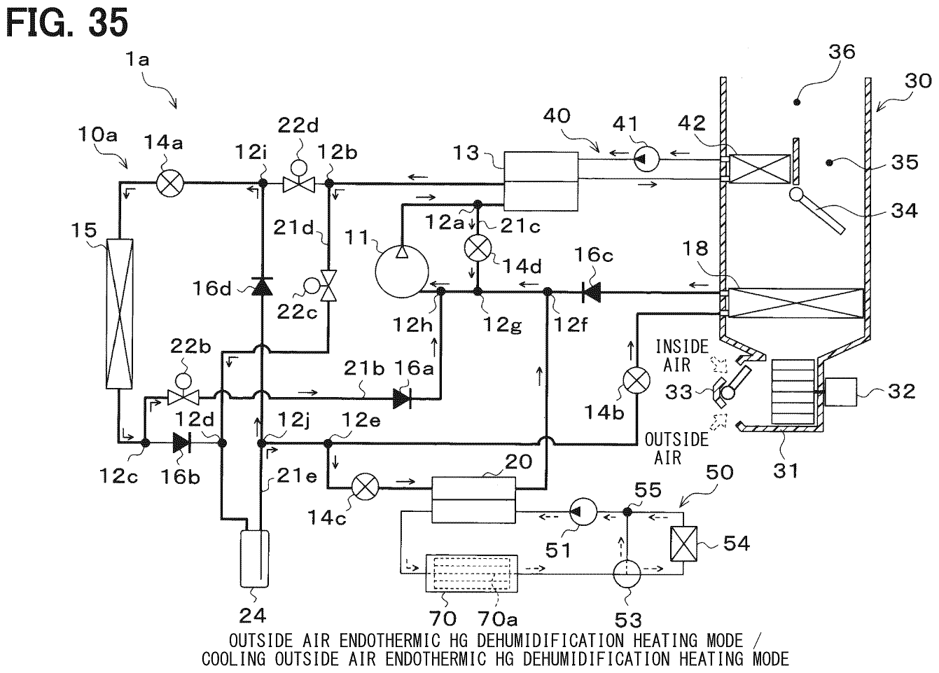

Therefore, in the heat pump cycle 10a in the outside air endothermic HG dehumidification heating mode, as indicated by the solid arrows in FIG. 35, the refrigerant discharged from the compressor 11 flows similarly to the HG dehumidification heating mode. Furthermore, the refrigerant circuit is switched to the refrigerant circuit in which the refrigerant discharged from the compressor 11 circulates in order of the first three-way joint 12a, the water refrigerant heat exchanger 13, the inlet side passage 21d, the receiver 24, the outlet side passage 21e, the heating expansion valve 14a, the outdoor heat exchanger 15, the low-pressure side passage 21b, the eighth three-way joint 12h, and the suction port of the compressor 11.

For this reason, in the heat pump cycle 10a in the outside air endothermic HG dehumidification heating mode, the high-temperature side heat medium is heated at the water refrigerant heat exchanger 13, similarly to the first embodiment. The ventilation air is cooled at the indoor evaporator 18. The refrigerant absorbs heat from outside air at the outdoor heat exchanger 15.

In the high-temperature side heat medium circuit 40 in the outside air endothermic HG dehumidification heating mode, the high-temperature side heat medium heated by the water refrigerant heat exchanger 13 flows into the heater core 42, similarly to the first embodiment.

In the low-temperature side heat medium circuit 50 in the outside air endothermic HG dehumidification heating mode, the refrigerant and the low-temperature side heating medium do not exchange heat at the chiller 20, similarly to the first embodiment.

In the indoor air conditioning unit 30 in the outside air endothermic HG dehumidification heating mode, the conditioned air whose temperature has been adjusted is blown to the vehicle interior, similarly to the first embodiment. This achieves heating of the vehicle interior.

In the outside air endothermic HG dehumidification heating mode, similarly to the first embodiment, the heating capability of the ventilation air at the heating portion can be improved more than the series dehumidification heating mode. Furthermore, in the outside air endothermic HG dehumidification heating mode, similarly to the first embodiment, the operation efficiency of the heat pump cycle 10a can be improved more than that in the HG dehumidification heating mode.

### (4-1) Outside Air Endothermic Heating Mode

In the heat pump cycle 10a in the outside air endothermic heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a full close state, the cooling expansion valve 14c is brought into a full close state, and the bypass side flow rate adjustment valve 14d is brought into a full close state.

The control device 60 determines the control voltages to be output to the low-pressure side on-off valve 22b, the first inlet side on-off valve 22c, and the second inlet side on-off valve 22d so as to open the low-pressure side on-off valve 22b, open the first inlet side on-off valve 22c, and close the second inlet side on-off valve 22d.

The control device 60 determines the operation state of the heating expansion valve 14a such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the outside air endothermic heating mode, the refrigerant circuit is switched to the refrigerant circuit in which the refrigerant discharged from the compressor 11 circulates in order of the water refrigerant heat exchanger 13, the inlet side passage 21d, the receiver 24, the outlet side passage 21e, the heating expansion valve 14a, the outdoor heat exchanger 15, the low-pressure side passage 21b, and the suction port of the compressor 11.

For this reason, in the heat pump cycle 10a in the outside air endothermic heating mode, a vapor compression refrigeration cycle is configured in which the water refrigerant heat exchanger 13 is caused to function as a condenser and the outdoor heat exchanger 15 is caused to function as an evaporator.

In the high-temperature side heat medium circuit 40 in the outside air endothermic heating mode, the high-temperature side heat medium heated by the water refrigerant heat exchanger 13 flows into the heater core 42, similarly to the first embodiment. In the indoor air conditioning unit 30 in the outside air endothermic heating mode, the conditioned air whose temperature has been adjusted is blown to the vehicle interior, similarly to the first embodiment. This achieves heating of the vehicle interior.

### (4-2) HG Heating Mode

In the heat pump cycle 10a in the outside air endothermic heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full close state, the air conditioning expansion valve 14b is brought into a full close state, the cooling expansion valve 14c is brought into a throttle state, and the bypass side flow rate adjustment valve 14d is brought into a throttle state.

The control device 60 determines the control voltages to be output to the low-pressure side on-off valve 22b, the first inlet side on-off valve 22c, and the second inlet side on-off valve 22d so as to close the low-pressure side on-off valve 22b, open the first inlet side on-off valve 22c, and close the second inlet side on-off valve 22d.

The control device 60 determines the operation states of the compressor 11, the cooling expansion valve 14c, and the bypass side flow rate adjustment valve 14d such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

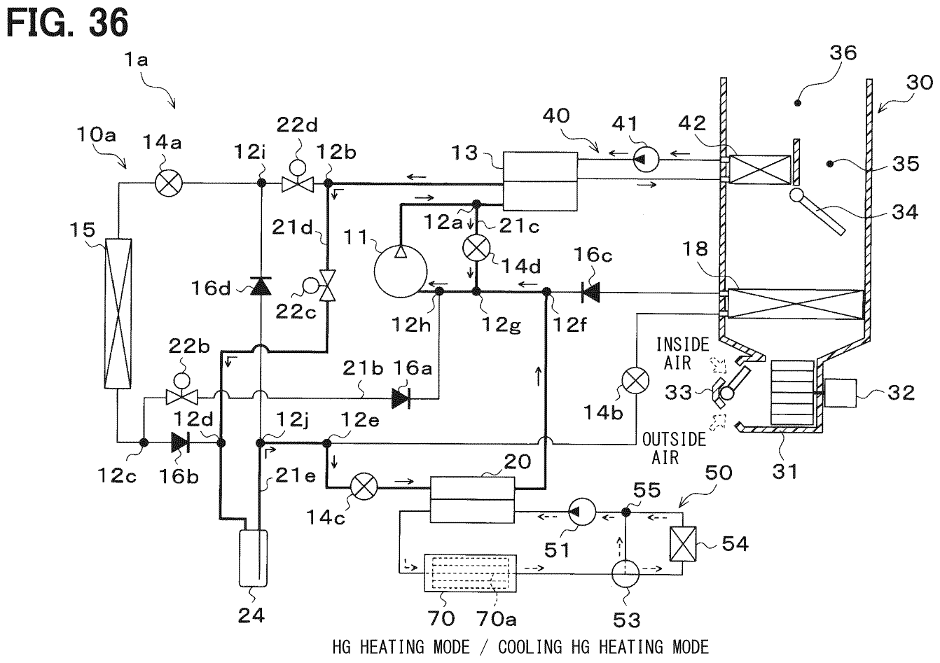

Therefore, in the heat pump cycle 10a in the HG heating mode, as indicated by the solid arrows in FIG. 36, the refrigerant discharged from the compressor 11 circulates in order of the first three-way joint 12a, the water refrigerant heat exchanger 13, the inlet side passage 21d, the receiver 24, the cooling expansion valve 14c, the chiller 20, the seventh three-way joint 12g, and the suction port of the compressor 11. At the same time, the refrigerant circuit is switched to the refrigerant circuit in which the refrigerant discharged from the compressor 11 circulates in order of the first three-way joint 12a, the bypass side flow rate adjustment valve 14d disposed in the bypass passage 21c, the seventh three-way joint 12g, and the suction port of the compressor 11.

For this reason, in the heat pump cycle 10a in the HG dehumidification heating mode, the high-temperature side heat medium is heated at the water refrigerant heat exchanger 13, similarly to the first embodiment.

In the high-temperature side heat medium circuit 40 in the HG heating mode, the high-temperature side heat medium heated by the water refrigerant heat exchanger 13 flows into the heater core 42, similarly to the first embodiment.

In the low-temperature side heat medium circuit 50 in the HG heating mode, the refrigerant and the low-temperature side heating medium do not exchange heat at the chiller 20, similarly to the first embodiment.

In the indoor air conditioning unit 30 in the HG heating mode, the conditioned air whose temperature has been adjusted is blown to the vehicle interior, similarly to the first embodiment. This achieves heating of the vehicle interior.

In the HG heating mode, similarly to the first embodiment, the heating capability of the ventilation air at the heating portion can be improved more than the outside air endothermic heating mode.

### (5) Cooling Air Conditioning Mode

In the heat pump cycle 10a in the cooling air conditioning mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full open state, the air conditioning expansion valve 14b is brought into a throttle state, the cooling expansion valve 14c is brought into a throttle state, and the bypass side flow rate adjustment valve 14d is brought into a full close state.

The control device 60 determines the control voltages to be output to the low-pressure side on-off valve 22b, the first inlet side on-off valve 22c, and the second inlet side on-off valve 22d so as to close the low-pressure side on-off valve 22b, close the first inlet side on-off valve 22c, and open the second inlet side on-off valve 22d.

The control device 60 determines the operation states of the air conditioning expansion valve 14b and the cooling expansion valve 14c such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the cooling air conditioning mode, the refrigerant discharged from the compressor 11 circulates in order of the water refrigerant heat exchanger 13, the heating expansion valve 14a in the fully opened state, the outdoor heat exchanger 15, the receiver 24, the fifth three-way joint 12e, the air conditioning expansion valve 14b, the indoor evaporator 18, and the suction port of the compressor 11. At the same time, the refrigerant circuit is switched to the refrigerant circuit in which the refrigerant discharged from the compressor 11 circulates in order of the water refrigerant heat exchanger 13, the heating expansion valve 14a that is fully opened, the outdoor heat exchanger 15, the receiver 24, the fifth three-way joint 12e, the cooling expansion valve 14c, the chiller 20, and the suction port of the compressor 11.

That is, the refrigerant circuit is switched to a refrigerant circuit in which the indoor evaporator 18 and the chiller 20 are connected in parallel to the flow of the refrigerant flowing out of the receiver 24.

For this reason, in the heat pump cycle 10a in the cooling air conditioning mode, a vapor compression refrigeration cycle is configured in which the water refrigerant heat exchanger 13 and the outdoor heat exchanger 15 are caused to function as a condenser, and the indoor evaporator 18 and the chiller 20 are caused to function as an evaporator.

In the high-temperature side heat medium circuit 40 in the cooling air conditioning mode, the high-temperature side heat medium heated by the water refrigerant heat exchanger 13 flows into the heater core 42, similarly to the first embodiment.

In the low-temperature side heat medium circuit 50 in the cooling air conditioning mode, the low-temperature side heat medium flows through the cooling water passage 70a of the battery 70, similarly to the first embodiment. Accordingly, the battery 70 is cooled.

In the indoor air conditioning unit 30 in the cooling air conditioning mode, the conditioned air whose temperature has been adjusted is blown to the vehicle interior, similarly to the first embodiment. This achieves heating of the vehicle interior.

### (6) Cooling Series Dehumidification Heating Mode

In the heat pump cycle 10a in the cooling series dehumidification heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a throttle state, the cooling expansion valve 14c is brought into a throttle state, and the bypass side flow rate adjustment valve 14d is brought into a full close state.

The control device 60 determines the control voltages to be output to the low-pressure side on-off valve 22b, the first inlet side on-off valve 22c, and the second inlet side on-off valve 22d so as to close the low-pressure side on-off valve 22b, close the first inlet side on-off valve 22c, and open the second inlet side on-off valve 22d.

The control device 60 determines the operation states of the heating expansion valve 14a, the air conditioning expansion valve 14b, and the cooling expansion valve 14c such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the cooling series dehumidification heating mode, the refrigerant discharged from the compressor 11 circulates in order of the water refrigerant heat exchanger 13, the heating expansion valve 14a, the outdoor heat exchanger 15, the receiver 24, the fifth three-way joint 12e, the air conditioning expansion valve 14b, the indoor evaporator 18, and the suction port of the compressor 11. At the same time, the refrigerant circuit is switched to the refrigerant circuit in which the refrigerant discharged from the compressor 11 circulates in order of the water refrigerant heat exchanger 13, the heating expansion valve 14a, the outdoor heat exchanger 15, the receiver 24, the fifth three-way joint 12e, the cooling expansion valve 14c, the chiller 20, and the suction port of the compressor 11.

That is, the refrigerant circuit is switched to a refrigerant circuit in which the indoor evaporator 18 and the chiller 20 are connected in parallel to the flow of the refrigerant flowing out of the receiver 24.

For this reason, in the heat pump cycle 10a in the cooling series dehumidification heating mode, a vapor compression refrigeration cycle is configured in which the water refrigerant heat exchanger 13 and the outdoor heat exchanger 15 are caused to function as a condenser, and the indoor evaporator 18 and the chiller 20 are caused to function as an evaporator.

In the high-temperature side heat medium circuit 40 in the cooling series dehumidification heating mode, the high-temperature side heat medium heated by the water refrigerant heat exchanger 13 flows into the heater core 42, similarly to the first embodiment.

In the low-temperature side heat medium circuit 50 in the cooling series dehumidification heating mode, the low-temperature side heat medium flows through the cooling water passage 70a of the battery 70, similarly to the first embodiment. Accordingly, the battery 70 is cooled.

In the indoor air conditioning unit 30 in the cooling series dehumidification heating mode, the conditioned air dehumidified and temperature-adjusted is blown to the vehicle interior, similarly to the first embodiment. This achieves dehumidification heating of the vehicle interior.

Here, the heat pump cycle 10a includes the receiver 24. Therefore, the cooling series dehumidification heating mode is executed in a temperature range in which the saturation temperature of the refrigerant at the outdoor heat exchanger 15 is higher than the outside air temperature Tam, similarly to the series dehumidification heating mode.

### (7-1) Cooling HG Dehumidification Heating Mode

In the heat pump cycle 10a in the cooling HG dehumidification heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full close state, the air conditioning expansion valve 14b is brought into a throttle state, the cooling expansion valve 14c is brought into a throttle state, and the bypass side flow rate adjustment valve 14d is brought into a throttle state.

The control device 60 determines the control voltages to be output to the low-pressure side on-off valve 22b, the first inlet side on-off valve 22c, and the second inlet side on-off valve 22d so as to close the low-pressure side on-off valve 22b, open the first inlet side on-off valve 22c, and close the second inlet side on-off valve 22d.

The control device 60 determines the operation states of the compressor 11, the air conditioning expansion valve 14b, the cooling expansion valve 14c, and the bypass side flow rate adjustment valve 14d such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the cooling HG dehumidification heating mode, as indicated by the solid arrows in FIG. 34, the refrigerant circuit is switched to the refrigerant circuit in which the refrigerant discharged from the compressor 11 circulates in the same order as that in the HG dehumidification heating mode.

For this reason, in the heat pump cycle 10a in the cooling HG dehumidification heating mode, the high-temperature side heat medium is heated at the water refrigerant heat exchanger 13, similarly to the first embodiment. The ventilation air is cooled at the indoor evaporator 18. The low-temperature side heat medium is cooled at the chiller 20.

In the high-temperature side heat medium circuit 40 in the cooling HG dehumidification heating mode, the high-temperature side heat medium heated by the water refrigerant heat exchanger 13 flows into the heater core 42, similarly to the first embodiment.

In the low-temperature side heat medium circuit 50 in the cooling HG dehumidification heating mode, as indicated by the broken arrows in FIG. 34, the low-temperature side heat medium flows through the cooling water passage 70a of the battery 70, similarly to the first embodiment. Accordingly, the battery 70 is cooled.

In the indoor air conditioning unit 30 in the cooling HG dehumidification heating mode, the conditioned air dehumidified and temperature-adjusted is blown to the vehicle interior, similarly to the first embodiment. This achieves dehumidification heating of the vehicle interior.

In the cooling HG dehumidification heating mode, similarly to the first embodiment, the heating capability of the ventilation air at the heating portion can be improved more than the cooling series dehumidification heating mode.

### (7-2) Cooling Outside Air Endothermic HG Dehumidification Heating Mode

In the heat pump cycle 10a in the cooling outside air endothermic HG dehumidification heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a throttle state, the cooling expansion valve 14c is brought into a throttle state, and the bypass side flow rate adjustment valve 14d is brought into a throttle state.

The control device 60 determines the control voltages to be output to the low-pressure side on-off valve 22b, the first inlet side on-off valve 22c, and the second inlet side on-off valve 22d so as to open the low-pressure side on-off valve 22b, open the first inlet side on-off valve 22c, and close the second inlet side on-off valve 22d.

The control device 60 determines the operation states of the compressor 11, the heating expansion valve 14a, the air conditioning expansion valve 14b, and the cooling expansion valve 14c such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the cooling outside air endothermic HG dehumidification heating mode, as indicated by the solid arrows in FIG. 35, the refrigerant circuit is switched to the refrigerant circuit in which the refrigerant discharged from the compressor 11 circulates in the same order as that in the outside air endothermic HG dehumidification heating mode.

For this reason, in the heat pump cycle 10a in the cooling outside air endothermic HG dehumidification heating mode, the high-temperature side heat medium is heated at the water refrigerant heat exchanger 13, similarly to the first embodiment. The ventilation air is cooled at the indoor evaporator 18. The low-temperature side heat medium is cooled at the chiller 20. The refrigerant absorbs heat from outside air at the outdoor heat exchanger 15.

In the high-temperature side heat medium circuit 40 in the cooling outside air endothermic HG dehumidification heating mode, the high-temperature side heat medium heated by the water refrigerant heat exchanger 13 flows into the heater core 42, similarly to the first embodiment.

In the low-temperature side heat medium circuit 50 in the cooling outside air endothermic HG dehumidification heating mode, as indicated by the broken arrows in FIG. 35, the low-temperature side heat medium flows through the cooling water passage 70a of the battery 70, similarly to the first embodiment. Accordingly, the battery 70 is cooled.

In the indoor air conditioning unit 30 in the cooling outside air endothermic HG dehumidification heating mode, the conditioned air dehumidified and temperature-adjusted is blown to the vehicle interior, similarly to the first embodiment. This achieves dehumidification heating of the vehicle interior.

In the cooling outside air endothermic HG heating mode, similarly to the first embodiment, the heating capability of the ventilation air at the heating portion can be improved more than the cooling series dehumidification heating mode. Furthermore, in the cooling outside air endothermic HG heating mode, similarly to the first embodiment, the operation efficiency of the heat pump cycle 10a can be improved more than that in the cooling HG dehumidification heating mode.

### (8) Cooling Equipment Endothermic Heating Mode

In the heat pump cycle 10a in the cooling equipment endothermic heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full open state, the air conditioning expansion valve 14b is brought into a full close state, the cooling expansion valve 14c is brought into a throttle state, and the bypass side flow rate adjustment valve 14d is brought into a full close state.

The control device 60 determines the control voltages to be output to the low-pressure side on-off valve 22b, the first inlet side on-off valve 22c, and the second inlet side on-off valve 22d so as to close the low-pressure side on-off valve 22b, close the first inlet side on-off valve 22c, and open the second inlet side on-off valve 22d.

The control device 60 determines the operation state of the cooling expansion valve 14c such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the cooling equipment endothermic heating mode, the refrigerant circuit is switched to the refrigerant circuit in which the refrigerant discharged from the compressor 11 circulates in order of the water refrigerant heat exchanger 13, the heating expansion valve 14a that is fully opened, the outdoor heat exchanger 15, the receiver 24, the cooling expansion valve 14c, the chiller 20, and the suction port of the compressor 11.

For this reason, in the heat pump cycle 10a in the cooling equipment endothermic heating mode, the high-temperature side heat medium is heated at the water refrigerant heat exchanger 13, similarly to the first embodiment. The refrigerant dissipates heat to the outside air at the outdoor heat exchanger 15. The low-temperature side heat medium is cooled at the chiller 20.

In the high-temperature side heat medium circuit 40 in the cooling equipment endothermic heating mode, the high-temperature side heat medium heated by the water refrigerant heat exchanger 13 flows into the heater core 42, similarly to the first embodiment.

In the low-temperature side heat medium circuit 50 in the cooling equipment endothermic heating mode, the low-temperature side heat medium flows through the cooling water passage 70a of the battery 70, similarly to the first embodiment. Accordingly, the battery 70 is cooled.

In the indoor air conditioning unit 30 in the cooling equipment endothermic heating mode, the conditioned air whose temperature has been adjusted is blown to the vehicle interior, similarly to the first embodiment. This achieves heating of the vehicle interior.

### (9) Cooling Outside Air Endothermic Heating Mode

In the heat pump cycle 10a in the cooling outside air endothermic heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a full close state, the cooling expansion valve 14c is brought into a throttle state, and the bypass side flow rate adjustment valve 14d is brought into a full close state.

The control device 60 determines the control voltages to be output to the low-pressure side on-off valve 22b, the first inlet side on-off valve 22c, and the second inlet side on-off valve 22d so as to close the low-pressure side on-off valve 22b, close the first inlet side on-off valve 22c, and open the second inlet side on-off valve 22d.

The control device 60 determines the operation states of the heating expansion valve 14a and the cooling expansion valve 14c such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the cooling outside air endothermic heating mode, the refrigerant circuit is switched to the refrigerant circuit in which the refrigerant discharged from the compressor 11 circulates in order of the water refrigerant heat exchanger 13, the heating expansion valve 14a, the outdoor heat exchanger 15, the receiver 24, the cooling expansion valve 14c, the chiller 20, and the suction port of the compressor 11.

For this reason, in the heat pump cycle 10a in the cooling outside air endothermic heating mode, the high-temperature side heat medium is heated at the water refrigerant heat exchanger 13, similarly to the first embodiment. The refrigerant dissipates heat to the outside air at the outdoor heat exchanger 15. The low-temperature side heat medium is cooled at the chiller 20.

In the high-temperature side heat medium circuit 40 in the cooling outside air endothermic heating mode, the high-temperature side heat medium heated by the water refrigerant heat exchanger 13 flows into the heater core 42, similarly to the first embodiment.

In the low-temperature side heat medium circuit 50 in the cooling outside air endothermic heating mode, the low-temperature side heat medium flows through the cooling water passage 70a of the battery 70, similarly to the first embodiment. Accordingly, the battery 70 is cooled.

In the indoor air conditioning unit 30 in the cooling outside air endothermic heating mode, the conditioned air whose temperature has been adjusted is blown to the vehicle interior, similarly to the first embodiment. This achieves heating of the vehicle interior.

Here, the heat pump cycle 10a includes the receiver 24. Therefore, the cooling equipment endothermic heating mode is executed in a temperature range in which the saturation temperature of the refrigerant at the outdoor heat exchanger 15 is higher than the outside air temperature Tam, similarly to the series dehumidification heating mode.

### (10-1) Cooling HG Heating Mode

In the heat pump cycle 10a in the cooling HG heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full close state, the air conditioning expansion valve 14b is brought into a full close state, the cooling expansion valve 14c is brought into a throttle state, and the bypass side flow rate adjustment valve 14d is brought into a throttle state.

The control device 60 determines the control voltages to be output to the low-pressure side on-off valve 22b, the first inlet side on-off valve 22c, and the second inlet side on-off valve 22d so as to close the low-pressure side on-off valve 22b, open the first inlet side on-off valve 22c, and close the second inlet side on-off valve 22d.

The control device 60 determines the operation states of the compressor 11, the cooling expansion valve 14c, and the bypass side flow rate adjustment valve 14d such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the cooling HG heating mode, as indicated by the solid arrows in FIG. 36, the refrigerant circuit is switched to the refrigerant circuit in which the refrigerant discharged from the compressor 11 circulates in the same order as that in the HG heating mode.

For this reason, in the heat pump cycle 10a in the cooling HG heating mode, the high-temperature side heat medium is heated at the water refrigerant heat exchanger 13, similarly to the first embodiment. The low-temperature side heat medium is cooled at the chiller 20.

In the high-temperature side heat medium circuit 40 in the cooling HG heating mode, the high-temperature side heat medium heated by the water refrigerant heat exchanger 13 flows into the heater core 42, similarly to the first embodiment.

In the low-temperature side heat medium circuit 50 in the cooling HG heating mode, as indicated by the broken arrows in FIG. 36, the low-temperature side heat medium flows through the cooling water passage 70a of the battery 70, similarly to the first embodiment. Accordingly, the battery 70 is cooled.

In the indoor air conditioning unit 30 in the cooling HG heating mode, the conditioned air whose temperature has been adjusted is blown to the vehicle interior, similarly to the first embodiment. This achieves heating of the vehicle interior.

In the HG heating mode, similarly to the first embodiment, the battery 70 is cooled, and at the same time, the heating capability of the ventilation air at the heating portion can be improved more than the cooling outside air endothermic heating mode.

### (10-2) Cooling Outside Air Endothermic HG Heating Mode

In the heat pump cycle 10a in the cooling outside air endothermic HG heating mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a throttle state, the air conditioning expansion valve 14b is brought into a full close state, the cooling expansion valve 14c is brought into a throttle state, and the bypass side flow rate adjustment valve 14d is brought into a throttle state.

The control device 60 determines the control voltages to be output to the low-pressure side on-off valve 22b, the first inlet side on-off valve 22c, and the second inlet side on-off valve 22d so as to close the low-pressure side on-off valve 22b, open the first inlet side on-off valve 22c, and close the second inlet side on-off valve 22d.

The control device 60 determines the operation states of the compressor 11, the heating expansion valve 14a, the cooling expansion valve 14c, and the bypass side flow rate adjustment valve 14d such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

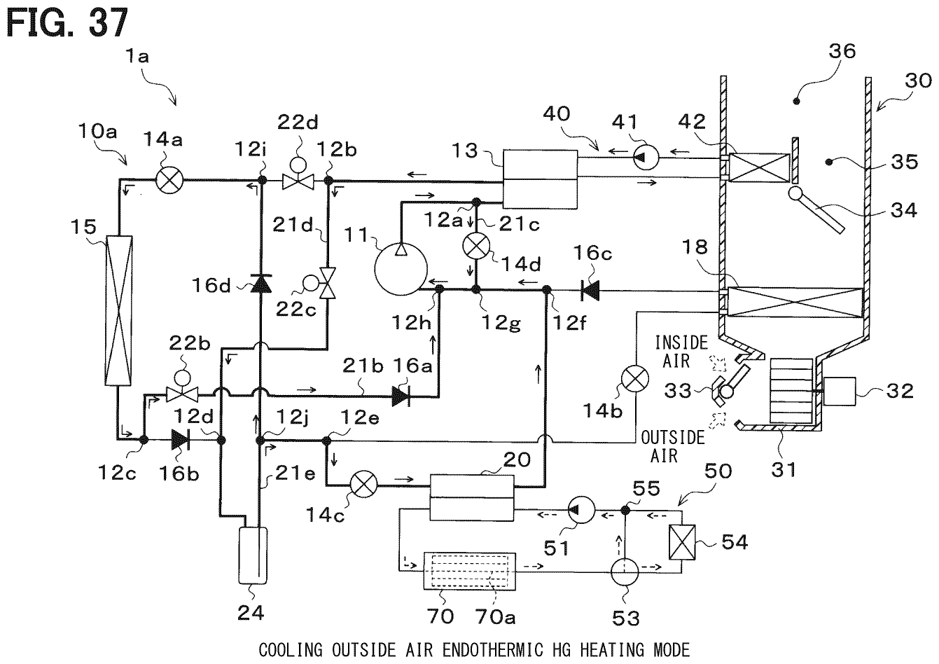

Therefore, in the heat pump cycle 10a in the cooling outside air endothermic HG heating mode, as indicated by the solid arrows in FIG. 37, the refrigerant discharged from the compressor 11 flows similarly to the cooling HG heating mode. At the same time, the refrigerant circuit is switched to the refrigerant circuit in which the refrigerant discharged from the compressor 11 circulates in order of the first three-way joint 12a, the water refrigerant heat exchanger 13, the inlet side passage 21d, the receiver 24, the outlet side passage 21e, the heating expansion valve 14a, the outdoor heat exchanger 15, the low-pressure side passage 21b, the eighth three-way joint 12h, and the suction port of the compressor 11.

For this reason, in the heat pump cycle 10a in the cooling outside air endothermic HG heating mode, the high-temperature side heat medium is heated at the water refrigerant heat exchanger 13, similarly to the first embodiment. The low-temperature side heat medium is cooled at the chiller 20. The refrigerant absorbs heat from outside air at the outdoor heat exchanger 15.

In the high-temperature side heat medium circuit 40 in the cooling outside air endothermic HG heating mode, the high-temperature side heat medium heated by the water refrigerant heat exchanger 13 flows into the heater core 42, similarly to the first embodiment.

In the low-temperature side heat medium circuit 50 in the cooling outside air endothermic HG heating mode, as indicated by the broken arrows in FIG. 37, the low-temperature side heat medium flows through the cooling water passage 70a of the battery 70, similarly to the first embodiment. Accordingly, the battery 70 is cooled.

In the indoor air conditioning unit 30 in the cooling outside air endothermic HG heating mode, the conditioned air whose temperature has been adjusted is blown to the vehicle interior, similarly to the first embodiment. This achieves heating of the vehicle interior.

In the cooling outside air endothermic HG heating mode, similarly to the cooling outside air endothermic HG heating mode, the battery 70 is cooled, and at the same time, the heating capability of the ventilation air at the heating portion can be improved more than the cooling outside air endothermic heating mode.

Furthermore, in the cooling outside air endothermic HG heating mode, the ventilation air can be heated using the heat absorbed from the outside air by the refrigerant at the outdoor heat exchanger 15. Therefore, in the cooling outside air endothermic HG heating mode, the operation efficiency of the heat pump cycle 10 can be improved more than that in the cooling HG heating mode.

### (11) Cooling Mode

In the heat pump cycle 10a in the cooling mode, the control device 60 determines the control signals to be output to the heating expansion valve 14a, the air conditioning expansion valve 14b, the cooling expansion valve 14c, and the bypass side flow rate adjustment valve 14d such that the heating expansion valve 14a is brought into a full open state, the air conditioning expansion valve 14b is brought into a full close state, the cooling expansion valve 14c is brought into a throttle state, and the bypass side flow rate adjustment valve 14d is brought into a full close state.

The control device 60 determines the control voltages to be output to the low-pressure side on-off valve 22b, the first inlet side on-off valve 22c, and the second inlet side on-off valve 22d so as to close the low-pressure side on-off valve 22b, close the first inlet side on-off valve 22c, and open the second inlet side on-off valve 22d.

The control device 60 determines the operation state of the cooling expansion valve 14c such that the superheating degree SH of the sucked refrigerant to be sucked into the compressor 11 approaches the predetermined reference superheating degree KSH.

Furthermore, similarly to the first embodiment, the control device 60 appropriately determines the operation state of another piece of equipment to be controlled. The control device 60 outputs a control signal or a control voltage to various pieces of equipment to be controlled so as to obtain the determined control state.

Therefore, in the heat pump cycle 10a in the cooling mode, the refrigerant circuit is switched to the refrigerant circuit in which the refrigerant discharged from the compressor 11 circulates in order of the water refrigerant heat exchanger 13, the heating expansion valve 14a that is fully opened, the outdoor heat exchanger 15, the receiver 24, the cooling expansion valve 14c, the chiller 20, and the suction port of the compressor 11.

For this reason, in the heat pump cycle 10a in the cooling mode, similarly to the first embodiment, at the outdoor heat exchanger 15, the heat of the refrigerant is dissipated to the outside air. The low-temperature side heat medium is cooled at the chiller 20.

In the low-temperature side heat medium circuit 50 in the cooling mode, the low-temperature side heat medium flows through the cooling water passage 70a of the battery 70, similarly to the first embodiment. Accordingly, the battery 70 is cooled.

### (12) Ventilation Mode

In the ventilation mode, the control device 60 stops the compressor 11. The control device 60 operates the indoor blower 32 according to a setting signal set by the air volume setting switch.

In the indoor air conditioning unit 30 in the ventilation mode, the ventilation air blown from the indoor blower 32 is blown indoor.

As described above, by switching the various operation modes, the vehicle air conditioner 1a of the present embodiment can achieve comfortable air conditioning in the vehicle interior while appropriately adjusting the temperature of the battery 70.

Furthermore, the vehicle air conditioner 1a of the present embodiment can obtain the same effects as those of the vehicle air conditioner 1 of the first embodiment. That is, it is possible to continuously adjust the temperature of the ventilation air in a wide range while suppressing a decrease in operation efficiency by switching between the series dehumidification heating mode and the HG dehumidification heating mode when performing dehumidification heating of the vehicle interior.

It is possible to continuously adjust the temperature of ventilation air in a wide range while suppressing a decrease in operation efficiency simultaneously with cooling of the battery 70 by switching between the cooling series dehumidification heating mode and the cooling HG dehumidification heating mode when performing dehumidification heating of the vehicle interior.

It is possible to continuously adjust the temperature of ventilation air in a wide range while suppressing a decrease in operation efficiency by switching between the outside air endothermic heating mode and the HG heating mode when performing heating the vehicle interior.

It is possible to continuously adjust the temperature of ventilation air in a wide range while suppressing a decrease in operation efficiency simultaneously with cooling of the battery 70 by switching between the cooling outside air endothermic heating mode and the cooling HG heating mode when performing heating of the vehicle interior.

The present disclosure is not limited to the above-described embodiments, and can be variously modified as follows without departing from the gist of the present disclosure.

In the above-described embodiments, examples in which the refrigeration cycle device according to the present disclosure is applied to the vehicle air conditioners 1 and 1a have been described, but application of the refrigeration cycle device according to the present disclosure is not limited to the vehicle. For example, the present invention may be applied to a stationary air conditioner with a temperature adjustment function for adjusting the temperature of an object to be cooled (e.g., a computer, a server device, and other peripheral equipment) while performing indoor air conditioning.

In the above-described embodiments, an example has been described in which the refrigeration cycle device according to the present disclosure is applied to an air conditioner with an in-vehicle equipment temperature adjustment function and adjusts the temperature of the battery 70 as in-vehicle equipment. However, the in-vehicle equipment is not limited to the battery 70. For example, the temperature of an inverter, a PCU, a transaxle, an ADAS control device, or the like may be adjusted. Furthermore, the temperatures of a plurality of pieces of in-vehicle equipment may be adjusted.

The inverter supplies power to a motor generator or the like. The PCU is a power control unit that performs transformation and power distribution. The transaxle is a power transmission mechanism in which a transmission, a differential gear, and the like are integrated. The ADAS control device is an advanced driver assistance system control device.

Of course, the refrigeration cycle device according to the present disclosure may be applied to an air conditioner that does not have a function of performing temperature adjustment of an object to be cooled such as in-vehicle equipment but exclusively performs air conditioning of a space to be air conditioned.

The configuration of the refrigeration cycle device according to the present disclosure is not limited to the configuration disclosed in the above-described embodiments.

In the above-described embodiments, an example in which the heating portion is formed by each piece of constituent equipment of the water refrigerant heat exchanger 13 and the high-temperature side heat medium circuit 40 has been described, but the heating portion is not limited to this.

For example, an indoor condenser may be employed as the heating portion. The indoor condenser is a heating heat exchange portion that heats the ventilation air by exchanging heat between the one discharge refrigerant branched at the first three-way joint 12a and the ventilation air passing through the indoor evaporator 18. The indoor condenser may be disposed similarly to the heater core 42 in the air passage of the indoor air conditioning unit 30.

In the above-described embodiments, an example has been described in which the cooling portion is formed by each piece of constituent equipment of the chiller 20 and the low-temperature side heat medium circuit 50, but the cooling portion is not limited to this.

For example, as the cooling portion, a thermosiphon may be employed in which the chiller 20 of the low-temperature side heat medium circuit 50 functions as a condense portion and the cooling water passage 70a functions as an evaporation portion. This can eliminate the low-temperature side pump 51.

The thermosiphon includes the evaporation portion that evaporates the refrigerant and the condense portion that condenses the refrigerant, and is configured by connecting the evaporation portion and the condense portion in a closed loop shape (i.e., in an annular shape). It is a heat transport circuit that generates a specific gravity difference in the refrigerant in the circuit by a temperature difference between the temperature of the refrigerant at the evaporation portion and the temperature of the refrigerant at the condense portion, and naturally circulates the refrigerant by the action of gravity to transport heat together with the refrigerant.

For example, a cooling heat exchange portion that directly exchanges heat between the low pressure refrigerant of the heat pump cycle and the battery 70 and causes the low pressure refrigerant to directly absorb the waste heat of the battery 70 without using the low-temperature side heat medium may be employed as the cooling portion. For example, an air cooling type cooling device that blows, to the battery 70, the ventilation air cooled by a cooling evaporator may be employed as the cooling portion.

In the above-described embodiments, an example in which the seventh three-way joint 12g and the eighth three-way joint 12h, which are the merging portions, are disposed on the refrigerant flow downstream side of the sixth three-way joint 12f has been described, but the arrangement of the merging portion is not limited to this.

For example, the seventh three-way joint 12g may be disposed in the refrigerant passage from the outlet side of the cooling expansion valve 14c to the refrigerant inlet side of the chiller 20. For example, the seventh three-way joint 12g may be disposed in the refrigerant passage from the refrigerant outlet side of the chiller 20 to the inlet side of the sixth three-way joint 12f. For example, in the heat pump cycle 10 of the first embodiment, the bypass passage 21c may be directly connected to the accumulator 23 by eliminating the seventh three-way joint 12g.

In the above-described embodiments, an example in which the merging portion is formed by the seventh three-way joint 12g and the eighth three-way joint 12h has been described. However, the merging portion may be formed by a four-way joint in which the seventh three-way joint 12g and the eighth three-way joint 12h are integrated.

Similarly, in the heat pump cycle 10 of the first embodiment, the fourth three-way joint 12d and the fifth three-way joint 12e may be integrated into a four-way joint. In the heat pump cycle 10a of the second embodiment, the ninth three-way joint 12i and the fifth three-way joint 12e may be integrated into a four-way joint.

With respect to the heat pump cycle 10a of the second embodiment, a subcooling expansion valve may be disposed in the refrigerant passage from the outflow port side of the fourth three-way joint 12d to the inlet side of the receiver 24. The subcooling expansion valve depressurizes the refrigerant flowing into the receiver 24. As the subcooling expansion valve, a fixed throttle may be employed, or a variable throttle mechanism may be employed.

This can raise the subcooling degree of the refrigerant flowing out of the water refrigerant heat exchanger 13 to raise the refrigerant pressure (i.e., discharge refrigerant pressure Pd) at the water refrigerant heat exchanger 13. As a result, the heating capability of the high-temperature side heat medium at the water refrigerant heat exchanger 13 can be improved, and the heating capability of the ventilation air can be improved.

In the above-described embodiments, an example in which R1234yf is employed as the refrigerants of the heat pump cycles 10 and 10a has been described, but the present invention is not limited to this. For example, R134a, R600a, R410A, R404A, R32, R407C, and the like may be employed. Alternatively, a mixed refrigerant in which a plurality of types of these refrigerants are mixed or the like may be employed. Furthermore, carbon dioxide may be employed as the refrigerant to form a supercritical refrigeration cycle in which the high-pressure side refrigerant pressure is equal to or greater than the critical pressure of the refrigerant.

In the above-described embodiments, an example in which PAG oil (i.e., polyalkylene glycol oil) is employed as the refrigerant oil has been described, but the invention is not limited to this. For example, polyol ester (POE) or the like may be employed.

In the above-described embodiments, an example in which an ethylene glycol aqueous solution is employed as the heat medium, the low-temperature side heat medium, and the high-temperature side heat medium has been described, but the present invention is not limited to this. For example, a solution containing dimethylpolysiloxane, a nanofluid or the like, an antifreeze liquid, an aqueous liquid refrigerant containing alcohol or the like, a liquid medium containing oil or the like may be employed.

The control sensor group connected to the input side of the control device 60 is not limited to the detection unit disclosed in the above-described embodiments. Various detection units may be added as necessary.

In the above-described embodiments, the vehicle air conditioners 1 and 1a that can switch a plurality of operation modes have been described, but the switching of the operation mode is not limited to this.

If at least the (2) series dehumidification heating mode and the (3-1) HG dehumidification heating mode are switchable, it is possible to continuously adjust the temperature of ventilation air in a wide range while suppressing a decrease in operation efficiency when performing dehumidification heating of the space to be air conditioned.

If at least the (6) cooling series dehumidification heating mode and the (7-1) cooling HG dehumidification heating mode are switchable, it is possible to continuously adjust the temperature of ventilation air in a wide range while suppressing a decrease in operation efficiency simultaneously with cooling of the battery 70 when performing dehumidification heating of the space to be air conditioned.

If at least the (4-1) outside air endothermic heating mode and the (4-2) HG heating mode are switchable, it is possible to continuously adjust the temperature of ventilation air in a wide range while suppressing a decrease in operation efficiency when performing heating of the space to be air conditioned.

If at least the (9) cooling outside air endothermic heating mode and the (10-1) cooling HG heating mode are switchable, it is possible to continuously adjust the temperature of ventilation air in a wide range while suppressing a decrease in operation efficiency simultaneously with cooling of the battery 70 when performing heating of the space to be air conditioned.

In the above-described embodiments, as described in step S140 and the like, an example has been described in which it is determined whether the heat of the outside air can be appropriately absorbed by the refrigerant at the outdoor heat exchanger 15 using the outdoor unit temperature difference ΔTO and the blowing temperature difference ΔTAO, but the present invention is not limited to this.

For example, in order to determine whether the outside air heat absorption is possible, the heat absorption amount of the refrigerant when the refrigerant flows into the outdoor heat exchanger 15 may be predicted, and whether the heat absorption amount is not excessive with respect to the target blowing temperature TAO may be determined. For example, in order to determine whether the outside air heat absorption is possible, a flow rate (mass flow rate) of the refrigerant flowing through the outdoor heat exchanger 15 may be predicted when the refrigerant flows into the outdoor heat exchanger 15, and whether the refrigerant oil can be returned to the compressor 11 may be determined.

The means disclosed in each of the embodiments described above may be appropriately combined within a feasible range. For example, the control aspect related to the switching of the operation mode described in the second embodiment may be applied to the vehicle air conditioner 1a described in the third embodiment.

Features of the refrigeration cycle devices described in the above includes at least following items.

### (Item 1)

A refrigeration cycle device includes:
a compressor (11) configured to compress and discharge a refrigerant; an upstream side branch portion (12a) configured to branch a flow of the refrigerant discharged from the compressor; a heating portion (13, 40) configured to heat ventilation air blowing a space to be air conditioned, using, as a heat source, the refrigerant flowing out of a one outflow port of the upstream side branch portion; a heating-portion side depressurization portion (14a, 14b, 14c) configured to depressurize the refrigerant flowing out of the heating portion; an outdoor heat exchange portion (15) configured to exchange heat between the refrigerant flowing out of the heating-portion side depressurization portion and outside air; an indoor evaporation portion (18) configured to evaporate the refrigerant depressurized at the heating-portion side depressurization portion to cool the ventilation air before being heated by the heating portion; a bypass passage (21c) that guides the refrigerant flowing out of an another outflow port branched at the upstream side branch portion, toward a suction port side of the compressor; a bypass flow rate adjustment portion (14d) that is configured to adjust a flow rate of the refrigerant flowing through the bypass passage; a merging portion (12g, 12h) configured to merge a flow of the refrigerant flowing out of the heating-portion side depressurization portion and a flow of the refrigerant flowing out of the bypass flow rate adjustment portion, and to cause the merged refrigerant to flow toward the suction port side of the compressor; and a refrigerant circuit switching portion (22a, 22b, 22c, 22d) configured to switch a refrigerant circuit. In the refrigeration cycle device, the heating-portion side depressurization portion includes an outdoor side depressurization portion (14a) that depressurizes the refrigerant flowing into the outdoor heat exchange portion, an indoor side depressurization portion (14b) that depressurizes the refrigerant flowing into the indoor evaporation portion, and a bypass side depressurization portion (14c) that depressurizes the refrigerant bypassing the outdoor heat exchange portion and the indoor evaporation portion, and operation modes, in which the heating portion heats the ventilation air cooled at the indoor evaporation portion, include a series dehumidification heating mode and a hot gas dehumidification heating mode. In addition, the refrigerant circuit switching portion is configured to
switch a refrigerant circuit in which the refrigerant discharged from the compressor circulates in order of the heating portion, the outdoor side depressurization portion, the outdoor heat exchange portion, the indoor side depressurization portion, the indoor evaporation portion, and the suction port of the compressor, in the series dehumidification heating mode, and
switch a refrigerant circuit in which (i) the refrigerant discharged from the compressor circulates in order of the upstream side branch portion, the heating portion, the indoor side depressurization portion, the indoor evaporation portion, the merging portion, and the suction port of the compressor; (ii) the refrigerant discharged from the compressor circulates in order of the upstream side branch portion, the heating portion, the bypass side depressurization portion, the merging portion, and the suction port of the compressor, and (iii) the refrigerant discharged from the compressor circulates in order of the upstream side branch portion, the bypass passage, the merging portion, and the suction port of the compressor, in the hot gas dehumidification heating mode.

### (Item 2)

The refrigeration cycle device according to Item 1 further includes: a target blowing temperature determination unit (S20) configured to determine a target blowing temperature (TAO) of the ventilation air blowing the space to be air conditioned; and a ventilation air temperature detection unit (66) configured to detect a ventilation air temperature (TAV) of the ventilation air blowing the space to be air conditioned. In this case, the refrigerant circuit switching portion switches from the series dehumidification heating mode to the hot gas dehumidification heating mode when the ventilation air temperature (TAV) is lower than the target blowing temperature (TAO).

### (Item 3)

The refrigeration cycle device according to Item 1 or 2 further includes: a target evaporator temperature determination unit (S1907) configured to determine a target evaporator temperature (TEO) of the indoor evaporation portion; and an evaporator temperature detection unit (62f) configured to detect an evaporator temperature (Tefin) of the indoor evaporation portion. In this case, the refrigerant circuit switching portion switches from the hot gas dehumidification heating mode to the series dehumidification heating mode when the evaporator temperature (Tefin) is higher than the target evaporator temperature (TEO).

### (Item 4)

In the refrigeration cycle device according to any one of Items 1 to 3, the operation mode, in which the heating portion heats the ventilation air cooled at the indoor evaporation portion, further includes an outside air endothermic hot-gas dehumidification heating mode. In this case, the refrigerant circuit switching portion is configured to switch a refrigerant circuit in which (i) the refrigerant discharged from the compressor circulates in order of the upstream side branch portion, the heating portion, the outdoor side depressurization portion, the outdoor heat exchange portion, the merging portion, and the suction port of the compressor; (ii) the refrigerant discharged from the compressor circulates in order of the upstream side branch portion, the heating portion, the indoor side depressurization portion, the indoor evaporation portion, the merging portion, and the suction port of the compressor; (iii) the refrigerant discharged from the compressor circulates in order of the upstream side branch portion, the heating portion, the bypass side depressurization portion, the merging portion, and the suction port of the compressor; and (iv) the refrigerant discharged from the compressor circulates in order of the upstream side branch portion, the bypass passage, the merging portion, the suction port of the compressor, in the outside air endothermic hot-gas dehumidification heating mode.

### (Item 5)

The refrigeration cycle device according to Item 4, further includes: a target evaporator temperature determination unit (S1907) configured to determine a target evaporator temperature (TEO) of the indoor evaporation portion; and an outside air temperature detection unit (61b) configured to detect an outside air temperature (Tam), which is a temperature of the outside air. In this case, the refrigerant circuit switching portion switches from the hot gas dehumidification heating mode to the outside air endothermic hot-gas dehumidification heating mode when an outdoor unit temperature difference (ΔTO) in which the target evaporator temperature (TEO) is subtracted from the outside air temperature (Tam) is equal to or greater than a predetermined reference temperature difference (KΔTO1).

### (Item 6)

The refrigeration cycle device according to Item 4 or 5, further includes: a target evaporator temperature determination unit (S1807) configured to determine a target evaporator temperature (TEO) of the indoor evaporation portion; and an evaporator temperature detection unit (62f) configured to detect an evaporator temperature (Tefin) of the indoor evaporation portion. In this case, the refrigerant circuit switching portion switches from the outside air endothermic hot-gas dehumidification heating mode to the hot gas dehumidification heating mode when the evaporator temperature (Tefin) is higher than the target evaporator temperature (TEO).

### (Item 7)

The refrigeration cycle device according to any one of Items 1 to 6 further includes a cooling portion (20, 50) configured to cool an object to be cooled, and operation modes, in which the cooling portion cools the object to be cooled and the heating portion heats the ventilation air cooled at the indoor evaporation portion, include a cooling series dehumidification heating mode and a cooling hot gas dehumidification heating mode. In this case, the refrigerant circuit switching portion is configured,
in the cooling series dehumidification heating mode, to switch a refrigerant circuit in which (i) the refrigerant discharged from the compressor circulates in order of the heating portion, the outdoor side depressurization portion, the outdoor heat exchange portion, the indoor side depressurization portion, the indoor evaporation portion, and the suction port of the compressor, and (ii) the refrigerant discharged from the compressor circulates in order of the heating portion, the outdoor side depressurization portion, the outdoor heat exchange portion, the bypass side depressurization portion, the cooling portion, and the suction port of the compressor, and
in the cooling hot gas dehumidification heating mode, to switch a refrigerant circuit in which (i) the refrigerant discharged from the compressor circulates in order of the upstream side branch portion, the heating portion, the indoor side depressurization portion, the indoor evaporation portion, the merging portion, and the suction port of the compressor; (ii) the refrigerant discharged from the compressor further circulates in order of the upstream side branch portion, the heating portion, the bypass side depressurization portion, the cooling portion, the merging portion, and the suction port of the compressor; and (iii) the refrigerant discharged from the compressor circulates in order of the upstream side branch portion, the bypass passage, the merging portion, and the suction port of the compressor.

### (Item 8)

A refrigeration cycle device includes: a compressor (11) configured to compress and discharge a refrigerant; an upstream side branch portion (12a) configured to branch a flow of the refrigerant discharged from the compressor; a heating portion (13, 40) configured to heat ventilation air blowing a space to be air conditioned, using, as a heat source, the refrigerant flowing out of a one outflow port of the upstream side branch portion; a heating-portion side depressurization portion (14a, 14b, 14c) configured to depressurize the refrigerant flowing out of the heating portion; an outdoor heat exchange portion (15) configured to exchange heat between the refrigerant flowing out of the heating-portion side depressurization portion and outside air; a bypass passage (21c) that guides an other stream of the refrigerant branched at the upstream side branch portion toward a suction port side of the compressor; a bypass flow rate adjustment portion (14d) configured to adjust a flow rate of the refrigerant flowing through the bypass passage; a merging portion (12g, 12h) configured to merge a flow of the refrigerant flowing out of the heating-portion side depressurization portion and a flow of the refrigerant flowing out of the bypass flow rate adjustment portion, and to cause the merged refrigerant to flow toward a suction port side of the compressor; and a refrigerant circuit switching portion (22a, 22b, 22c, 22d) configured to switch a refrigerant circuit. The heating-portion side depressurization portion includes an outdoor side depressurization portion (14a) that depressurizes the refrigerant flowing into the outdoor heat exchange portion, and a bypass side depressurization portion (14c) that depressurizes the refrigerant bypassing the outdoor heat exchange portion. The operation modes, in which the heating portion heats the ventilation air, includes an outside air endothermic heating mode and a hot gas heating mode. The refrigerant circuit switching portion is configured,
in the outside air endothermic heating mode, to switch a refrigerant circuit in which the refrigerant discharged from the compressor circulates in order of the heating portion, the outdoor side depressurization portion, the outdoor heat exchange portion, and the suction port of the compressor, and
in the hot gas heating mode, to switch a refrigerant circuit in which (i) the refrigerant discharged from the compressor circulates in order of the upstream side branch portion, the heating portion, the bypass side depressurization portion, the merging portion, and the suction port of the compressor; and (ii) the refrigerant discharged from the compressor circulates in order of the upstream side branch portion, the bypass passage, the merging portion, and the suction port of the compressor.

### (Item 9)

The refrigeration cycle device according to Item 8, further includes: a target blowing temperature determination unit (S20) configured to determine a target blowing temperature (TAO) of the ventilation air blowing the space to be air conditioned; and a ventilation air temperature detection unit (66) configured to detect a ventilation air temperature (TAV) of the ventilation air blowing the space to be air conditioned. In this case, the refrigerant circuit switching portion switches from the outside air endothermic heating mode to the hot gas heating mode when the ventilation air temperature (TAV) is lower than the target blowing temperature (TAO).

### (Item 10)

The refrigeration cycle device according to Item 8 or 9, further includes: a target blowing temperature determination unit (S20) configured to determine a target blowing temperature (TAO) of the ventilation air blowing the space to be air conditioned. In this case, the refrigerant circuit switching portion switches from the hot gas heating mode to the outside air endothermic heating mode when the target blowing temperature (TAO) is lower than a hot gas reference temperature (δ).

### (Item 11)

The refrigeration cycle device according to any one of Items 8 to 10 further includes a cooling portion (20, 50) configured to cool an object to be cooled, operation modes, in which the cooling portion cools the object to be cooled and the heating portion heats the ventilation air, includes a cooling series dehumidification heating mode and a cooling hot gas dehumidification heating mode, and in which the bypass side depressurization portion depressurizes the refrigerant flowing into the cooling portion. In addition, the operation modes, in which the cooling portion cools the object to be cooled and the heating portion heats the ventilation air, further includes a cooling outside air endothermic heating mode and a cooling hot gas heating mode. In this case, the refrigerant circuit switching portion is configured,
in the cooling outside air endothermic heating mode, to switch a refrigerant circuit in which the refrigerant discharged from the compressor circulates in order of the heating portion, the outdoor side depressurization portion, the outdoor heat exchange portion, the bypass side depressurization portion, the cooling portion, and the suction port of the compressor, and
in the cooling hot gas heating mode, to switch a refrigerant circuit in which (i) the refrigerant discharged from the compressor circulates in order of the upstream side branch portion, the heating portion, the bypass side depressurization portion, the cooling portion, the merging portion, and the suction port of the compressor; and (ii) the refrigerant discharged from the compressor circulates in order of the upstream side branch portion, the bypass passage, the merging portion, and the suction port of the compressor.

Although the present disclosure has been described in accordance with examples, it is understood that the present disclosure is not limited to the examples and structures. The present disclosure also includes various modifications and modifications within equivalent ranges. In addition, various combinations and forms, and other combinations and forms including only one element, more elements, or less elements also fall within the scope and idea of the present disclosure.

What is claimed is:

1. A refrigeration cycle device comprising:
a compressor configured to compress and discharge a refrigerant;
a branch portion configured to branch a flow of the refrigerant discharged from the compressor;
a heating portion configured to heat ventilation air blowing a space to be air conditioned, using, as a heat source, the refrigerant flowing out of a one outflow port of the branch portion;
a depressurization device configured to depressurize the refrigerant flowing out of the heating portion;
an outdoor heat exchange portion configured to exchange heat between the refrigerant flowing out of the depressurization device and outside air;
an indoor evaporation portion configured to evaporate the refrigerant depressurized at the depressurization device to cool the ventilation air before being heated by the heating portion;
a bypass passage that guides one stream of the refrigerant branched at the branch portion, toward a suction port side of the compressor;
a bypass flow rate adjustment portion that is configured to adjust a flow rate of the refrigerant flowing through the bypass passage;
a merging portion configured to merge a flow of the refrigerant flowing out of the depressurization device and a flow of the refrigerant flowing out of the bypass flow rate adjustment portion, and to cause the merged refrigerant to flow toward the suction port side of the compressor; and
a refrigerant circuit switching portion configured to switch a refrigerant circuit, wherein
the depressurization device includes a first depressurization unit that depressurizes the refrigerant flowing into the outdoor heat exchange portion, a second depressurization unit that depressurizes the refrigerant flowing into the indoor evaporation portion, and a third depressurization unit that depressurizes the refrigerant bypassing the outdoor heat exchange portion and the indoor evaporation portion, and
operation modes, in which the heating portion heats the ventilation air cooled at the indoor evaporation portion, include a series dehumidification heating mode and a hot gas dehumidification heating mode, and
the refrigerant circuit switching portion is configured to
switch a refrigerant circuit in which the refrigerant discharged from the compressor circulates in order of the heating portion, the first depressurization unit, the outdoor heat exchange portion, the second depressurization unit, the indoor evaporation portion, and the suction port of the compressor, in the series dehumidification heating mode, and
switch a refrigerant circuit in which (i) the refrigerant discharged from the compressor circulates in order of the branch portion, the heating portion, the second depressurization unit, the indoor evaporation portion, the merging portion, and the suction port of the compressor; (ii) the refrigerant discharged from the compressor circulates in order of the branch portion, the heating portion, the third depressurization unit, the merging portion, and the suction port of the compressor, and (iii) the refrigerant discharged from the compressor circulates in order of the branch portion, the bypass passage, the merging portion, and the suction port of the compressor, in the hot gas dehumidification heating mode.

2. The refrigeration cycle device according to claim 1, further comprising
a target blowing temperature determination unit configured to determine a target blowing temperature of the ventilation air blowing the space to be air conditioned; and
a ventilation air temperature detection unit configured to detect a ventilation air temperature of the ventilation air blowing the space to be air conditioned, wherein
the refrigerant circuit switching portion switches from the series dehumidification heating mode to the hot gas dehumidification heating mode when the ventilation air temperature is lower than the target blowing temperature.

3. The refrigeration cycle device according to claim 1, further comprising
a target evaporator temperature determination unit configured to determine a target evaporator temperature of the indoor evaporation portion; and
an evaporator temperature detection unit configured to detect an evaporator temperature of the indoor evaporation portion, wherein
the refrigerant circuit switching portion switches from the hot gas dehumidification heating mode to the series dehumidification heating mode when the evaporator temperature is higher than the target evaporator temperature.

4. The refrigeration cycle device according to claim 1, wherein
the operation mode, in which the heating portion heats the ventilation air cooled at the indoor evaporation portion, further includes an outside air endothermic hot-gas dehumidification heating mode, wherein
the refrigerant circuit switching portion is configured to
switch a refrigerant circuit in which (i) the refrigerant discharged from the compressor circulates in order of the branch portion, the heating portion, the first depressurization unit, the outdoor heat exchange portion, the merging portion, and the suction port of the compressor; (ii) the refrigerant discharged from the compressor circulates in order of the branch portion, the heating portion, the second depressurization unit, the indoor evaporation portion, the merging portion, and the suction port of the compressor; (iii) the refrigerant discharged from the compressor circulates in order of the branch portion, the heating portion, the third depressurization unit, the merging portion, and the suction port of the compressor; and (iv) the refrigerant discharged from the compressor circulates in order of the branch portion, the bypass passage, the merging portion, the suction port of the compressor, in the outside air endothermic hot-gas dehumidification heating mode.

5. The refrigeration cycle device according to claim 4, further comprising
a target evaporator temperature determination unit configured to determine a target evaporator temperature of the indoor evaporation portion; and
an outside air temperature detection unit configured to detect an outside air temperature, which is a temperature of the outside air, wherein
the refrigerant circuit switching portion switches from the hot gas dehumidification heating mode to the outside air endothermic hot-gas dehumidification heating mode when an outdoor unit temperature difference in which the target evaporator temperature is subtracted from the outside air temperature is equal to or greater than a predetermined reference temperature difference.

6. The refrigeration cycle device according to claim 4, further comprising
a target evaporator temperature determination unit configured to determine a target evaporator temperature of the indoor evaporation portion; and
an evaporator temperature detection unit configured to detect an evaporator temperature of the indoor evaporation portion, wherein
the refrigerant circuit switching portion switches from the outside air endothermic hot-gas dehumidification heating mode to the hot gas dehumidification heating mode when the evaporator temperature is higher than the target evaporator temperature.

7. The refrigeration cycle device according to claim 1, further comprising:
a cooling portion configured to cool an object to be cooled, wherein
operation modes, in which the cooling portion cools the object to be cooled and the heating portion heats the ventilation air cooled at the indoor evaporation portion, include a cooling series dehumidification heating mode and a cooling hot gas dehumidification heating mode,
the refrigerant circuit switching portion is configured to
in the cooling series dehumidification heating mode, switch a refrigerant circuit in which (i) the refrigerant discharged from the compressor circulates in order of the heating portion, the first depressurization unit, the outdoor heat exchange portion, the second depressurization unit, the indoor evaporation portion, and the suction port of the compressor, and (ii) the refrigerant discharged from the compressor circulates in order of the heating portion, the first depressurization unit, the outdoor heat exchange portion, the third depressurization unit, the cooling portion, and the suction port of the compressor, and
in the cooling hot gas dehumidification heating mode, switch a refrigerant circuit in which (i) the refrigerant discharged from the compressor circulates in order of the branch portion, the heating portion, the second depressurization unit, the indoor evaporation portion, the merging portion, and the suction port of the compressor; (ii) the refrigerant discharged from the compressor circulates in order of the branch portion, the heating portion, the third depressurization unit, the cooling portion, the merging portion, and the suction port of the compressor; and (iii) the refrigerant discharged from the compressor circulates in order of the branch portion, the bypass passage, the merging portion, and the suction port of the compressor.

8. A refrigeration cycle device comprising:
a compressor configured to compress and discharge a refrigerant;
a branch portion configured to branch a flow of the refrigerant discharged from the compressor;
a heating portion configured to heat ventilation air blowing a space to be air conditioned, using one stream of refrigerant flowing out of the branch portion, as a heat source;
a depressurization device configured to depressurize the refrigerant flowing out of the heating portion;
an outdoor heat exchange portion configured to exchange heat between the refrigerant flowing out of the depressurization device and outside air;
a bypass passage that guides an another stream of the refrigerant branched at the branch portion toward a suction port side of the compressor;
a bypass flow rate adjustment portion configured to adjust a flow rate of the refrigerant flowing through the bypass passage;
a merging portion configured to merge a flow of the refrigerant flowing out of the depressurization device and a flow of the refrigerant flowing out of the bypass flow rate adjustment portion, and to cause the merged refrigerant to flow toward a suction port side of the compressor;
a cooling portion configured to cool an object to be cooled; and
a refrigerant circuit switching portion configured to switch a refrigerant circuit, wherein
the depressurization device includes an outdoor side depressurization unit that depressurizes the refrigerant flowing into the outdoor heat exchange portion, and a bypass side depressurization unit that depressurizes the refrigerant bypassing the outdoor heat exchange portion,
the bypass side depressurization unit depressurizes the refrigerant flowing into the cooling portion,
the operation modes, in which the heating portion heats the ventilation air, includes an outside air endothermic heating mode and a hot gas heating mode,
operation modes, in which the cooling portion cools the object to be cooled and the heating portion heats the ventilation air, includes a cooling outside air endothermic heating mode and a cooling hot gas heating mode, in addition to a cooling series dehumidification heating mode and a cooling hot gas dehumidification heating mode in which a dehumidification heating of the ventilation air is performed, and
the refrigerant circuit switching portion is configured,
in the outside air endothermic heating mode, to switch a refrigerant circuit in which the refrigerant discharged from the compressor circulates in order of the heating portion, the outdoor side depressurization unit, the outdoor heat exchange portion, and the suction port of the compressor,
in the hot gas heating mode, to switch a refrigerant circuit in which (i) the refrigerant discharged from the compressor circulates in order of the branch portion, the heating portion, the bypass side depressurization unit, the merging portion, and the suction port of the compressor; and (ii) the refrigerant discharged from the compressor circulates in order of the branch portion, the bypass passage, the merging portion, and the suction port of the compressor,
in the cooling outside air endothermic heating mode, to switch a refrigerant circuit in which the refrigerant discharged from the compressor circulates in order of the heating portion, the outdoor side depressurization unit, the outdoor heat exchange portion, the bypass side depressurization unit, the cooling portion, and the suction port of the compressor, and
in the cooling hot gas heating mode, to switch a refrigerant circuit in which (i) the refrigerant discharged from the compressor circulates in order of the branch portion, the heating portion, the bypass side depressurization unit, the cooling portion, the merging portion, and the suction port of the compressor; and (ii) the refrigerant discharged from the compressor circulates in order of the branch portion, the bypass passage, the merging portion, and the suction port of the compressor.

9. The refrigeration cycle device according to claim 8, further comprising
a target blowing temperature determination unit configured to determine a target blowing temperature of the ventilation air blowing the space to be air conditioned; and
a ventilation air temperature detection unit configured to detect a ventilation air temperature of the ventilation air blowing the space to be air conditioned, wherein
the refrigerant circuit switching portion switches from the outside air endothermic heating mode to the hot gas heating mode when the ventilation air temperature is lower than the target blowing temperature.

10. The refrigeration cycle device according to claim 8, further comprising
a target blowing temperature determination unit configured to determine a target blowing temperature of the ventilation air blowing the space to be air conditioned, wherein
the refrigerant circuit switching portion switches from the hot gas heating mode to the outside air endothermic heating mode when the target blowing temperature is lower than a hot gas reference temperature.

11. A refrigeration cycle device comprising:
a compressor configured to compress and discharge a refrigerant;
a branch joint configured to branch a flow of the refrigerant discharged from the compressor;
a heater configured to heat ventilation air blowing a space to be air conditioned, using the refrigerant flowing out of a one outflow port of the branch joint as a heat source;
a depressurization device configured to depressurize the refrigerant flowing out of the heater;
an outdoor heat exchanger configured to exchange heat between the refrigerant flowing out of the depressurization device and outside air;
an indoor evaporator configured to evaporate the refrigerant depressurized at the depressurization device and to cool the ventilation air before being heated by the heater;
a bypass passage that guides one stream of the refrigerant branched at the branch portion, toward a suction port side of the compressor;
a bypass flow rate adjustment valve that is configured to adjust a flow rate of the refrigerant flowing through the bypass passage;
a merging joint configured to merge a flow of the refrigerant flowing out of the depressurization device and a flow of the refrigerant flowing out of the bypass flow rate adjustment valves, and to cause the merged refrigerant to flow toward the suction port side of the compressor;
a plurality of refrigerant circuit switching valves configured to switch a refrigerant circuit; and
a controller including at least one of a circuit and a processor having a memory, wherein
the controller is configured to control the refrigerant circuit switching valves, and to set operation modes including a series dehumidification heating mode and a hot gas dehumidification heating mode, in which the heater heats the ventilation air cooled at the indoor evaporator,
the depressurization device includes a first depressurization valve that depressurizes the refrigerant flowing into the outdoor heat exchanger, a second depressurization valve that depressurizes the refrigerant flowing into the indoor evaporator, and a third depressurization valve that depressurizes the refrigerant bypassing the outdoor heat exchanger and the indoor evaporator, and
the controller controls the refrigerant circuit switching valves to
switch a refrigerant circuit in which the refrigerant discharged from the compressor circulates in order of the heater, the first depressurization valve, the outdoor heat exchanger, the second depressurization valve, the indoor evaporator, and the suction port of the compressor, in the series dehumidification heating mode, and
switch a refrigerant circuit in which (i) the refrigerant discharged from the compressor circulates in order of the branch joint, the heater, the second depressurization valve, the indoor evaporator, the merging joint, and the suction port of the compressor; (ii) the refrigerant discharged from the compressor circulates in order of the branch joint, the heater, the third depressurization valve, the merging joint, and the suction port of the compressor, and (iii) the refrigerant discharged from the compressor circulates in order of the branch joint, the bypass passage, the merging joint, and the suction port of the compressor, in the hot gas dehumidification heating mode.

12. The refrigeration cycle device according to claim 11, further comprising
a ventilation air temperature sensor disposed to detect a ventilation air temperature of the ventilation air blowing the space to be air conditioned, wherein
the controller is configured to determine a target blowing temperature of the ventilation air blowing the space to be air conditioned, and
the controller controls the refrigerant circuit switching valves, to switch from the series dehumidification heating mode to the hot gas dehumidification heating mode when the ventilation air temperature is lower than the target blowing temperature.

13. The refrigeration cycle device according to claim 11, further comprising
an evaporator temperature sensor configured to detect an evaporator temperature of the indoor evaporator, wherein
the controller is configured to determine a target evaporator temperature of the indoor evaporator; and
the controller controls the refrigerant circuit switching valves, to switch from the hot gas dehumidification heating mode to the series dehumidification heating mode when the evaporator temperature is higher than the target evaporator temperature.

14. The refrigeration cycle device according to claim 11, wherein
the operation mode, in which the heater heats the ventilation air cooled at the indoor evaporator, further includes an outside air endothermic hot-gas dehumidification heating mode, wherein
the controller controls the refrigerant circuit switching valves, to switch
a refrigerant circuit in which (i) the refrigerant discharged from the compressor circulates in order of the branch joint, the heater, the first depressurization valve, the outdoor heat exchanger, the merging joint, and the suction port of the compressor; (ii) the refrigerant discharged from the compressor circulates in order of the branch joint, the heater, the second depressurization valve, the indoor evaporator, the merging joint, and the suction port of the compressor; (iii) the refrigerant discharged from the compressor circulates in order of the branch joint, the heater, the third depressurization valve, the merging joint, and the suction port of the compressor; and (iv) the refrigerant discharged from the compressor circulates in order of the branch joint, the bypass passage, the merging joint, the suction port of the compressor, in the outside air endothermic hot-gas dehumidification heating mode.

15. The refrigeration cycle device according to claim 14, further comprising
an outside air temperature sensor configured to detect an outside air temperature, which is a temperature of the outside air, wherein
the controller is configured to determine a target evaporator temperature of the indoor evaporator, and
the controller controls the refrigerant circuit switching valves, to switch from the hot gas dehumidification heating mode to the outside air endothermic hot-gas dehumidification heating mode when an outdoor unit temperature difference in which the target evaporator temperature is subtracted from the outside air temperature is equal to or greater than a predetermined reference temperature difference.

16. The refrigeration cycle device according to claim 14, further comprising
an evaporator temperature sensor configured to detect an evaporator temperature of the indoor evaporator, wherein
the controller is configured to determine a target evaporator temperature of the indoor evaporator; and
the controller controls the refrigerant circuit switching valves, to switch from the outside air endothermic hot-gas dehumidification heating mode to the hot gas dehumidification heating mode when the evaporator temperature is higher than the target evaporator temperature.
